(19) United States
(12) Patent Application Publication
(10) Pub. No.: US 2002/0154767 A1
(43) Pub. Date: Oct. 24, 2002

(54) Tamper resistance device

(76) Inventors: Takashi Endo, Musashimurayama (JP); Masahiro Kaminaga, Sakado (JP); Takashi Watanabe, Kokubunji (JP); Masaru Ohki, Tokorozawa (JP)

Correspondence Address: Mattingly, Stanger & Malur, P.C, 1800 Diagonal Road, Suite 370, Alexandria, VA, 22314, US

(21) Appl. No.: 09/940,982

(22) Filed: Aug. 29, 2001

(30) Foreign Application Priority Data
Feb. 22, 2001 (JP) 2001-046250

(51) Int. Cl. H04L 9/00

(52) U.S. Cl. 380/28; 713/194; 380/42

(57) ABSTRACT

It is an object of the disclosed technology to provide a tamper resistance device such as a card member having high security. The disclosed technology provides a solution to problems by reduction of the degree of relationship between information processed in the card member such as a chip for an IC card and current consumption for the processing.

As a means for solving the problem, there is provided a method for reducing the degree of relationship between the magnitude of a current consumed by the chip for an IC card and information processed by the chip. In accordance with this method, information is transformed by using data for disturbance of the information prior to processing and, after the processing of the transformed data, the processed transformed information is subjected to inverse transformation using the data for disturbance of the information to result in correct processed information. The method is characterized in that the hamming weight of the data for disturbance of information is all but constant.

### 2. BACKGROUND OF THE INVENTION

The present invention relates to an information-processing apparatus and, more particularly, a tamper resistance device for highly confidential IC cards.

An IC card is a device for holding personal information that must not be rewritten as one pleases, for encryption of data using a secret key treated as secret information and for decoding an encrypted text using the secret key. The IC card itself does not have a power supply. When the IC card is inserted into a reader and writer for the IC card, however, the IC card receives power from a power supply and becomes capable of carrying out operations. If the IC card is put in a state of being capable of carrying out operations, the IC card receives a command issued by the reader and writer and carries processing such as a transfer of data.

The basic concept of the IC card 101 is shown in FIG. 1. As shown in the figure, a IC-card chip 102 is mounted on the IC card 101. In general, the IC card 101 has a power-supply terminal Vcc, a ground terminal GND, a reset terminal RST, an input/output terminal I/O and a clock terminal CLK, which are each placed at a predetermined location as shown in the figure. The locations of these terminals are prescribed in ISO7816 specifications. Power is supplied by the power supply of the reader and writer and data is communicated with the reader and writer by way of these terminals. Communication using such an IC card is described in, among other documents, a reference authored by W. Rankl and W. Effing with a title of “Smart Card Handbook,” published by John Wiley and Sons, 1997, pp. 41.

The configuration of the IC-card chip 102 mounted on the IC card 101 is basically the same as that of an ordinary microcomputer. FIG. 2 is a block diagram showing the basic configuration of the IC-card chip 102 mounted on the IC card 101. As shown in FIG. 2, the IC-card chip 102 for the IC card 101 comprises a central processing unit (CPU) 201, a storage device 204, an input/output (I/O) port 207 and a coprocessor 202. The coprocessor 202 may or may not be included in the IC-card chip 102 in dependence on the system. The CPU 201 is a device for carrying out, among other operations, logic and arithmetic processing. The storage device 204 is a device used for storing programs and data. The I/O port 207 is device for carrying out communications with the reader and writer. The coprocessor 202 is a device for speeding up encryption itself or processing required for the encryption. In order to implement the functions of the coprocessor 202, the coprocessor 202 is provided with a special processing device for carrying out modulo operations of RSA encryption (RSA ciphering) and round processing of DES (Data Encryption Standard) encryption. There are many IC cards 101 including no coprocessor 201. A data bus 203 is used for connecting the CPU 201, the storage device 204, the I/O port 207 and the coprocessor 202, if any, to each other.

The storage device 204 includes a ROM (Read-Only Memory), a RAM (Random-Access Memory) and an EEPROM (Electric Erasable Programmable Read-Only Memory). The ROM is a memory not allowing information stored therein to be altered. The ROM is used mainly for storing a program. On the other hand, the RAM is a memory allowing data stored therein to be rewritten with a high degree of freedom. If power supplied by a power supply to the RAM is turned off, however, data stored in the RAM is lost. Thus, when the IC card 101 is removed from the reader and writer, data stored in the RAM is lost since power supplied by the power supply of the reader and writer to the RAM is cut off. The EEPROM is a memory for storing information that needs to be updated but must be retained even if the IC card 101 is pulled out from the reader and writer. In the case of a prepaid IC card 101, for example, information stored in the EEPROM includes the number of times the IC card 101 have been used so far. Such information needs to be updated each time the IC card 101 is used and needs to be retained in the EEPROM even if the IC card 101 is pulled out from the reader and writer.

The IC card 101 is used for storing programs and important information and carrying out encryption on the card. In the past, the difficulty of decoding data encrypted by the IC card 101 used to be considered to be the same as the difficulty of decoding an encryption algorithm. By observing a current consumed during an encryption process carried out by the IC card 101 and analyzing the waveform of the current, however, there is revealed a possibility to infer the encryption process' substance as well as secret key more easily than decoding an encryption algorithm. The consumed current can be observed by monitoring the waveform of a current supplied by the reader and writer. Details of this attack are described in, among other documents, the reference authored by W. Rankl and W. Effing with a title of “Smart Card Handbook,” published by John Wiley and Sons. In this reference's section entitled ‘8.5.1.1 Passive Protective Mechanisms’ on page 263, such a risk is described in particular. The consumed current can be used to decode an encryption algorithm more easily and infer the encryption process' substance as well as secret key for a reason described as follows. A CMOS composing the IC card 101 consumes a current when the output state changes from 1 to 0 or 0 to 1. In particular, when the value of data on the data bus 203 changes from 1 to 0 or 0 to 1, a large current generated by a bus driver flows through the data bus 203. Such a large current is caused by static capacitance values of wires and transistors connected to the wires. Thus, observation of the current consumed by the IC card 101 reveals the possibility to infer operations carried out by the IC card 101.

FIG. 3 is a diagram showing waveforms 301 and 302 of a current consumed by the IC-card chip 102 in 1 cycle. The waveform 301 is different from the waveform 302 due to differences between pieces of data processed by the IC-card chip 102. The pieces of data include data flowing through the data bus 203 and data being processed by the CPU 201.

Consider a transfer of data through a 16-bit pre-charge bus. A pre-charge bus is a bus with all bits thereof set at 0 prior to a transfer of data. As an example, consider 2 pieces of hexadecimal data, namely, 88 and 11, appearing on the data bus 203. Even though these pieces of hexadecimal data have different values, they have the same number of bits each having the logic value of 1. That is to say, the number of bits each having the logic value of 1 in the hexadecimal data 88 is 2 and so is the number of bits each having the logic value of 1 in the hexadecimal data 11. The waveform of the current for transferring the hexadecimal data 88 is all but identical with the waveform of the current for transferring the hexadecimal data 11. This is because the number of bits changing from 0 to 1 for transferring the hexadecimal data 88 is equal to that for transferring the hexadecimal data 11. Thus, currents are consumed in the same way, resulting in all but identical current waveforms. All but identical waveforms are observed for pieces of data having the same number of bits each having the logic value of 1. Examples of pieces of data having the same number of bits each having the logic value of 1 are hexadecimal data 89 and hexadecimal data 19, which both have a 1-bit count of 3. However, even though the waveform of current consumption for the hexadecimal data 89 is all but identical with that for the hexadecimal data 19, the waveforms of current consumption for the hexadecimal data 89 and the hexadecimal data 19 are different from the waveforms of current consumption for the hexadecimal data 88 and the hexadecimal data 18, which both have a 1-bit count of 2. This is because, since 3 bits change from 0 to 1 in the transfer of the hexadecimal data 89 or the hexadecimal data 19, the magnitude of the current consumed during the transfer increases by an amount corresponding to 1 bit in comparison with the aforementioned transfer of the data having a 1-bit count of 2 as described above. There is observed a law stating that, the greater the 1-bit count of transferred data, the higher the waveform of current consumption for transferring the data. Thus, transferred data can be inferred from this law.

The following description explains how a difference is detected in the case of an actual instruction by giving the following left-shift instruction as an example.

logical_shift 1 R1 (Exp. 1)

The above instruction shifts the contents of a register R1 to the left, storing the most significant bit of the contents in a carry flag of a condition-code register. Since the most significant bit of the register R1 is transferred to the condition-code register through the internal bus 203, by comparing the waveform magnitudes of the current, it is quite within the bounds of possibility that the most significant bit can be determined to be 0 or 1. That is to say, if the register R1 contains important data, it is quite within the bounds of possibility that one bit of the data can be determined to be 0 or 1. In the case of the DES encryption processing, in particular, an operation to shift the secret key is carried out frequently. This shift operation results in a waveform that can be used for inferring the secret key, giving rise to the risk of having the secret key inferred.

The value of a bit of data being transferred can possibly be determined from the waveform of current consumption in processing carried out by the coprocessor 202. If imbalance caused by dependence of processing on a secret key exists, the imbalance can be found from the waveform of current consumption. It is thus quite within the bounds of possibility that the secret key can be inferred.

As disclosed in Japanese Patent Laid-open No. 2000-182012 (or U.S. patent application Ser. No. 09/458018), as a technique to solve this problem, input data is first transformed by using data for disturbance. The transformed data is then processed. Finally, a result of the processing is subjected to inverse transformation using the data for disturbance in order to give an improvement wherein the degree of relationship between current consumption and data under processing is lowered.

A problem of the disclosed technique is explained by using the following array of instructions as an example:

logical_rotate 1 R1 (Exp. 2)

XOR R1 and R2 (Exp. 3)

The instruction of Exp. 2 logically rotates the contents of the register R1 to the left and stores a result of the logical rotation in the register R1. The instruction of Exp. 3 computes an exclusive logical sum of the register R1 and a register R2, storing the exclusive logical sum in the register R2. Since the instructions of Exps. 2 and 3 each manipulate processed data as it is, the magnitude of the waveform of current consumption changes in accordance with the value of the data, making it possible to infer the value of the data by observation of the waveform of current consumption.

In accordance with the technique disclosed in Japanese Patent Laid-open No. 2000-182012, in order to solve the problem described above, X1 and X2 selected at random are each used as data for disturbance. To be more specific, X1 and X2 are used to transformed the contents of the registers R1 and R2 by execution of instructions of Exps. 4 and 5 respectively. The transformed contents are then processed by execution of instructions of Exps. 6 and 7, and a result of the processing is stored in the register R2. Instructions of Exps. 8 and 9 are adopted by in preparation for inverse transformation. The result of processing of the transformed contents which is stored in the register R2 is subjected to inverse transformation by execution of an instruction of Exp. 10, and a result of the inverse transformation is stored in the register R2. The result of the inverse transformation is the same as the result obtained by execution of the instructions of Exps. 2 and 3 described above.

| | | | |
|---|---|---|---|
| XOR | X1 | R1 | (Exp. 4) |
| XOR | X2 | R2 | (Exp. 5) |
| logical_rotate | R1 | | (Exp. 6) |
| XOR | R1 | R2 | (Exp. 7) |
| logical_rotate | X1 | | (Exp. 8) |
| XOR | X1 | X2 | (Exp. 9) |
| XOR | X2 | R2 | (Exp. 10) |

The problem of the technique disclosed in Japanese Patent Laid-open No. 2000-182012 is that data for disturbance is used in such a way that the hamming weight of processed data cannot be observed directly. The hamming weight of data is the number of bits each having the logic value of 1 in the data with the data expressed in a binary format. At a certain probability, however, the hamming weight of data for disturbance has a special value of 0 or 8. If the hamming weight of data for disturbance has such a special value, the hamming weight of processed data can be observed directly. The present invention prevents the hamming weight of data for disturbance from becoming equal to 0 or 8.

To put it concretely, in the execution of instructions of Exps. 4 and 5, differences in current consumption which are dependent on the values of the disturbance data X1 and X2 can be observed, making it possible to infer the hamming weights of X1 and X2. In the case of a processor wherein the current consumption is proportional to the hamming weight of the disturbance data X1 or X2, for example, it is possible to detect a case in which the hamming weight is 0. By the same token, also in the case of current consumption proportional to the number of bits inverted in XOR (exclusive logical or) processing, the number of inverted bits is equal to the hamming weight of the disturbance data X1 or X2. Since a hamming weight of 0 is the hamming weight of only 0 data, by observation of current consumption, processed data including 0 data for disturbance, that is measured data only, can be identified. To put it concretely, in the transforming technique described above, the waveform of current consumption observed during the execution of the instruction of Exp. 6 or 7 is the same as the waveform of current consumption observed during the execution of the instruction of Exp. 2 or 3 respectively.

### 3. SUMMARY OF THE INVENTION

It is an object of the present invention to provide a tamper-resistance information-processing apparatus for assuring high security of devices such as a card member.

A technical problem to be solved by the present invention is how to lower the degree of relationship between data under processing and current consumption in a card member such as a chip for an IC card. If the degree of relationship between data under processing and current consumption in a chip for an IC card can be lowered, it will be difficult to infer the data under processing and a secret key in such a chip by observation of the waveform of current consumption. That is to say, the present invention provides high security to devices such as a card member.

The present invention is focused on a technique to lower the degree of relationship between data under processing and current consumption in a card member such as a chip for an IC card. In accordance with this technique, data to be transformed is first transformed by using data for disturbance. The transformed data is then processed. Finally, a result of the processing is subjected to inverse transformation using the data for disturbance to obtain a correct processing result. In addition, the disturbance data used in transformation of data to be processed in order to lower the degree of relationship between data under processing and current consumption is generated in such a way that the probability of the hamming weight's always becoming a constant value, an all but constant value and a value indicating 0s or 1s in all bits of the data for disturbance in the binary expression of the data for disturbance is 0.5 or a value close to 0.5. Furthermore, the disturbance data used in inverse transformation of a result of processing in order to lower the degree of relationship between data under processing and current consumption is generated in such a way that the probability of the hamming weight's always becoming a constant value, an all but constant value and a value indicating 0s or 1s in all bits of the data for disturbance in the binary expression of the data for disturbance is 0.5 or a value close to 0.5. In this way, the degree of relationship between current consumption of processing using the data for disturbance and the data for disturbance is lowered. As a result, it is difficult to launch an attack to infer the data for disturbance from current consumption, infer transformed data from the current consumption and infer original data from the inferred data for disturbance and the inferred transformed data. It should be noted that, in this case, the hamming weight of data is the number of bits each having the logic value of 1 in the binary expression of the data as described earlier.

In addition, as a technique of generating data for disturbance, a plurality of values usable as the data for disturbance is generated and stored in a memory in advance. In this way, it is possible to lower the degree of relationship between current consumption of processing to generate the data for disturbance and the data for disturbance at the time the values are read out from the memory. As a result, it is difficult to infer the data for disturbance.

### 4. BRIEF DESCRIPTION OF THE DRAWINGS

FIG. 1 is a diagram showing a typical hardware configuration of an IC card;

FIG. 2 is a diagram showing a typical hardware configuration of a chip for the IC card;

FIG. 3 is a diagram showing a typical waveform of current consumption;

FIG. 4 is a diagram showing a data flow in a typical procedure of original-data transformation using a piece of data for disturbance;

FIG. 5 is a diagram showing a data flow in a typical procedure for generating pieces of disturbance data and selecting one of the generated pieces of disturbance data to be used in transformation of original data;

FIG. 6 is a diagram showing a data flow in a technique to generate random numbers having constant uniform hamming weights;

FIG. 7 is a flowchart representing a typical technique to generate random numbers having constant uniform hamming weights;

FIG. 8 is a flowchart representing a technique to create a table of values having constant uniform hamming weights;

FIG. 9 is a flowchart representing a technique to create a table of values which have constant uniform hamming weights even after processing of data for disturbance;

FIG. 10 is a flowchart representing a typical technique to generate random numbers each having a constant hamming weight;

FIG. 11 is a diagram showing a data flow in a typical technique to generate data for disturbance and processed data for disturbance;

FIG. 12 is a diagram showing a data flow in another typical technique to generate data for disturbance and processed data for disturbance;

FIG. 13 is a diagram showing a data flow in a typical technique to process input data in accordance with a transformed table by transformation using 2 different pieces of disturbance data;

FIG. 14 is a diagram showing a data flow in a typical technique to generate data for disturbance and a transformed table;

FIG. 15 is a diagram showing a data flow in another typical technique to generate data for disturbance and a transformed table;

FIG. 16 is a diagram showing a data flow in a further typical technique to generate data for disturbance and a transformed table;

FIG. 17 is a diagram showing a data flow in a typical technique to process input data in accordance with a transformed table by transformation using 2 different pieces of disturbance data and by adoption of a method to process transformed data;

FIG. 18 is a diagram showing a data flow in a typical technique to generate data for disturbance and a transformed table;

FIG. 19 is a diagram showing a data flow in another typical technique to generate data for disturbance and a transformed table;

FIG. 20 is a diagram showing a data flow in a further typical technique to generate data for disturbance and a transformed table;

FIG. 21 is a diagram showing a data flow in a still further typical technique to generate data for disturbance and a transformed table;

FIG. 22 is a diagram showing a data flow in a still further typical technique to generate data for disturbance and a transformed table;

FIG. 23 is a diagram showing an input-data process comprising data transformation, data inverse transformation, data processing and a table-lookup operation which are each carried out twice by using 2 pieces of disturbance data;

FIG. 24 is a diagram showing a data flow in a typical technique to process input data in accordance with a transformed table by transformations using 4 different pieces of disturbance data and by adoption of a method to process transformed data;

FIG. 25 is a diagram showing a data flow in a typical technique to generate data for disturbance and a transformed table;

FIG. 26 is a diagram showing a data flow in another typical technique to generate data for disturbance and a transformed table;

FIG. 27 is a diagram showing a data flow in a further typical technique to generate data for disturbance and a transformed table;

FIG. 28 is a diagram showing a data flow in a still further typical technique to generate data for disturbance and a transformed table;

FIG. 29 is a diagram showing a data flow in a typical technique to generate DES-processing SBOX disturbance data and generate a transformed SBOX;

FIG. 30 is a diagram showing a data flow in a typical technique to generate DES-processing plain-text disturbance data;

FIG. 31 is a diagram showing a data flow in another typical technique to generate DES-processing plain-text disturbance data;

FIG. 32 is a diagram showing a data flow in a typical technique to transform a plain text;

FIG. 33 is a diagram showing a data flow in a typical technique to process a secret key;

FIG. 34 is a diagram showing a data flow in a typical DES 1st, 5th, 9th or 13th-round processing technique;

FIG. 35 is a diagram showing a data flow in a typical DES 2nd, 6th, 10th or 14th-round processing technique;

FIG. 36 is a diagram showing a data flow in a typical DES 3rd, 7th, 11th and 15th-round processing technique;

FIG. 37 is a diagram showing a data flow in a typical DES 4th, 8th or 12th-round processing technique;

FIG. 38 is a diagram showing a data flow in a typical DES 16th-round processing technique;

FIG. 39 is a diagram showing a data flow in a DES final inverse transformation technique;

FIG. 40 is a diagram showing a data flow in a typical DES 1st, 5th, 9th or 13th-round processing technique;

FIG. 41 is a diagram showing a data flow in a typical DES 2nd, 6th, 10th or 14th-round processing technique;

FIG. 42 is a diagram showing a data flow in a typical DES 3rd, 7th, 11th and 15th-round processing technique;

FIG. 43 is a diagram showing a data flow in a typical DES 4th, 8th or 12th-round processing technique;

FIG. 44 is a diagram showing a data flow in a typical DES 16th-round processing technique;

FIG. 45 is a flowchart representing a typical SBOX access technique;

FIG. 46 is a diagram showing a typical SBOX table;

FIG. 47 is a flowchart representing an SBOX-table transform method;

FIG. 48 is a diagram showing a data flow in a typical technique of generating disturbance data with a constant hamming weight and generating processed disturbance data also with a constant hamming weight;

FIG. 49 is a diagram showing a data flow in a typical technique of generating random numbers each having a uniform constant hamming weight;

FIG. 50 is a diagram showing a data flow in another typical technique of generating random numbers each having a uniform constant hamming weight;

FIG. 51 is a diagram showing a data flow in a further typical technique of generating random numbers each having a uniform constant hamming weight;

FIG. 52 is a diagram showing a data flow in a typical technique to generate DES-processing SBOX disturbance data and generate a transformed SBOX;

FIG. 53 is a diagram showing a data flow in a typical technique to generate DES-processing disturbance data;

FIG. 54 is a diagram showing a data flow in a typical technique to transform DES-processing intermediate data;

FIG. 55 is a diagram showing a typical table for the technique represented by the data flow shown in FIG. 12;

FIG. 56 is a diagram showing typical first disturbance data stored in a first-disturbance-data storage memory (1501) and typical second disturbance data stored in a second-disturbance-data storage memory (1502);

FIG. 57 is a diagram showing a typical table stored in a table storage memory (1507); and

FIG. 58 is a diagram showing a table containing first data for disturbance, second data for disturbance and a transformed table.

### 5. PREFERRED EMBODIMENTS OF THE INVENTION

Next, some preferred embodiments of the present invention are explained by referring to diagrams.

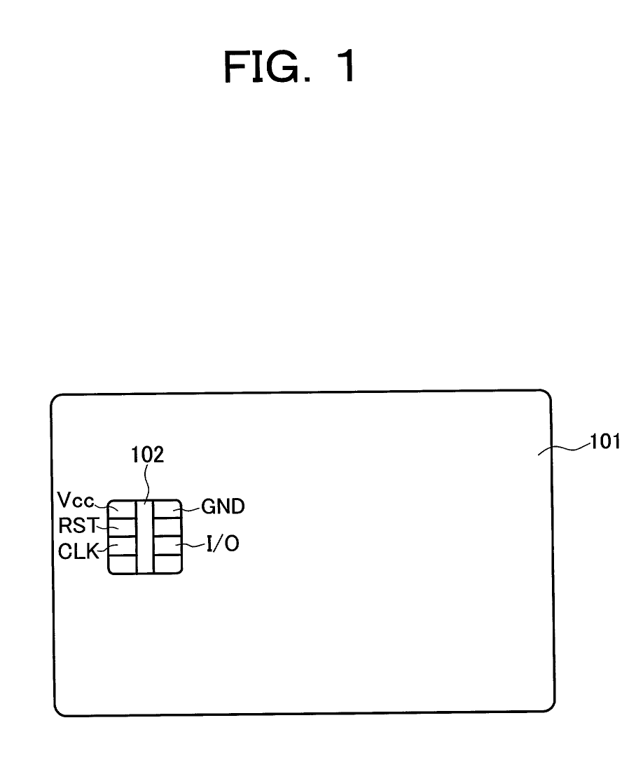

FIG. 1 is a diagram showing an external view of an IC card 101 in a simple and plain manner. ISO7816 specifications prescribe, among others, the size of the IC card 101, the location of a IC-card chip 102 on the IC card 101, the number of contacts on the IC-card chip 102 and the assignment of the contacts.

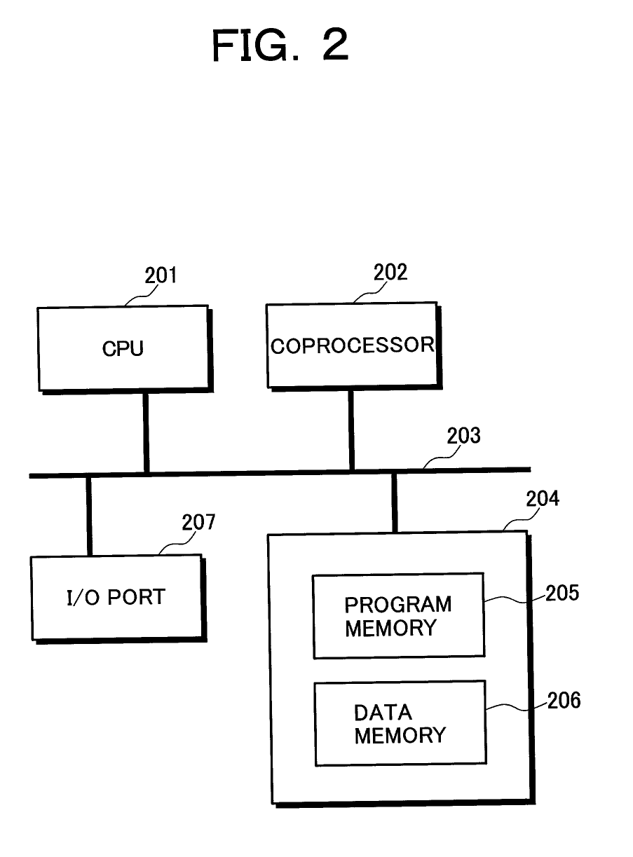

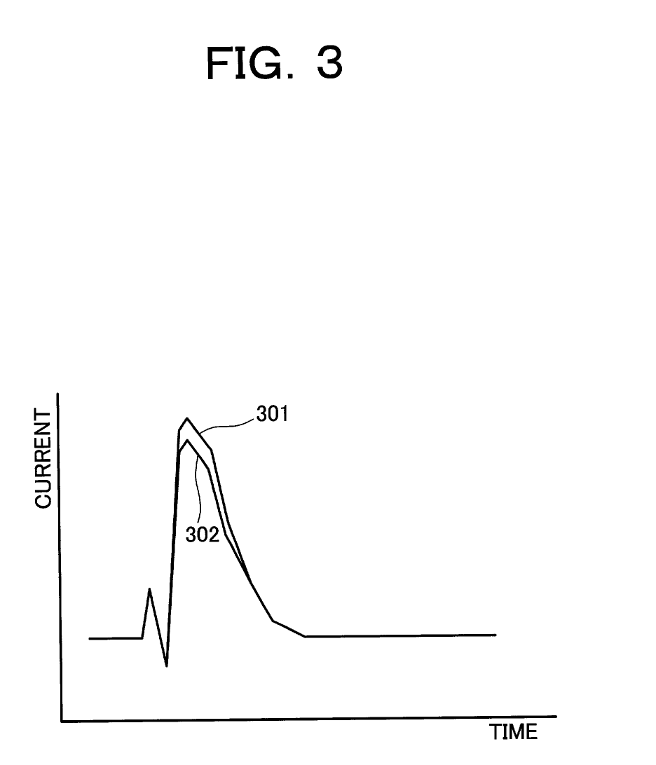

FIG. 2 is a diagram showing the internal configuration of the IC-card chip 102. The configuration of the IC-card chip 102 has been described before. In the present invention, transformation is added to data processed by a program 205. It is thus difficult to infer the data from the waveform of a current consumed by the hardware of the IC-card chip 102 mounted on the IC card 101 during the processing.

As has been explained in the paragraph with a title of “Background of the Invention,” if data is processed as it is, the data can be inferred by measuring current consumption. In accordance with a prior technology, data to be processed is first transformed by using data for disturbance. The transformed data is then processed. Finally, a result of the processing is subjected to inverse transformation by using the data for disturbance or by using a result of processing the data for disturbance to produce a value equal to data which will also be obtained as a result of processing the original data. In this way, the degree of correlation between the magnitude of a current consumed during the processing and the original data is lowered, making it difficult to infer the original data by measuring the current consumption. In the prior technology, however, there is no limitation imposed on the data for disturbance. Thus, by monitoring a current consumed during processing of the data for disturbance, the data for disturbance can be inferred. Then, by classifying the inferred data, the attack cited before can be launched.

As an example, assume that an XOR operation is used as a function for transformation. In this case, if the data for disturbance has a specific pattern such as all bits having the logic value of 0 or 1, observation of power consumption allows the original data to be identified. In addition, even if the identification rate is not 100%, by computing an average of many measured samples, an identification error can be prevented from affecting the inference of the original data.

It should be noted that, the typical processing described above can be exemplified by operations such as a rotate, a shift, a bit permutation and bit permutation with expansion.

For such processing, data for disturbance is generated in such a way that the hamming weight of the data for disturbance is equal to half the bit count of the data for disturbance, and the appearance probability of the logic value 0 or 1 at each bit position of the data for disturbance is set at 0.5. As a result, it is no longer easy to identify the data for disturbance from the waveform of a current consumed during processing of the data for disturbance. It should be noted that the probability of appearance does not to be strictly 0.5. That is to say, the probability may be smaller or greater than 0.5. However, an appearance probability of 0.5 is desirable. The closer the probability of appearance to 0.5, the more desirable the probability.

Let notations D1, f and D2 denote input data, a processing function and output data respectively. In this case, the following equation holds true.

D2=f(D1) (Eq. 11)

By measuring the waveform of a current consumed during the processing function f, the input data D1 can be inferred. In order to solve this problem, disturbance data X1i is introduced. Let notation h denote a transformation function for transforming the input data D1 and notation g denote an inverse-transformation function serving as a reversed function of the transformation function h. If Eq. 12 or 13 holds true, then the value of the expression on the right-side of Eq. 12 or 13 can be computed to find the output data D2 represented by Eq. 11 instead of computing D2 in accordance with Eq. 11.

Determination of whether to use Eq. 12 or 13 depends on the properties of the processing function f and the transform function h. A typical case in which the processing function f, the transform function h and the inverse-transformation function g satisfy Eq. 12 is shown by Eqs. 14, 15 and 16. As shown in Eq. 15, the processing function f is a rotate operation. It should be noted that, besides a rotate operation, the processing function f can be other processing such as a shift operation or a bit-permutation operation. On the other hand, the transform function h is an XOR operation as shown by Eq. 14. In this case, the inverse-transformation function g is also an XOR operation as shown by Eq. 16.

In a typical case where the processing function f and the transform function h satisfy Eq. 13, the processing function f is an addition or subtraction operation and the transform function h is also an addition or subtraction operation. In another typical case where the processing function f and the transform function h satisfy Eq. 13, the processing function f is a multiplication or division operation and the transform function h is also a multiplication or division operation.

Also in the processing represented by Eq. 12 or 13, by measuring the waveform of a current for the processing function f, the value of h (D1, X1i) can be inferred. If the value of the disturbance data X1i cannot be inferred, however, the value of the input data D1 cannot be restored either.

F(D1)=g(f(h(D1, X1i)), f(X1i)) (12)

F(D1)=g(f(h(D1, X1i)), X1i) (13)

h(x, y)=x XOR y (14)

f(x)=rotate_right (x) (15)

g(x, y)=x XOR y (16)

If the disturbance data X1i is generated to be a specific value C which can be recognized by external observation and the transform function h is known, however, the input data D1 can be restored by computation of the value of the inverse-transformation function g of the transform function h from the value of h (D1, C). A typical specific value C which can be recognized by external observation is a value consisting of all bits of 0 or all bits of 1. This is because data with a hamming weight of 0 is none other than 0 and, likewise, a value providing a hamming weight equal to the hamming weight for all bits of 1 is nothing but all bits of 1. If the disturbance data X1i is recognized to be 0 and the transform function is an XOR operation, the value of h (D1, 0) is equal to the input data D1. In the case of data's hamming weight equal to half the bit count of the data, the data can have a greatest variety of values.

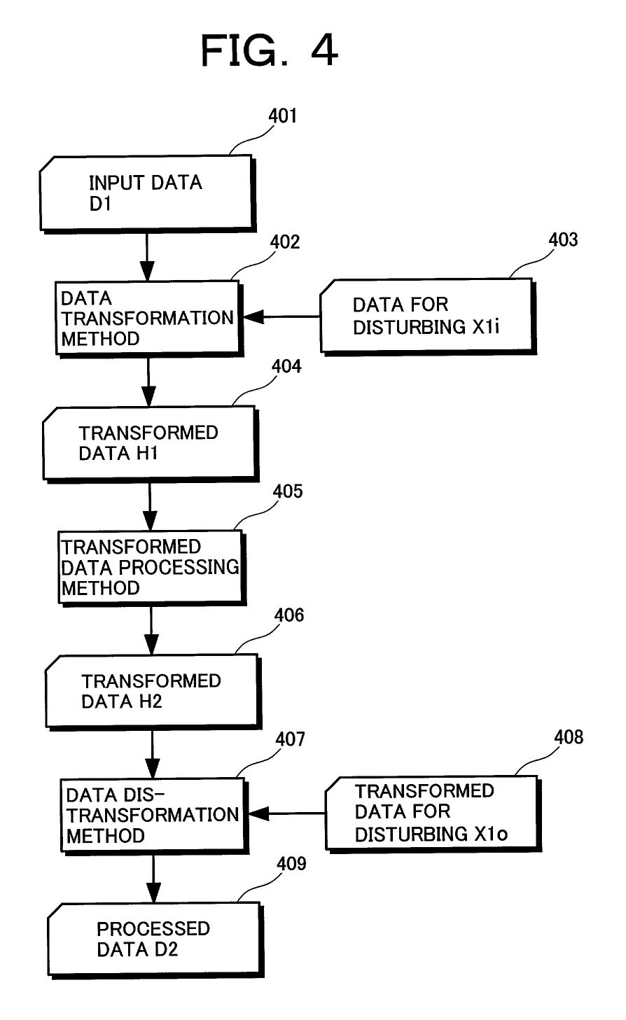

FIG. 4 is a diagram showing an embodiment implementing a data flow using a piece of data for disturbance. The embodiment is characterized in that, by determining the hamming weight of the data for disturbance, that is, by imposing a restriction on the hamming weight of the data for disturbance, the data for disturbance can be prevented from being inferred due to the fact that the data for disturbance is generated to be all bits of 0 or 1. A data transform method 402 is used to transform D1 input data 401 by using X1i disturbance data 403 to generate H1 transformed data 404. A transformed-data-processing method 405 is used to process the H1 transformed data 404 to produce H2 processed transformed data 406. A data inverse-transformation method 407 is used to carry out inverse transformation on the H2 processed transformed data 406 by using X1o processed disturbance data 408 to produce D2 processed data 409. The X1i disturbance data 403 and the X1o processed disturbance data 408 each have a constant hamming weight.

There are several techniques for generating the X1i disturbance data 403 and the X1o processed disturbance data 408.

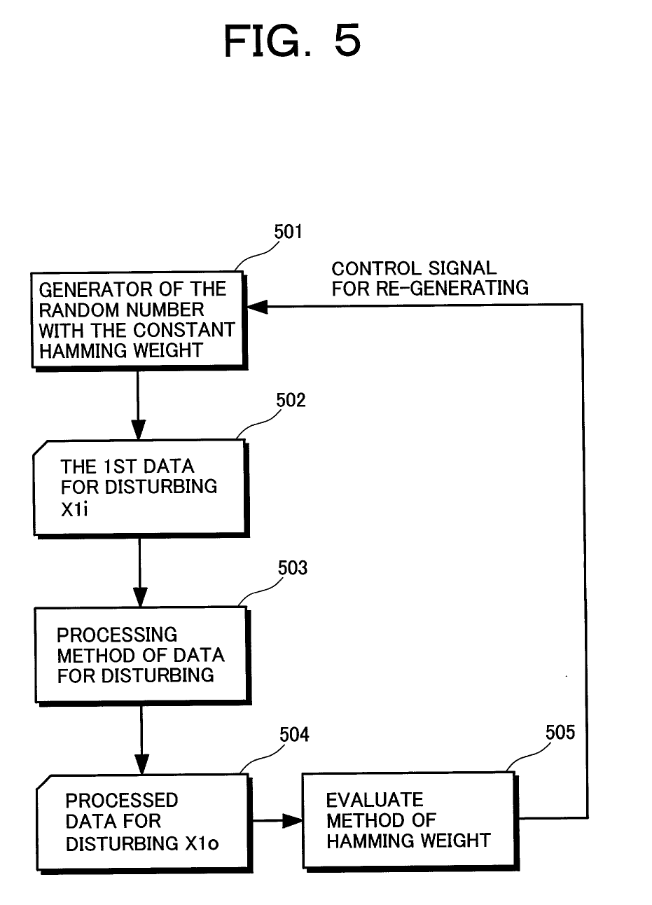

FIG. 5 is a diagram showing a data flow in a typical procedure for generating X1i disturbance data 502 and X1o processed disturbance data 504 which each have a constant hamming weight. A constant-hamming-weight-random-number generator 501 generates random numbers having uniform and constant hamming weights. A generated random number used as the first X1i disturbance data 502 is processed by using a disturbance-data-processing method 503 to produce the X1o processed disturbance data 504. A hamming-weight evaluation method 505 is used for evaluating the hamming weight of the X1o processed disturbance data 504. If the hamming weight is found different from a predetermined value, a reproduction control signal is supplied to the constant-hamming-weight-random-number generator 501 to regenerate another random number to be used as the X1i disturbance data 502. In many cases, the hamming weight is evaluated by a CPU. The role of the constant-hamming-weight-random-number generator 501 is also played by a CPU or a generator.

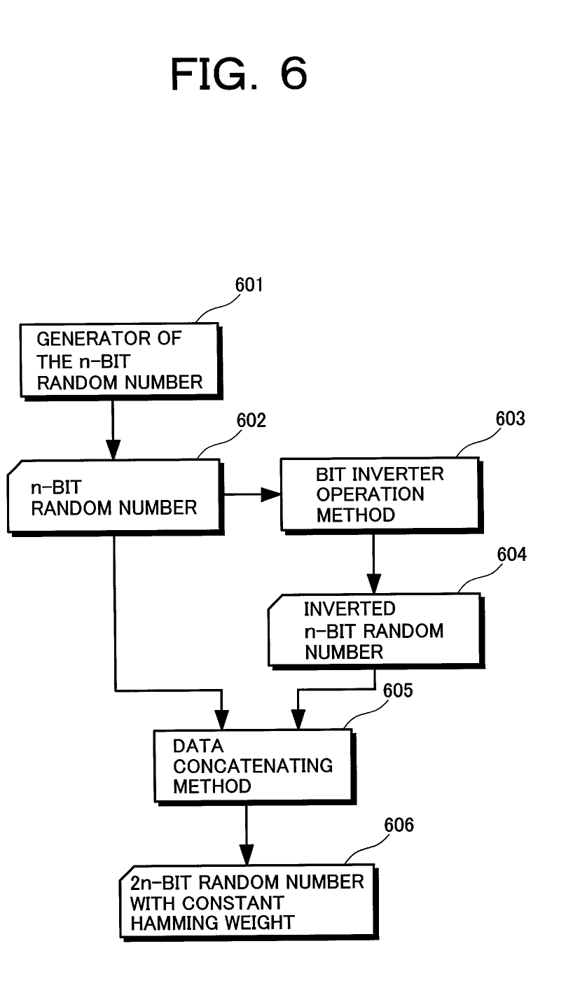

There are several techniques for generating random numbers having uniform and constant hamming weights. FIG. 6 is a diagram showing a data flow of a first embodiment implementing a technique to generate random numbers having constant uniform hamming weights. In this embodiment, the number of bits in a random number to be generated is 2n. As shown in the figure, first of all, an n-bit-random-number generator 601 generates an n-bit random number 602. The n-bit-random-number generator 601 may generate a pseudo random number or a true random number which is selected from results of measurement of a physical phenomenon. Then, a bit-inverting operation method 603 is used for inverting the generated n-bit ransom number 602 to produce an inverted n-bit ransom number 604. Subsequently, a data concatenation method 605 is used for concatenating the n-bit random number 602 and the inverted n-bit random number 604 to generate a constant-hamming-weight 2n-bit random number 606. This is because, if the number of bits each having the logic value 1 in the n-bit random number 602 is n1 and the number of bits each having the logic value 0 in the n-bit random number 602 is n2, then the following equation holds true:

n1+n2=n (Eq. 17)

Since the inverted n-bit random number 604 is obtained as a result of bit inversion of the n-bit random number 602, the number of bits each having the logic value 1 in the inverted n-bit random number 604 is n2 and the number of bits each having the logic value 0 in the inverted n-bit random number 604 is n1. Thus, the hamming weight of the constant-hamming-weight 2n-bit random number 606 obtained as a result of concatenation of the n-bit random number 602 and the inverted n-bit random number 604 is (n1+n2) which is always equal to the constant value n as obvious from Eq. 17.

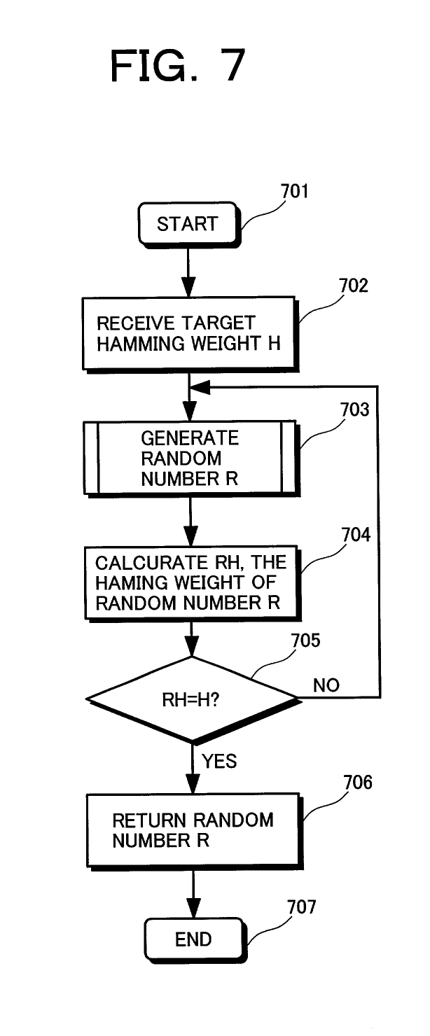

FIG. 7 is a flowchart representing a second embodiment implementing a technique to generate random numbers having constant uniform hamming weights. As shown in the figure, the random-number generation represented by the flowchart begins with a step 702 at which a target hamming weight H is input. Then, at the next step 703, a random number R is generated. Subsequently, at the next step 704, the hamming weight RH of the generated random number R is computed. The flow of the random-number generation then goes on to a step 705 to form a judgment as to whether or not the hamming weight RH of the generated random number R is equal to the target hamming weight H. If the hamming weight RH of the generated random number R is not equal to the target hamming weight H, the flow of the random-number generation goes back to the step 703 at which another random number R is generated. If the hamming weight RH of the generated random number R is equal to the target hamming weight H, on the other hand, the flow of the random-number generation goes on to a step 706 at which the random number R is passed to a calling routine as a return value. Then, at the next step 707, the generation of random numbers is ended.

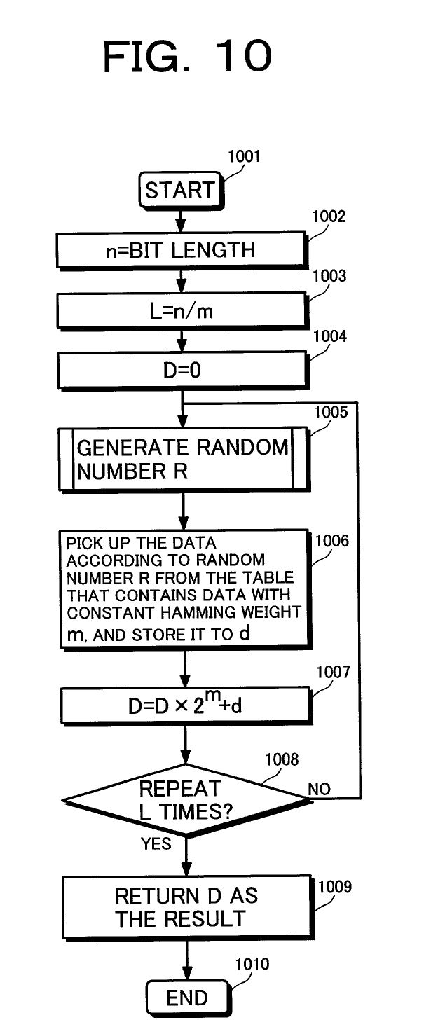

FIG. 10 is a flowchart representing a third embodiment implementing a technique to generate random numbers having constant uniform hamming weights. First of all, pieces of m-bit data having uniform constant hamming weights are collected in a table. The embodiment generates only random numbers that have uniform constant hamming weights and each have a bit count equal to a multiple of m. As shown in the figure, the random-number generation represented by the flowchart begins with a step 1002 at which the bit count of a random number to be generated is set at n. Then, at the next step 1003, a result of division of n by m is substituted for L. In the basic flow of the random-number generation, L m-bit random numbers having uniform constant hamming weights are generated and concatenated to generate an n-bit random number having a constant hamming weight. Subsequently, at the next step 1004, a variable D for accommodating the n-bit random number being generated to have a constant hamming weight is initialized at 0. Then, at the next step 1005, a random number R is generated. Subsequently, at the next step 1006, a piece of m-bit data having a constant hamming weight is fetched from the table cited above. The piece of m-bit data fetched from the table is indicated by an index having a value equal to the random number R. The piece of m-bit data fetched from the table is stored in a variable d. Subsequently, at the next step 1007, the variable D is shifted to the left by m bits and then the variable d is added to the variable D. The pieces of processing from the step 1005 to generate a random number R to the step 1007 to add the variable d to the variable D shifted to the left by m bits are carried out repeatedly L times. A step 1008 is adopted to form a judgment as to whether or not the pieces of processing have been carried out repeatedly L times. If the pieces of processing have been carried out repeatedly L times, the flow of the random-number generation goes on to a step 1009 at which the variable D is passed to a calling routine as a return value.

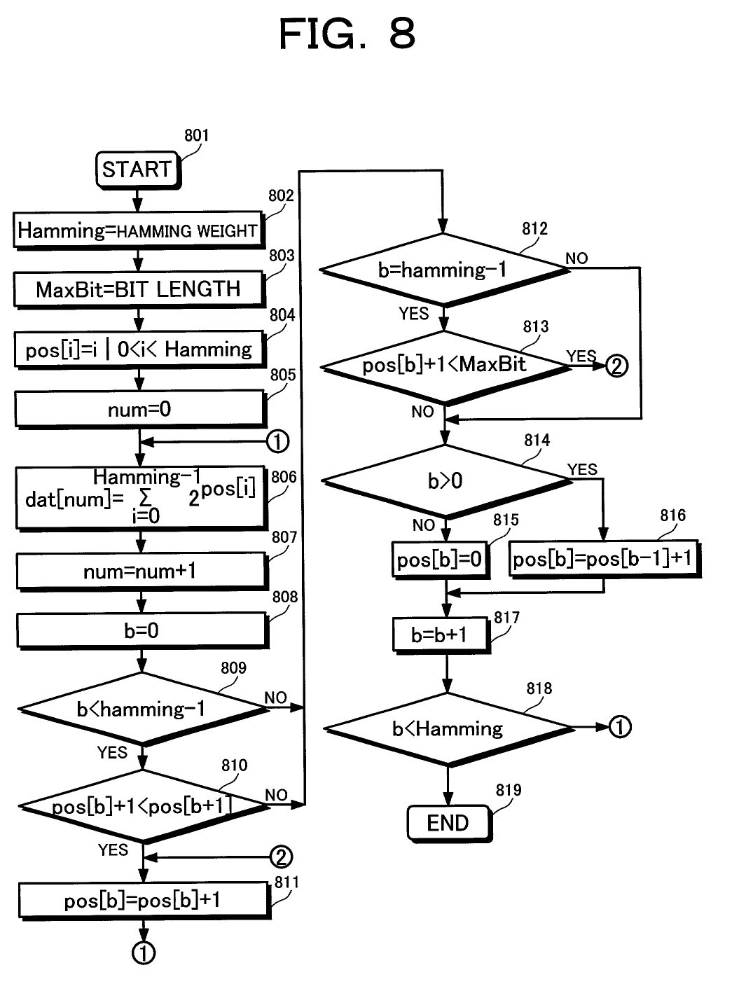

FIG. 8 is a flowchart representing an embodiment implementing a technique to create a list of bit arrays having constant uniform hamming weights. In the figure, notation MaxBit denotes a predetermined bit count of each of the values and notation Hamming denotes the constant uniform hamming weight. Notation dat denotes a list of bit arrays which is being created. The size of the bit-array list dat, that is, the number of bit arrays on the list, is (the factorial of MaxBit)/{(the factorial of Hamming) ˆ 2}. It should be noted that each of bit arrays on the bit-array list dat is a piece of data with a constant hamming weight. In the case of a bit count MaxBit of 8 and a hamming weight Hamming of 4, for example, the size of the bit-array list dat is (8!)/{(4!) ˆ 2}=70. In accordance with a concept underlying this technique, first of all, a first bit array with a bit count of MaxBit and a hamming weight (the number of bits each having the logic value of 1) of Hamming is prepared. Then, new bit arrays are prepared by moving each bit with the logic value of 1 in the first bit array to a position occupied by a bit with the logic value of 0 in the first bit array. In this way, all possible bit arrays each with a bit count of MaxBit and a hamming weight of Hamming can be found.

As shown in FIG. 8, the creation of a list begins with a step 802 at which the hamming weight is stored in a variable Hamming. Then, at the next step 803, the bit count is stored in a variable MaxBit. Subsequently, at the next step 804, an array pos [j] where j=0 to (Hamming −1) is initialized at values indicating the positions of bits in a bit array which each have a logic value of 1. A bit position can be any value in the range 0 to (MaxBit −1). Then, at the next step 805, an index num pointing to a slot in the bit-array list dat is initialized at 0. The dat bit-array list's slot pointed to by the index num will be used for storing a computed bit array at the next step 806. In addition, an index b used as the subscript of the array pos [b] in the following processing is initialized at −1. Subsequently, at the step 806, the bit array is computed and stored in the dat bit-array list' slot pointed to by the index num. Then, at the next step 807, the index num is incremented by 1. Subsequently, at the next step 808, the index b used as the subscript of the array pos [b] is incremented by 1. The flow of the list creation then goes on to a step 809 to form a judgment as to whether or not the subscript b has not reached (Hamming −1), which is a subscript value corresponding to the bit array's highest-order bit having the logic value of 1. That is to say, the judgment is formed to determine whether or not pos [b] does not have the value indicating the position of the highest-order bit having the logic value of 1 in the bit array. If the subscript b has reached (Hamming −1), the flow of the list creation goes on to a step 812. If the subscript b has not reached (Hamming −1), on the other hand, the flow of the list creation goes on to a step 810. At the next step 810, the bit array's higher-order bit position, that is, (pos [b]+1), is checked to form a judgment as to whether or not the bit at the higher-order position or the bit at (pos [b]+1) already has the logic value of 1. If the bit at the bit array's higher-order position already has the logic value of 1, the flow of the list creation goes on to the step 812. If the bit at the bit array's higher-order position or the bit at (pos [b]+1) has the logic value of 0, on the other hand, the flow of the list creation goes on to a step 811. At the step 811, the logic value of 1 in the bit array is shifted from the bit position p [b] to the bit position (p [b]+1) and the flow of the list creation then goes back to the step 806 to create another bit array.

In the following description, a current bit position p [b] means a bit position from which the logic value of 1 is to be shifted to the bit array's other bit position having a logic value of 0. At the step 812, the subscript b is checked to form a judgment as to whether the bit at the current bit position p [b] is the bit array's highest-order bit having the logic value of 1, that is the bit at the bit position (Hamming −1). If the bit at the current bit position p [b] is the bit array's highest-order bit having the logic value of 1, the flow of the list creation goes on to a step 813. If the bit at the current bit position p [b] is not the bit array's highest-order bit having the logic value of 1, on the other hand, the flow of the list creation goes on to a step 814.

At the step 813, the current bit position p [b] is checked to form a judgment as to whether or not the current bit position p [b] is the highest-order bit position in the bit array, that is, whether or not the logic value of 1 can no longer be shifted from the current bit position p [b] to the next higher-order position. The highest-order bit position in the bit array is the bit at the bit position (Maxbit −1). If the current bit position p [b] is not the highest-order bit position in the bit array, that is, if the logic value of 1 can still be shifted from the current bit position p [b] to the next higher-order position, the flow of the list creation goes on to the step 811. If the current bit position p [b] is the highest-order bit position p in the bit array, that is, if the logic value of 1 can no longer be shifted from the current bit position p [b] to the next higher-order position, on the other hand, the flow of the list creation goes on to the step 814.

At the step 814, the subscript b is checked to form a judgment as to whether a bit at the current bit position p [b] is the bit array's lowest-order bit or bit 0. If the bit at the current bit position p [b] is the bit array's lowest-order bit, the flow of the list creation goes on to a step 815. If the bit at the bit current bit position p [b] is not the bit array's lowest-order bit, on the other hand, the flow of the list creation goes on to a step 816.

At the step 816, the logic value of 1 at the current bit position p [b] is shifted to a lower-order bit position having a logic value of 0. The lower-order position having a logic value of 0 is an immediately-higher-order bit than a 1-bit position closest to the current bit position p [b]. At the step 815, the logic value of 1 at the current bit position p [b] is shifted to the lowest-order bit position in the bit array or the bit position 0 in the bit array.

At the next step 817 following the step 815 or 816, the current bit position pos [b] is changed to a next high order bit position p [b+1] in the bit array, that is, the subscript b is incremented by 1. At the next step 818, the subscript b is checked to form a judgment as to whether or not the subscript b has reached Hamming, that is, whether or not processing has been carried out for all possible combinations. If processing has not been carried out for all possible combinations, the flow of the list creation goes back to the step 806. If processing has been carried out for all possible combinations, on the other hand, the flow of the list creation goes on to a step 819 at which the creation of the list is ended. At the end of the list creation, the number of bit arrays that have been stored on the bit-array list dat is equal to the index num.

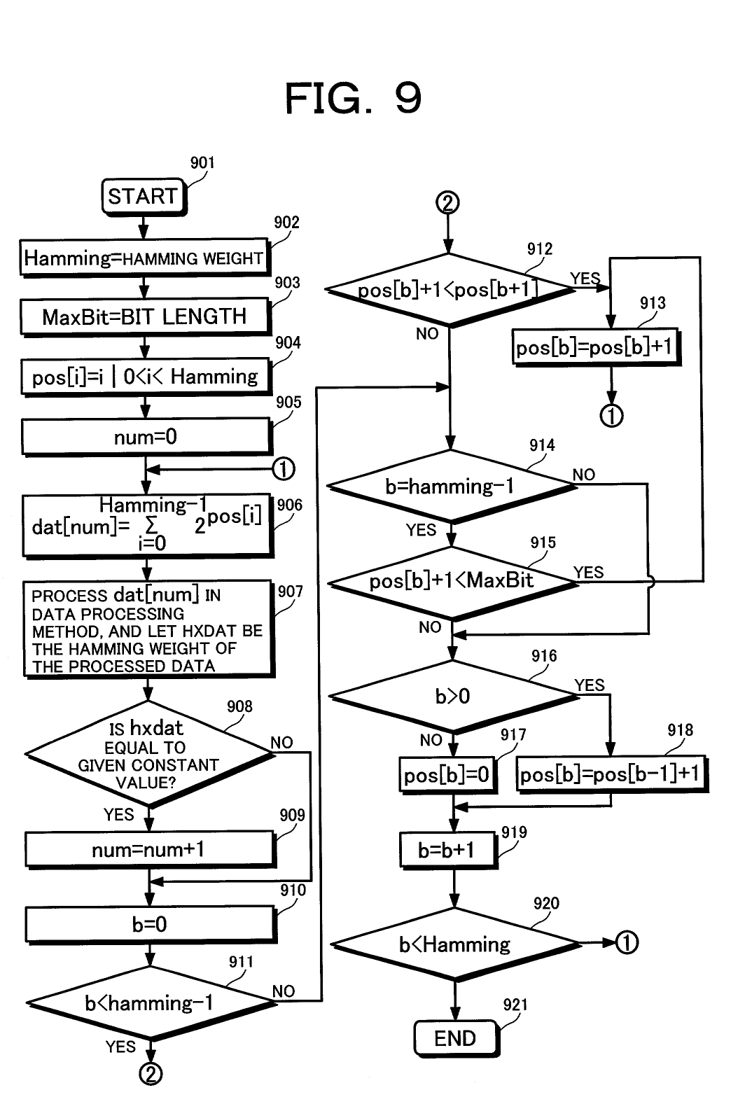

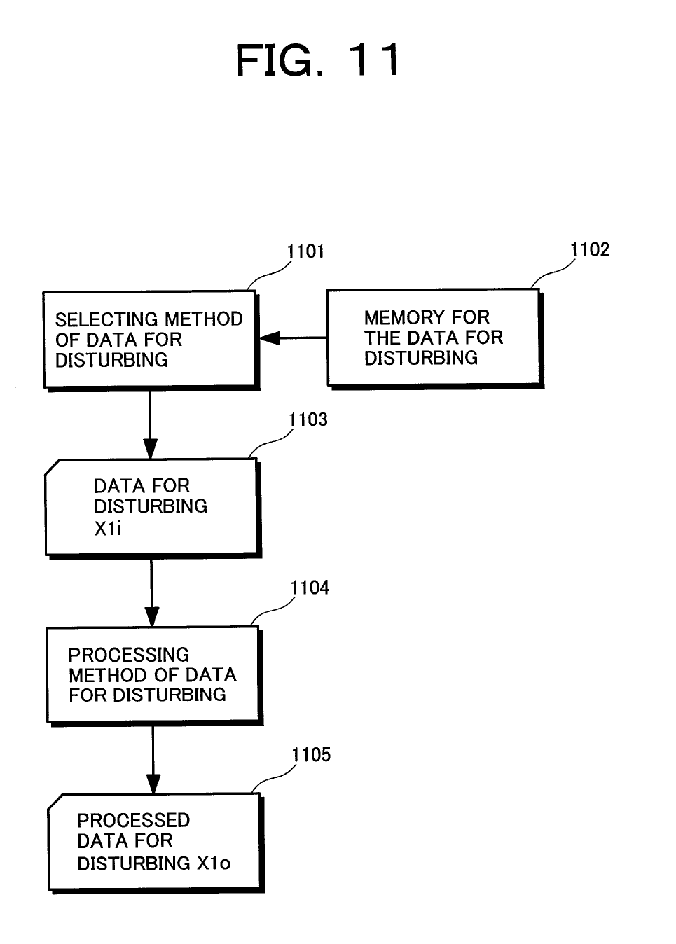

FIG. 11 is a diagram showing a data flow in a typical technique to generate the X1i disturbance data 1103 and the X1o processed disturbance data 1105. A disturbance-data selector 1101 is used for selecting a piece of data from a disturbance-data storage memory 1102 for storing pieces of data usable as the X1i disturbance data 1103 in advance. The selected piece of data is used as X1i disturbance data 1103. A disturbance-data-processing method 1104 is used for processing the X1i disturbance data 1103 to generate the X1o processed disturbance data 1105. The disturbance-data storage memory 1102 is typically a RAM or registers while the disturbance-data-processing method 1104 is normally executed by a CPU or an ALU. FIG. 9 is a flowchart representing an embodiment implementing a technique to create disturbance data to be stored in the disturbance-data storage memory 1102 in advance.

The embodiment shown in FIG. 9 adopts the same technique to create a list of bit arrays having constant uniform hamming weights as the embodiment shown in FIG. 8. The embodiment shown in FIG. 9 is different from that of FIG. 8 in that, in the case of the embodiment shown in FIG. 9, the disturbance data created on the list is not used as it is but processed by using a disturbance-data-processing method. The hamming weight of the processing results is stored in a variable hxdat at a step 907 of the flowchart shown in FIG. 9. Then, the flow of the list creation goes on to a step 908 to form a judgment as to whether the hamming weight is unchanged only if the hamming weight is found unchanged is the data for disturbance is cataloged on the bit-array list dat. The remaining of the flowchart is the same as the flowchart shown in FIG. 8.

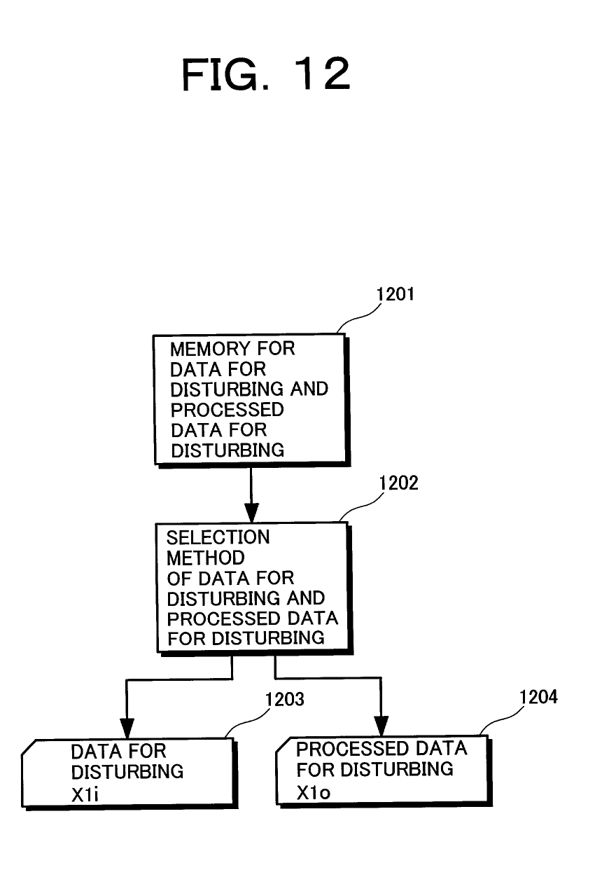

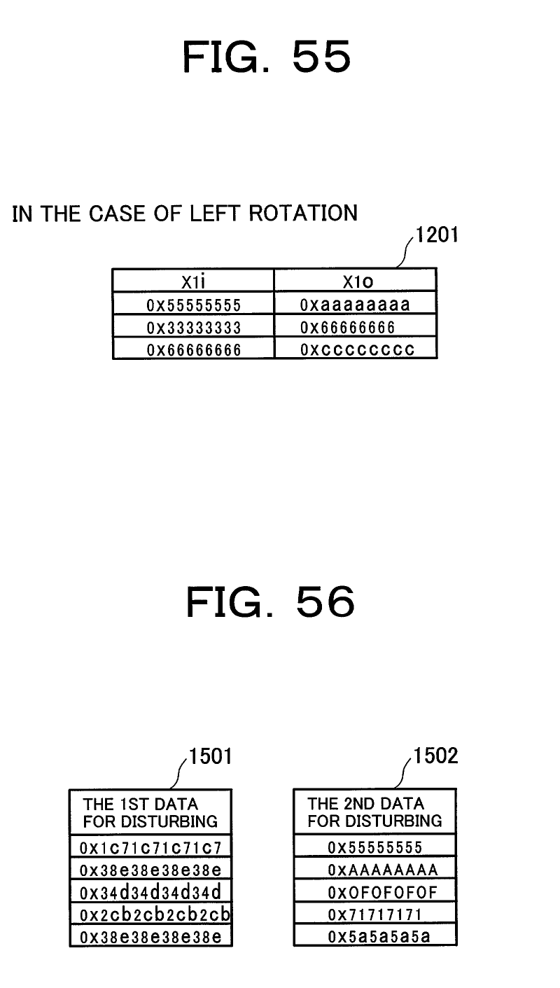

FIG. 12 is a diagram showing a data flow in an embodiment implementing a typical technique to generate X1i disturbance data 1203 and X1o processed disturbance data 1204. As shown in the figure, a plurality of pairs of data for disturbance and processed data for disturbance, which are typically generated by the embodiment with a data flow shown in FIG. 5 and the embodiment represented by a flowchart shown in FIG. 9, is stored in a disturbance-data and processed-disturbance-data storage memory 1201 in advance. A disturbance-data and processed-disturbance-data selector 1202 is used for fetching X1i disturbance data 1203 and X1o processed disturbance data 1204 from the disturbance-data and processed-disturbance-data storage memory 1201. The order in which X1i disturbance data 1203 and X1o processed disturbance data 1204 are fetched is arbitrary. For example, X1i disturbance data 1203 and X1o processed disturbance data 1204 are fetched at random based on random numbers or the like. FIG. 55 shows a typical table serving as an example of the disturbance-data and processed-disturbance-data storage memory 1201. The table includes typical disturbance data X1i and typical processed disturbance data X1o which are stored in the disturbance-data and processed-disturbance-data storage memory 1201 to be used in a left rotate operation.

In addition, it is necessary to have an even number of pairs of data for disturbance and processed data for disturbance which are stored in the disturbance-data and processed-disturbance-data storage memory 1201 and to properly select data for disturbance and processed data for disturbance to be stored in the disturbance-data and processed-disturbance-data storage memory 1201. At least, 2 pairs of data for disturbance and processed data for disturbance are needed.

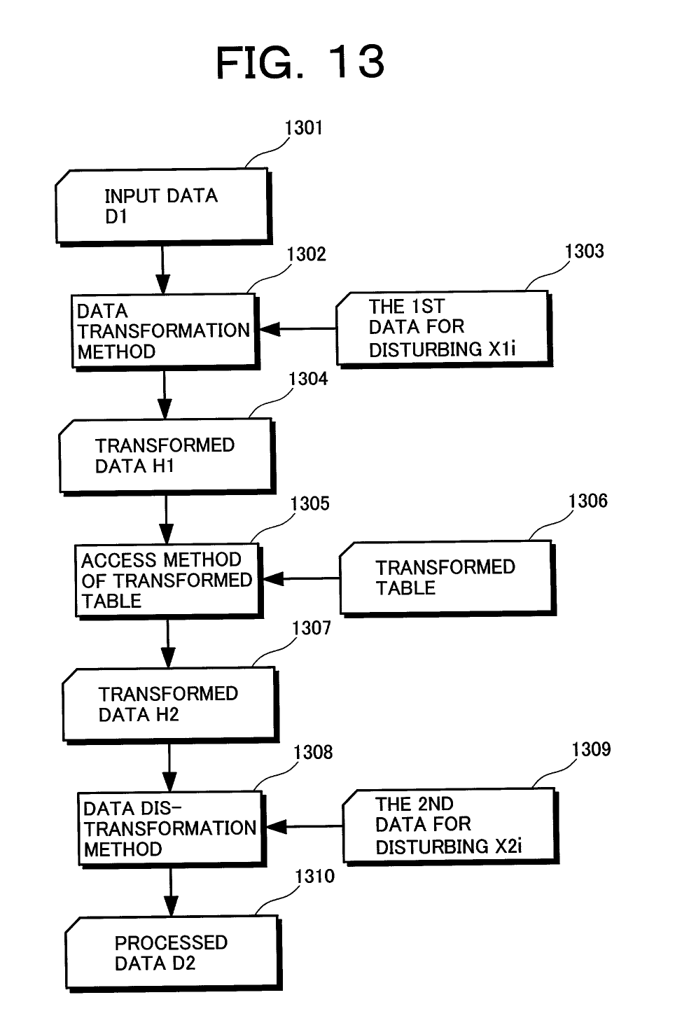

FIG. 13 is a diagram showing a data flow in an embodiment implementing a technique to process input data in accordance with a processed-data lookup table by transformation using 2 different pieces of disturbance data. Ideally, D1 input data 1301 is used to look up a transform table for D2 processed data 1310. The transform table is a relation between D1 input data 1301 and D2 processed data 1310 as expressed by Eq. 19 as follows:

D2=Table [D1] (Eq. 19)

By observing the waveform of a current consumed during the table lookup processing, however, the values of D1 and D2 can be inferred. In order to solve this problem, a transformed table XTable is newly defined by Eq. 20 as follows:

XTable [f(I, X1i)]=g(Table [I], X2i) (Eq. 20)

where notation X1i denotes first data for disturbance, notation X2i denotes second data for disturbance, notation f denotes a transform function for generating a table index and notation g denotes a transform function for generating an output result. Notation h used in the following description denotes a reversed function of the transform function g. The inverse-transformation function h is defined by Eq. 22 as follows:

D=h(g(D, X), X) (Eq. 22)

Thus, the lookup-table processing is expressed by the following equations:

$$\begin{matrix}H1 = f ( D1 , X1i ) & ( Eq . 23 ) \\ H2 = XTable [ H1 ] & ( Eq . 24 ) \\ D2 = h ( H2 , X2i ) & ( Eq . 25 )\end{matrix}$$

The transform function f (x, y) is required to always produce different table indexes for different values of x. As the definition expressed by Eq. 22 indicates, the transform function g and the inverse-transformation function h need to satisfy a relation represented by Eq. 26 as follows:

a=h(g(a, X), X) (Eq. 26)

By observation the waveform of a current consumed during processing represented by Eq. 24, it may be possible to infer transformed data H1 or transformed data H2. Since the transformed data H1 is a result of transformation of the input data D1 by using the first disturbance data X1i whereas the transformed data H2 is subjected to inverse transformation using the second disturbance data X2i, however, the values of the input data D1 and the processed data D2 cannot be inferred by merely observing the waveform of a current consumed during processing represented by Eq. 24. In the embodiment shown in FIG. 13, processing represented by Eq. 23 is processing to transform the D1 input data 1301 by using the X1i first disturbance data 1303 in accordance with a data transform method 1302 to produce the H1 transformed data 1304. Processing represented by Eq. 24 is processing to fetch the H2 transformed data 1307 indicated by the H1 transformed data 1304 serving as a table index from a transformed table 1306 by using a transformed-table access method 1305. Processing represented by Eq. 25 is processing to carry out inverse transformation on the H2 transformed data 1307 by using the X2i second disturbance data 1309 in accordance with a data inverse-transformation method 1308 to produce the D2 processed data 1310.

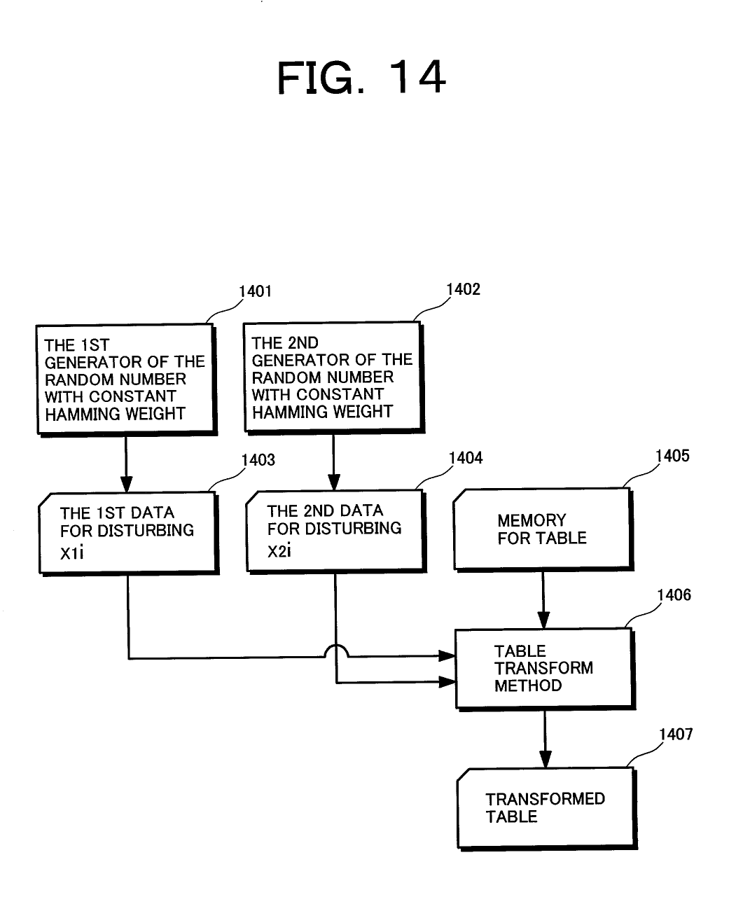

FIG. 14 is a diagram showing a data flow in an embodiment implementing a technique to generate the X1i first disturbance data 1403, the X2i second disturbance data 1404 and the transformed table 1407 which are used in the embodiment shown in FIG. 13. As shown in FIG. 14, a first constant-hamming-weight-random-number generator 1401 is used for generation of the X1i first disturbance data 1403 and a second constant-hamming-weight-random-number generator 1402 is used for generation of the X2i second disturbance data 1404. A table transform method 1406 is used for creating the transformed table 1407 from the X1i first disturbance data 1403, the X2i second disturbance data 1404 and a table, which is stored in a table storage memory 1405 and satisfies Eq. 19, in accordance with a transformation satisfying Eq. 20. As the first constant-hamming-weight-random-number generator 1401 and the second constant-hamming-weight-random-number generator 1402, the constant-hamming-weight-random-number generators shown in FIGS. 6 to 8 can be used.

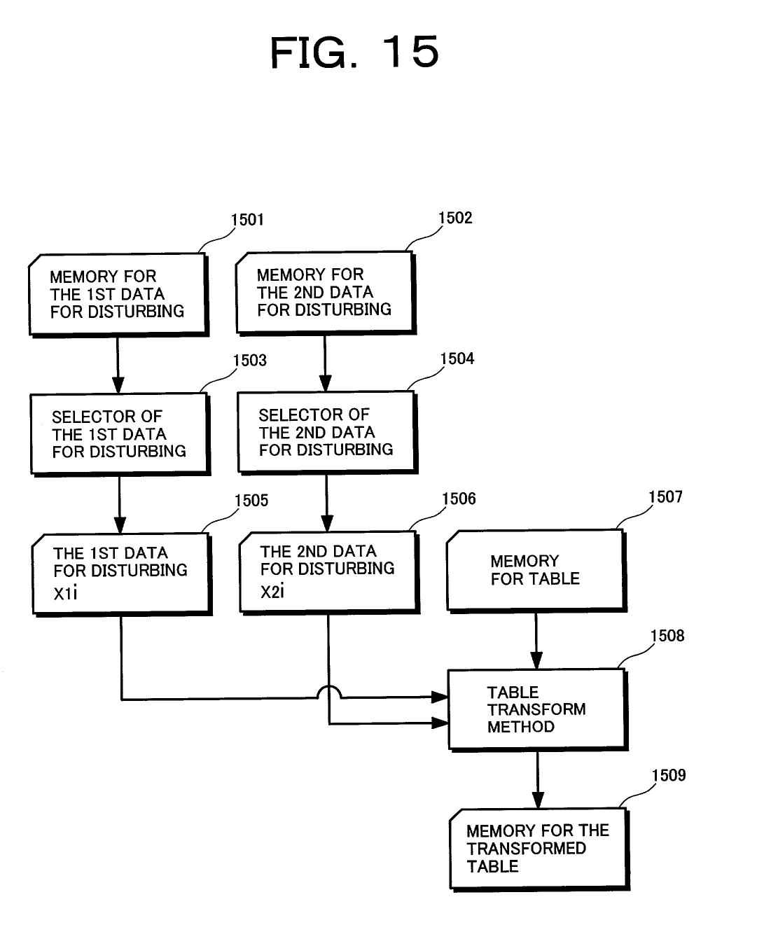

FIG. 15 is a diagram showing a data flow in an embodiment implementing a technique to generate the X1i first disturbance data 1505, the X2i second disturbance data 1506 and the transformed table 1509 which are used in the embodiment shown in FIG. 13. As shown in FIG. 15, a first-disturbance-data selector 1503 is used for selecting a piece of X1i first disturbance data 1505 from a first-disturbance-data storage memory 1501 for storing pieces of first disturbance data X1i in advance, and a second-disturbance-data selector 1504 is used for selecting a piece of X2i second disturbance data 1506 from a second-disturbance-data storage memory 1502 for storing pieces of second disturbance data X2i in advance. A table transform method 1508 is used for creating the transformed table 1509 from the selected piece of X1i first disturbance data 1505, the selected piece of X2i second disturbance data 1506 and a table, which is stored in a table storage memory 1507 and satisfies Eq. 19, in accordance with a transformation satisfying Eq. 20.

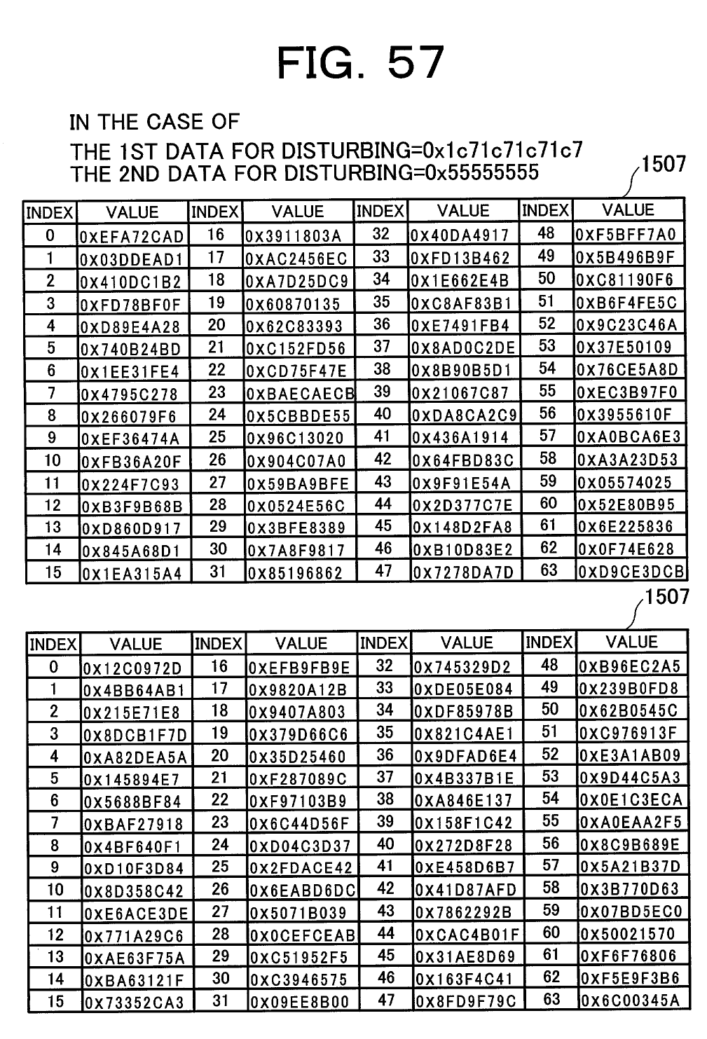

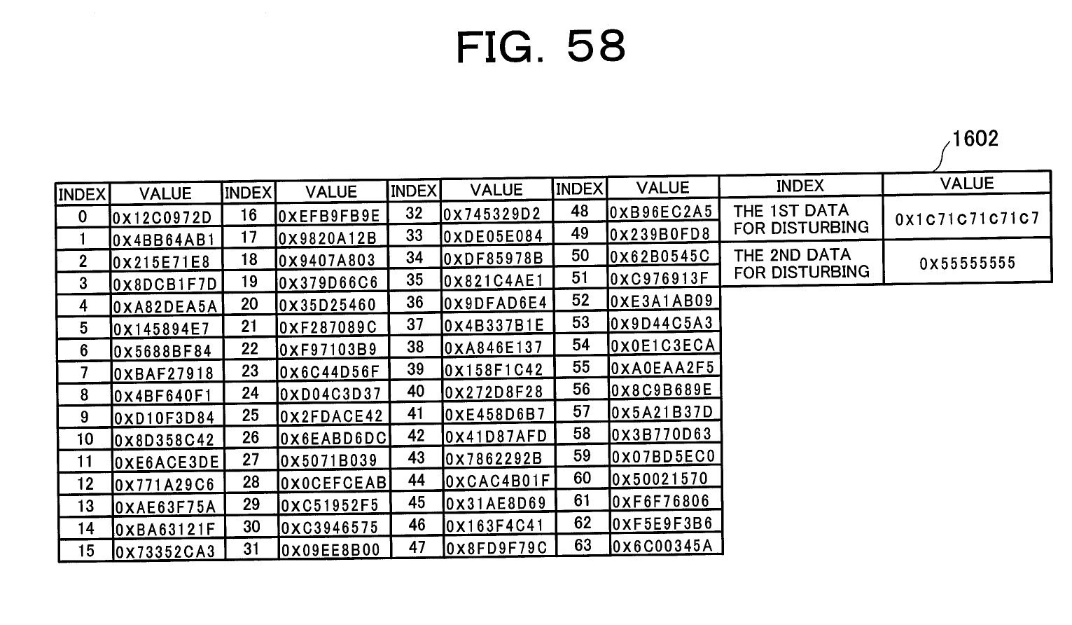

FIG. 56 is a diagram showing typical first disturbance data stored in the first-disturbance-data storage memory (1501) and typical second disturbance data stored in the second-disturbance-data storage memory (1502). FIG. 57 is a diagram showing typical table stored in the table storage memory (1507). As shown in the figure, an example of the first disturbance data is 0x1c71c71c71c7 and an example of the second disturbance data is 0x55555555.

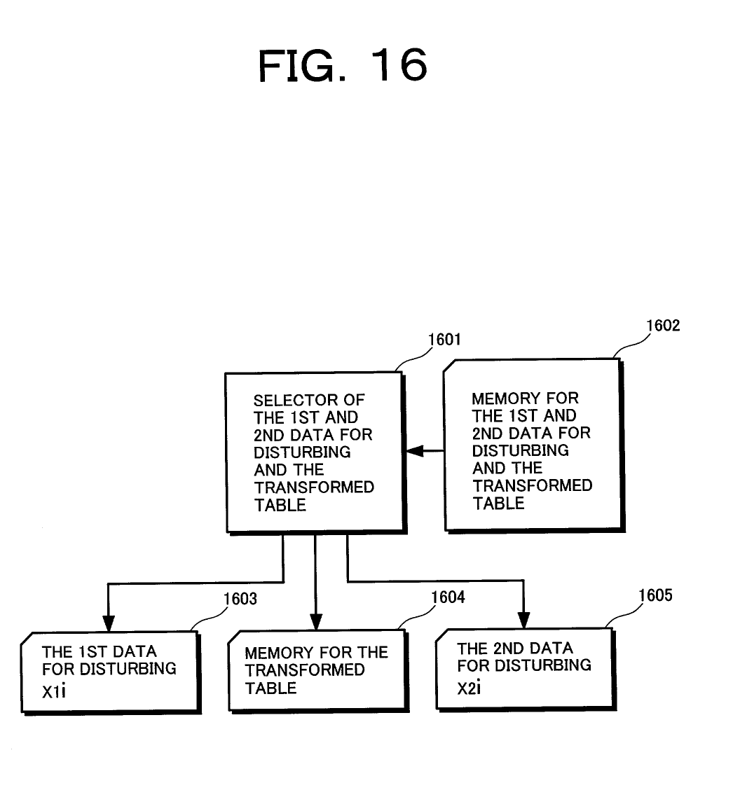

FIG. 16 is a diagram showing a data flow in an embodiment implementing a technique to generate the X1i first disturbance data 1603, the X2i second disturbance data 1604 and the transformed table 1605 which are used in the embodiment shown in FIG. 13. As shown in FIG. 16, first of all, a first-disturbance-data, second-disturbance-data and transformed table selector 1601 is used to select and fetch a set of first disturbance data X1i, second disturbance data X2i and a transformed table from a first-disturbance-data, second-disturbance-data and transformed-table storage memory 1602 to be used as the X1i first disturbance data 1603, the X2i second disturbance data 1604 and the transformed table 1605. The first-disturbance-data, second-disturbance-data and transformed-table storage memory 1602 is a memory used for storing in advance a plurality of sets each consisting of a constant-hamming-weight value serving as potential first disturbance data X1i, a constant-hamming-weight value serving as potential second disturbance data X2i and a transformed table serving as a potential serving table 1605. The transformed table is a list obtained as a result of transformation using a pair consisting of a constant-hamming-weight value serving as potential first disturbance data X1i and a constant-hamming-weight value serving as potential second disturbance data X2i.

FIG. 58 is a diagram showing a table containing first data for disturbance, second data for disturbance and a transformed table, which are used in the embodiment shown in FIG. 16. The first-disturbance-data, second-disturbance-data and transformed table storage memory 1602 cited above is a memory used for storing in advance a plurality of tables each having a format shown in FIG. 58.

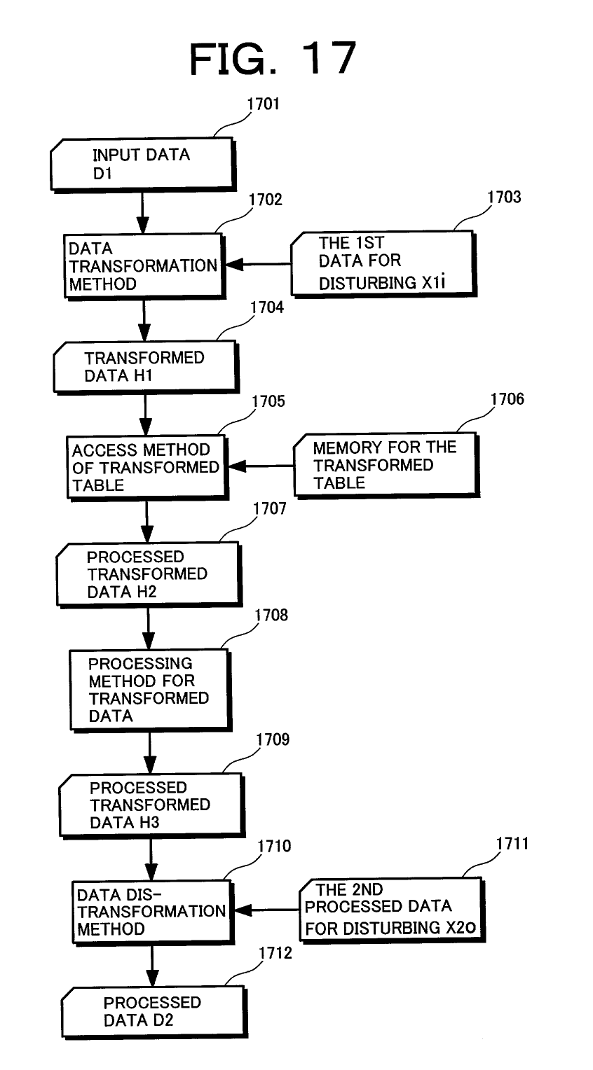

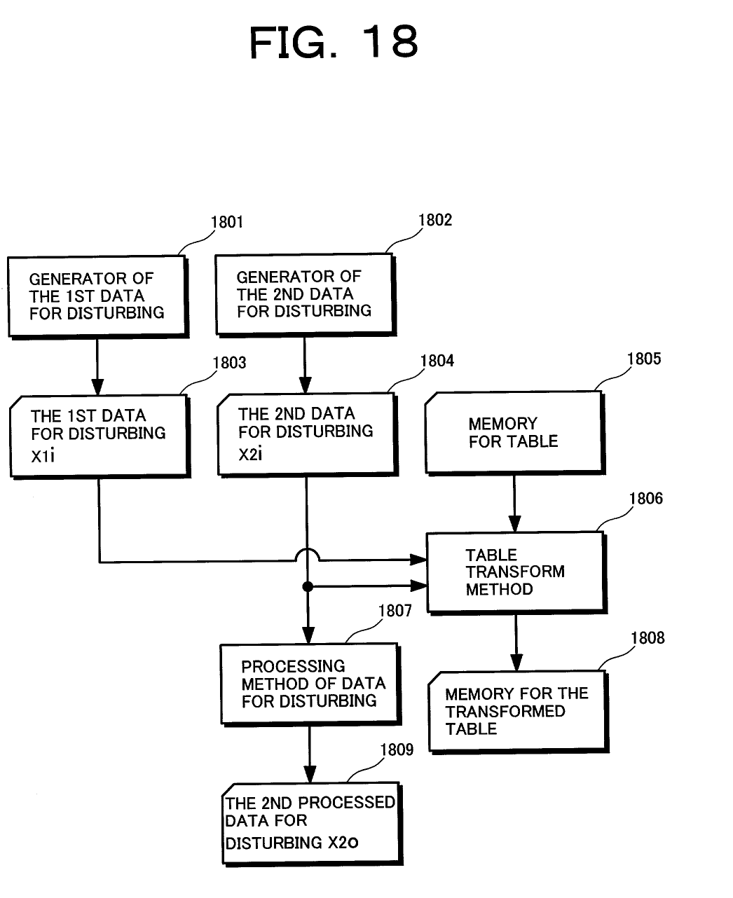

FIG. 17 is a diagram showing a data flow in a typical technique to process input data in accordance with a transformed table by transformation using 2 different pieces of disturbance data. Unlike the embodiment shown in FIG. 13, transformed data H2 is further processed by adoption of a method to process transformed data to generate processed transformed data H3. p processing shown in the figure includes a table-lookup operation and is carried out on D1 input data 1701 to produce D2 processed data 1712 as represented by Eq. 27 as follows.

D2=p(Table [D1]) (Eq. 27)

where notation Table denotes the transform table.

By observing the waveform of a current consumed during the table-lookup operation, the values of the input data D1 and the processed data D2 can be inferred. In order to solve this problem, a transformed table XTable is newly defined by Eq. 28 as follows:

XTable [f(i, X1i)]=g(Table [i], X2i) (Eq. 28)

where notation X1i denotes first data for disturbance, notation X2i denotes second data for disturbance, notation f denotes a transform function for generating a table index and notation g denotes a transform function for generating an output result. Notation h used in the following description denotes a reversed function of the transform function g. The inverse-transformation function h is defined by Eq. 29 as follows:

D=h(g(D, X), X) (Eq. 29)

Let processed second disturbance data X2o denoted by reference numeral 1711 in FIG. 17 be defined as follows.

X2o=p(X2i) (Eq. 30)

Thus, the lookup-table operation and the processing p are expressed by the following equations:

$$\begin{matrix}H1 = f ( D1 , X1i ) & ( Eq . 31 ) \\ H2 = XTable [ H1 ] & ( Eq . 32 ) \\ H3 = p ( H2 ) & ( Eq . 33 ) \\ D2 = h ( H3 , X2o ) & ( Eq . 34 )\end{matrix}$$

The transform function f, the inverse-transformation function h and the processing function p need to satisfy a relation represented by Eq. 35 as follows:

a=h(p(f(a, X)), p(X)) (Eq. 35)

Examples of the transform function f, the inverse-transformation function h and the processing function p that satisfy Eq. 35 are given as follows:

$$f ( x , y ) = x XOR y \\ p ( x ) = right rotation ( x ) \\ h ( x , y ) = x XOR y \qquad ( Eq . 36 )$$

Even if the value of the transformed data H1 can be inferred by observing the waveform of a current consumed during the processing represented by Eq. 32, the value of the input data D1 cannot be inferred from only a result of observation for the processing represented by Eq. 32. This is because the transformed data H1 is obtained of a result of transformation of the input data D1 by using the first disturbance data X1i. By the same token, even if the value of the processed transformed data H3 can be inferred by observing the waveform of a current consumed during the processing represented by Eq. 33, the value of the processed data D2 cannot be inferred from only a result of observation for the processing represented by Eq. 33. This is because the processed transformed data H3 is further subjected to inverse transformation by using the X2o processed second disturbance data 1711.

In the embodiment shown in FIG. 17, processing represented by Eq. 31 is processing to transform the D1 input data 1701 by using the X1i first disturbance data 1703 in accordance with a data transform method 1702 to produce the H1 transformed data 1704. Processing represented by Eq. 32 is processing to fetch the H2 transformed data 1707 pointed to by the H1 transformed data 1704 serving as a table index from the transformed table 1706 by using a transformed-table access method 1705. Processing represented by Eq. 33 is processing to convert the H2 transformed data 1707 into H3 processed transformed data 1709 by using a transformed-data-processing method 1708. Processing represented by Eq. 34 is processing to carry out inverse transformation on the H3 processed transformed data 1709 by using the X2o processed second disturbance data 1711 in accordance with a data inverse-transformation method 1710 to produce the D2 processed data 1712.

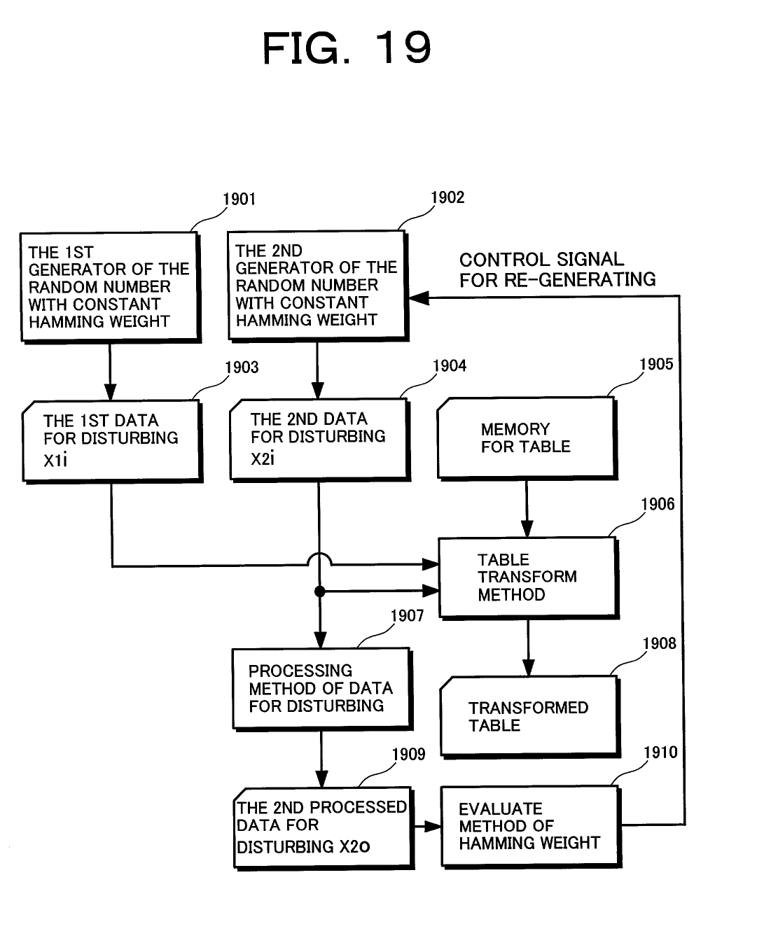

FIG. 19 is a diagram showing a data flow in another embodiment implementing a technique to generate X1i first disturbance data 1903, X2i second disturbance data 1904, a transformed table 1908 and X2o processed second disturbance data 1909, which are used in the embodiment shown in FIG. 17.

As shown in FIG. 19, a first constant-hamming-weight-random-number generator 1901 is used for generating X1i first disturbance data 1903. By the same token, a second constant-hamming-weight-random-number generator 1902 is used for generating X2i second disturbance data 1904. A disturbance-data-processing method 1907 is used for processing the X2i second disturbance data 1904 to generate X2o processed second disturbance data 1909. A hamming-weight evaluation method 1910 is used for evaluating the hamming weight of the X2o processed second disturbance data 1909. If the hamming weight is found incorrect, a reproduction control signal is supplied to the constant-hamming-weight-random-number generator 1902 to regenerate other X2i second disturbance data 1904. A table transform method 1906 is used for carrying out transformation according to Eq. 27 to generate a transformed table 1908 from a table stored in a table storage memory 1905, the X1i first disturbance data 1903 and the X2i second disturbance data 1904. As the first constant-hamming-weight-random-number generator 1901 and the second constant-hamming-weight-random-number generator 1902, the constant-hamming-weight random-numbers generators shown in FIGS. 6 to 8 can be adopted. This embodiment has a merit that, since the X1i first disturbance data 1903 and the X2i second disturbance data 1904 are generated each time they are required, a large number of variations in value can be expected specially in the case of disturbance data with a large bit count.

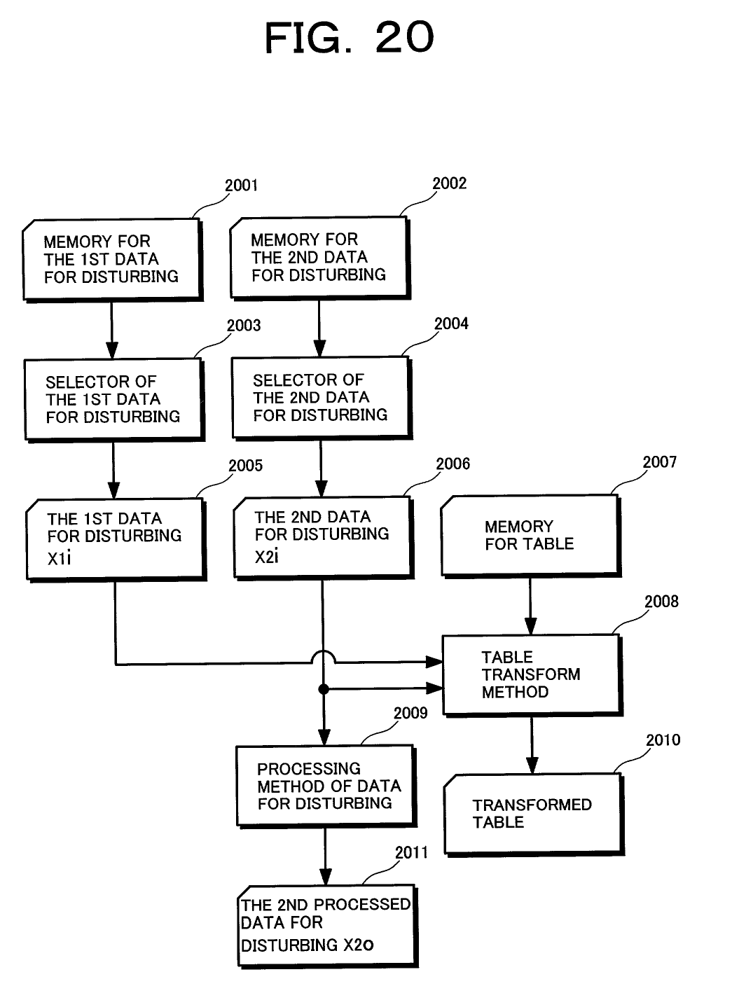

FIG. 20 is a diagram showing a data flow in a further embodiment implementing a technique to generate X1i first disturbance data 2005, X2i second disturbance data 2006, a transformed table 2010 and X2o processed second disturbance data 2011, which are used in the embodiment shown in FIG. 17.

As shown in FIG. 20, a first-disturbance-data selector 2003 is used for selecting a piece of X1i first disturbance data 2005 from a first-disturbance-data storage memory 2001 for storing pieces of first disturbance data X1i in advance, and a second-disturbance-data selector 2004 is used for selecting a piece of X2i second disturbance data 2006 from a second-disturbance-data storage memory 2002 for storing pieces of second disturbance data X2i in advance. A disturbance-data-processing method 2009 is used for processing the selected X2i second disturbance data 2006 to generate X2o processed second disturbance data 2011. A table transform method 2008 is used for creating the transformed table 2010 from the selected piece of X1i first disturbance data 2005, the selected piece of X2i second disturbance data 2006 and a table stored in a table storage memory 2007 in accordance with a transformation satisfying Eq. 26. This embodiment has a merit that, since candidates for the X1i first disturbance data 2005 and the X2i second disturbance data 2006 are prepared in advance, it does not take time to generate the X1i first disturbance data 2005 and the X2i second disturbance data 2006.

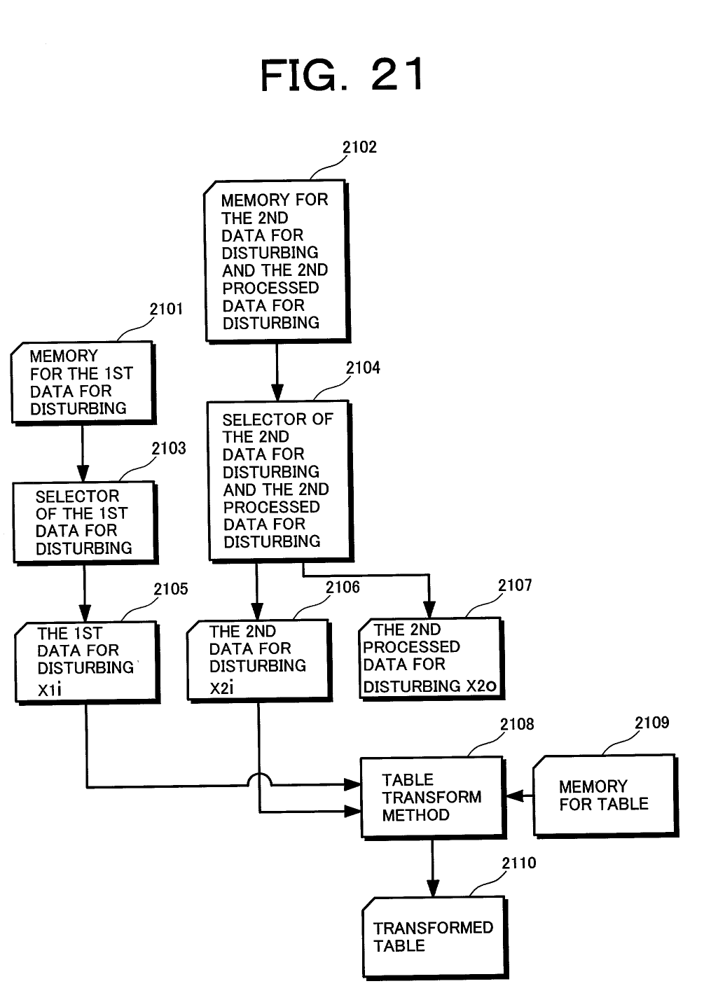

FIG. 21 is a diagram showing a data flow in a still further embodiment implementing a technique to generate X1i first disturbance data 2105, X2i second disturbance data 2106, a transformed table 2110 and X2o processed second disturbance data 2107, which are used in the embodiment shown in FIG. 17.

As shown in FIG. 21, a first-disturbance-data selector 2103 is used for selecting a piece of X1i first disturbance data 2105 from a first-disturbance-data storage memory 2101 for storing pieces of first disturbance data X1i in advance, and a second-disturbance-data and processed-second-disturbance-data selector 2104 is used for selecting a piece of X2i second disturbance data 2106 and a piece of X2o processed second disturbance data 2107 from a second-disturbance-data and processed-second-disturbance-data storage memory 2102 for storing pieces of second disturbance data X2i and pieces of processed second disturbance data X2o in advance. A table transform method 2108 is used for creating the transformed table 2110 from the selected piece of X1i first disturbance data 2105, the selected piece of X2i second disturbance data 2106 and a table stored in a table storage memory 2109 in accordance with a transformation satisfying Eq. 26. This embodiment has a merit that, since candidates for the X1i first disturbance data 2105, the X2i second disturbance data 2106 and the X2o processed second disturbance data 2107 are prepared in advance, it does not take time to generate the of X1i first disturbance data 2105, the X2i second disturbance data 2106 and the X2o processed second disturbance data 2107. It is also unnecessary to process X2i second disturbance data 2106 to generate X2o processed second disturbance data 2107. As a result, the amount of leaked information is small in comparison with the configuration shown in FIG. 20.

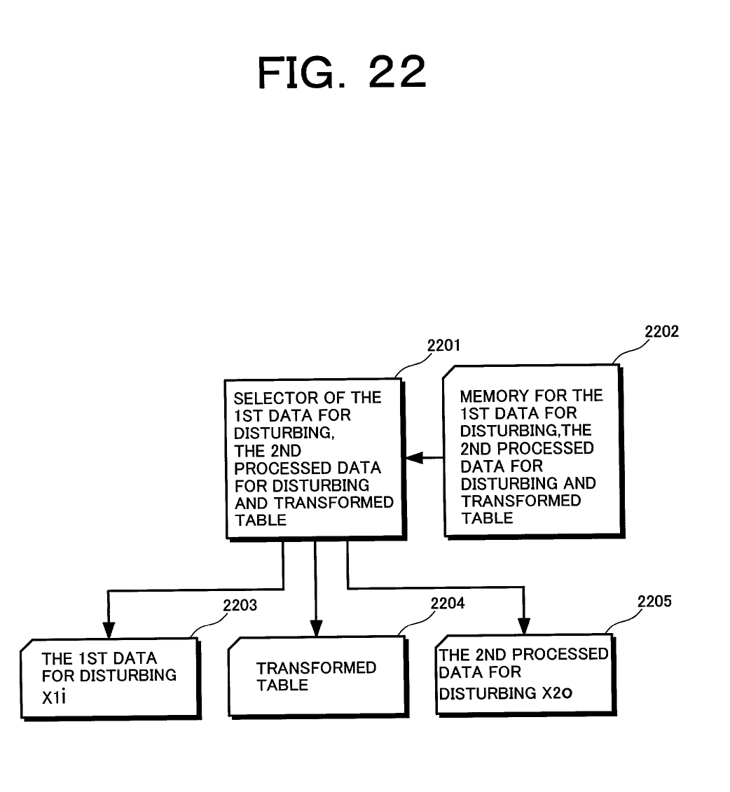

FIG. 22 is a diagram showing a data flow in a still further embodiment implementing a technique to generate X1i first disturbance data 2203, a transformed table 2205 and X2o processed second disturbance data 2204, which are used in the embodiment shown in FIG. 17.

As shown in FIG. 22, a first-disturbance-data and processed-second-disturbance-data and transformed-table selector 2201 is used for selecting a piece of X1i first disturbance data 2203, a piece of X2o processed second disturbance data 2204 and a transformed table 2205 from a first-disturbance-data and processed-second-disturbance-data and transformed-table storage memory 2202 for storing pieces of first disturbance data X1i, pieces of processed second disturbance data X2o and transformed tables in advance. This embodiment has a merit that it is also unnecessary to create a transformed table 2205 in comparison with the configuration shown in FIG. 21. As a result, the amount of leaked information is small in comparison with the configuration shown in FIG. 21.

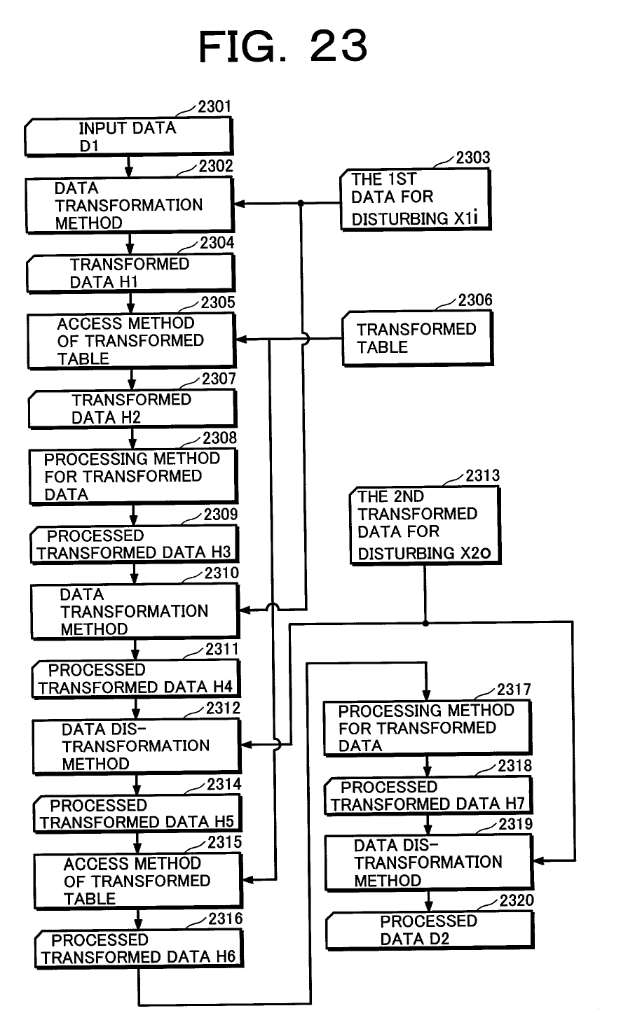

FIG. 23 is a diagram showing a first embodiment implementing an information-processing apparatus wherein input data is processed by carrying out data transformation, data inverse transformation, data processing and a table-lookup operation which are each carried a number of times by using a transformed table as well as 2 pieces of data for disturbance of a table index, table contents and numerical values appearing in the course of the process.

In the process, data is always transformed prior to data processing and the transformation will be followed by inverse transformation later. The procedure comprising the transformation, the data processing and the inverse-transformation is executed a number of times. As a result, in the course of data processing, no untransformed data will appear. Data subjected to data processing may be transformed once or twice. In either case, however, data in the course of processing is always data left in transformed state as it is. Thus, this embodiment is characterized in that the amount of leaked information is small.

In the embodiment shown in FIG. 23, any inverse transformation carried out after transformation opposite to the inverse transformation must result in a pre-transformation value prior to the transformation. On the contrary, any transformation carried out after inverse transformation opposite to the transformation must result in a value prior to the inverse-transformation. Assume that a function f (x, y) is a function for transforming data x by using disturbance data y and a function g (a, b) is a function for carrying out inverse transformation on transformed data a by using disturbance data b. That is to say, the function g is a function opposite to the function f. In this case, the following equation holds true:

f(g(x, y1), y2)=g(f(x, y2), y1) (Eq. 37)

In the embodiment shown in FIG. 23, X1i first disturbance data 2303, a transformed table 2306 and X2o processed second disturbance data 2313 can be generated by any of the embodiments shown in FIGS. 19 to 22. As shown in FIG. 23, first of all, a data transform method 2302 is used to transform D1 input data 2301 by using X1i first disturbance data 2303 to generate H1 transformed data 2304. Then, a transformed-table access method 2305 is used for looking up a transformed table 2306 for H2 transformed data 2307 pointed to by the H1 transformed data 2304 serving as an index of the transformed table 2306. Subsequently, a transformed-data-processing method 2308 is used for processing the H2 transformed data 2307 to generate H3 processed transformed data 2309. The processed transformed data H3 in this state is ready for second transformation by using data for disturbance. Then, a data transform method 2310 is used to transform the H3 processed transformed data 2309 by using the X1i first disturbance data 2303 to generate H4 transformed processed transformed data 2311. The H4 transformed processed transformed data 2311 is thus data completing first transformation and second transformation. Subsequently, a data inverse-transformation method 2312 is used to carrying out inverse transformation on the H4 transformed processed transformed data 2309 by using X2o processed second disturbance data 2313 to generate H5 processed transformed data 2314. The H5 processed transformed data 2314 is obtained as a result of removing the second transformation. Since the H5 processed transformed data 2314 is thus data completing the first transformation only, the H5 processed transformed data 2314 can be used as an index pointing to an entry of a transformed table. Thus, a transformed-table access method 2315 is then used for looking up the transformed table 2306 for H6 transformed data 2316 indicated by the H5 transformed data 2314. Subsequently, a transformed-data processing method 2317 is used for processing the H6 transformed data 2316 to generate H7 processed transformed data 2318. Finally, a data inverse-transformation method 2319 is used to carrying out inverse transformation on the H7 processed transformed data 2318 by using X20 processed second disturbance data 2313 to generate D2 processed data 2320. In this embodiment, a transformation method and, hence an inverse-transformation method are each used only twice. It should be noted that such methods can each be used any number of times by following the same procedure.

FIG. 19 is a diagram showing a data flow in another embodiment implementing a technique to generate X1i first disturbance data 1903, a transformed table 1908 and X2o processed second disturbance data 1909, which are used in the embodiment shown in FIG. 23.

FIG. 20 is a diagram showing a data flow in a further embodiment implementing a technique to generate X1i first disturbance data 2005, a transformed table 2010 and X2o processed second disturbance data 2011, which are used in the embodiment shown in FIG. 23.

FIG. 21 is a diagram showing a data flow in a still further embodiment implementing a technique to generate X1i first disturbance data 2105, a transformed table 2110 and X2o processed second disturbance data 2107, which are used in the embodiment shown in FIG. 23.

FIG. 22 is a diagram showing a data flow in a still further embodiment implementing a technique to generate X1i first disturbance data 2203, a transformed table 2204 and X2o processed second disturbance data 2205, which are used in the embodiment shown in FIG. 23.

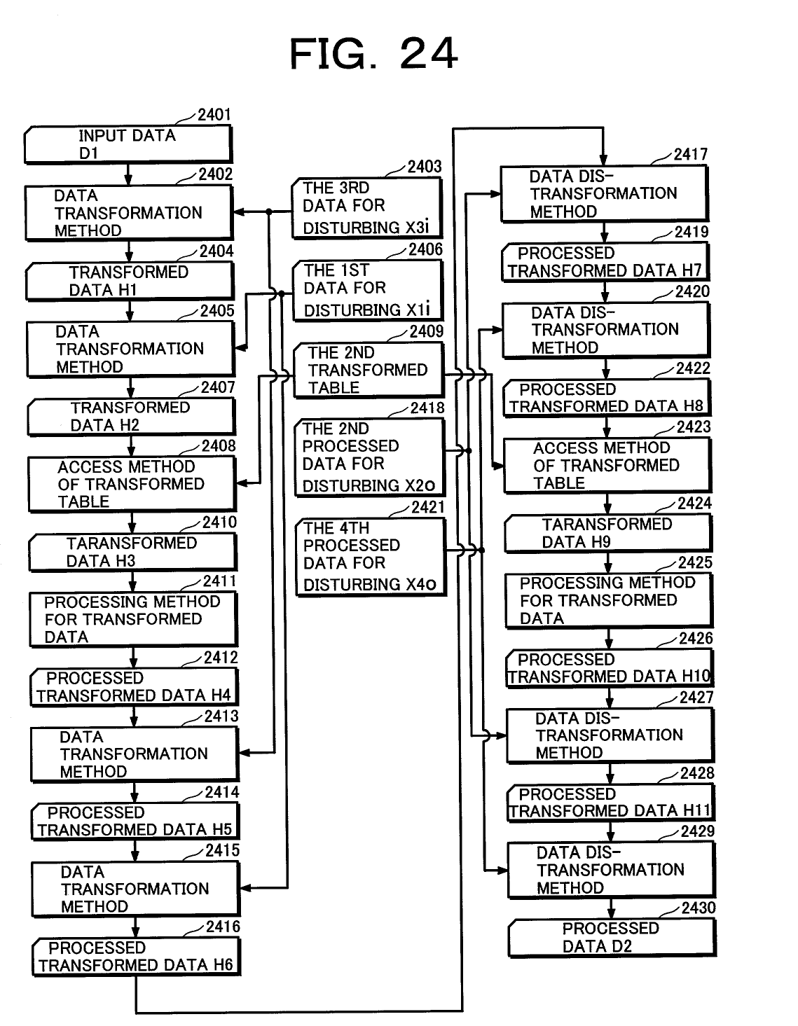

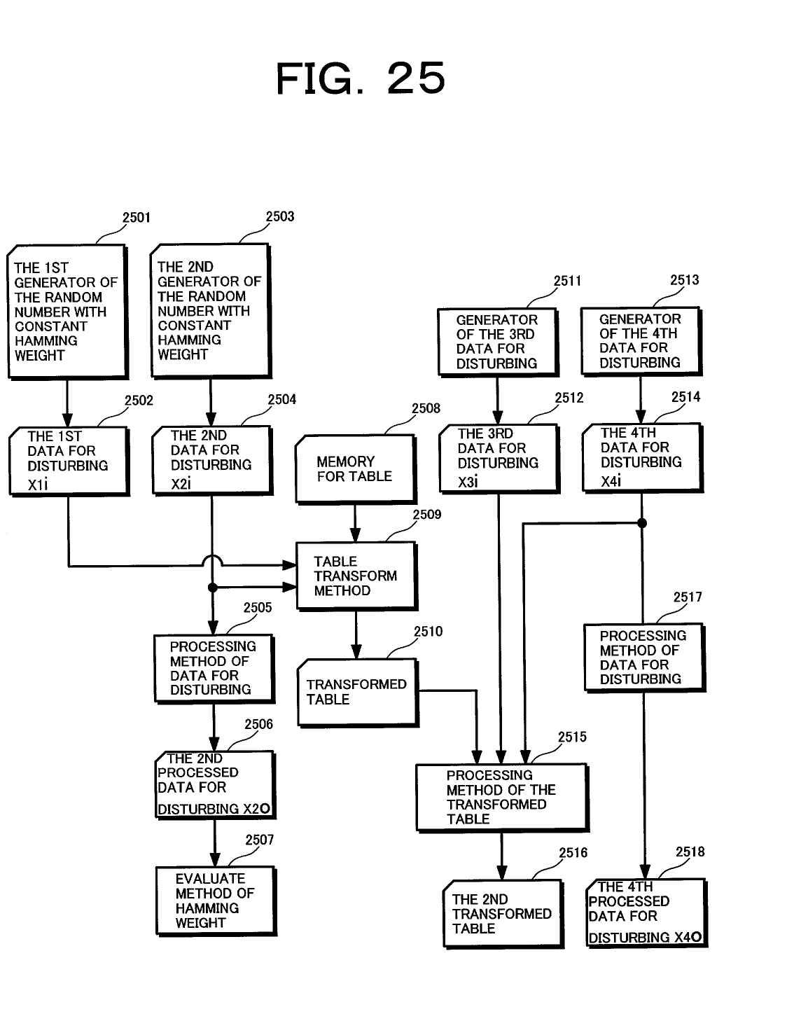

FIG. 24 is a diagram showing another embodiment implementing an information-processing apparatus wherein input data is subjected to repetition of a process comprising a transformation using a transformed table and transformations using 2 different pieces of data for disturbance of an index pointing to an entry in the transformed table and a result of transformation twice. The transformation of an index pointing to an entry in the transformed table and a result of 2 transformations by using 2 different pieces of disturbance data effectively disturbs observation of the waveform of current consumption by using only few resources. Such effective disturbance makes the current difficult to analyze.

As a method for generating 4 different pieces of data for disturbance and a second transformed table which are used in this embodiment, the embodiments shown in FIGS. 19 to 23 can be used. In the case of an embodiment wherein a plurality of values having uniform constant hamming weights is prepared in advance and one of the values is selected, for example, if the number of variations of the values is small and the processing to transform a value by using data for disturbance is known, all the pieces of data for disturbance can be inferred. If the processing to transform a value by using data for disturbance is the XOR processing and the transformed value is equal to the data for disturbance, the result of the transformation is 0. It is thus not impossible to infer the set of data for disturbance prepared in advance. In order to solve this problem, after transformation using disturbance data with a variable hamming weight to give a result of transformation, disturbance data with a constant hamming weight is used to further disturb the result of transformation. In this way, the data for disturbance will be no longer easy to infer. The disturbance data with a variable hamming weight typically represents all values that can each be expressed by using the number of bits. Details of the processing are explained by referring to FIG. 24.

As shown in the figure, first of all, a data transform method 2402 is adopted for transforming D1 input data 2401 by using X3i third disturbance data 2403 to generate H1 transformed data 2404. The X3i third disturbance data 2403 is one of 2 pieces of data for transformation of indexes pointing to an entry in a table used in transformation by looking up the table for the entry. Before being used for looking up the table, the index needs to be further transformed by using X1i first disturbance data 2406. That is to say, a data transform method 2405 is adopted for transforming the H1 transformed data 2404 by using the X1i first disturbance data 2406 to generate H2 transformed data 2407. Then, a transformed-table access method 2408 is used for looking up a second transformed table 2409 for H3 transformed data 2410 pointed to by the H2 transformed data 2407 serving as an index pointing to an entry in the second transformed table 2409. Subsequently, a transformed-data-processing method 2411 is used for processing the H3 transformed data 2410 to produce H4 processed transformed data 2412. Then, a data transform method 2413 is adopted for transforming the H4 processed transformed data 2412 by using the X3i third disturbance data 2403 to generate H5 transformed processed transformed data 2414. Furthermore, a data transform method 2415 is adopted for transforming the H5 transformed processed transformed data 2414 by using the X1i first disturbance data 2406 to generate H6 transformed processed transformed data 2416. The H6 transformed processed transformed data 2416 is a result of transformations using the X3i third disturbance data 2403 and the X1i first disturbance data 2406 respectively as well as a transformation based on the second transformed table 2409 and thus ready for inverse-transformation by using X2o processed second disturbance data 2418 and X4o processed fourth disturbance data 2421. For this reason, a data inverse-transformation method 2417 is adopted for carrying out inverse transformation on the H6 transformed processed transformed data 2416 by using the X2o processed second disturbance data 2418 to generate H7 transformed processed transformed data 2419. Then, a data inverse-transformation method 2420 is adopted for carrying out inverse transformation on the H7 transformed processed transformed data 2419 by using the X4o processed fourth disturbance data 2421 to generate H8 processed transformed data 2422. Since the H8 processed transformed data 2422 is a result of transformations using the X3i third disturbance data 2403 and the X1i first disturbance data 2406 respectively, the H8 processed transformed data 2422 can be used as an index pointing to an entry in the second transformed table 2409. For this reason, a transformed-table access method 2423 is used for looking up the second transformed table 2409 for H9 transformed data 2424 pointed to by the H8 processed transformed data 2422 serving as an index pointing to an entry in the second transformed table 2409. Subsequently, a transformed-data-processing method 2425 is further used for processing the H9 transformed data 2424 to produce H10 processed transformed data 2426. The H10 processed transformed data 2426 is a result of transformations by using the X2o processed second disturbance data 2418 and the X4o processed fourth disturbance data 2421 respectively. For this reason, a data inverse-transformation method 2427 is adopted for carrying out inverse transformation on the H10 processed transformed data 2426 by using the X2o processed second disturbance data 2418 to generate H11 processed transformed data 2428. Finally, a data inverse-transformation method 2429 is adopted for carrying out inverse transformation on the H11 processed transformed data 2428 by using the X4o processed fourth disturbance data 2421 to generate the eventual D2 processed data 2430.

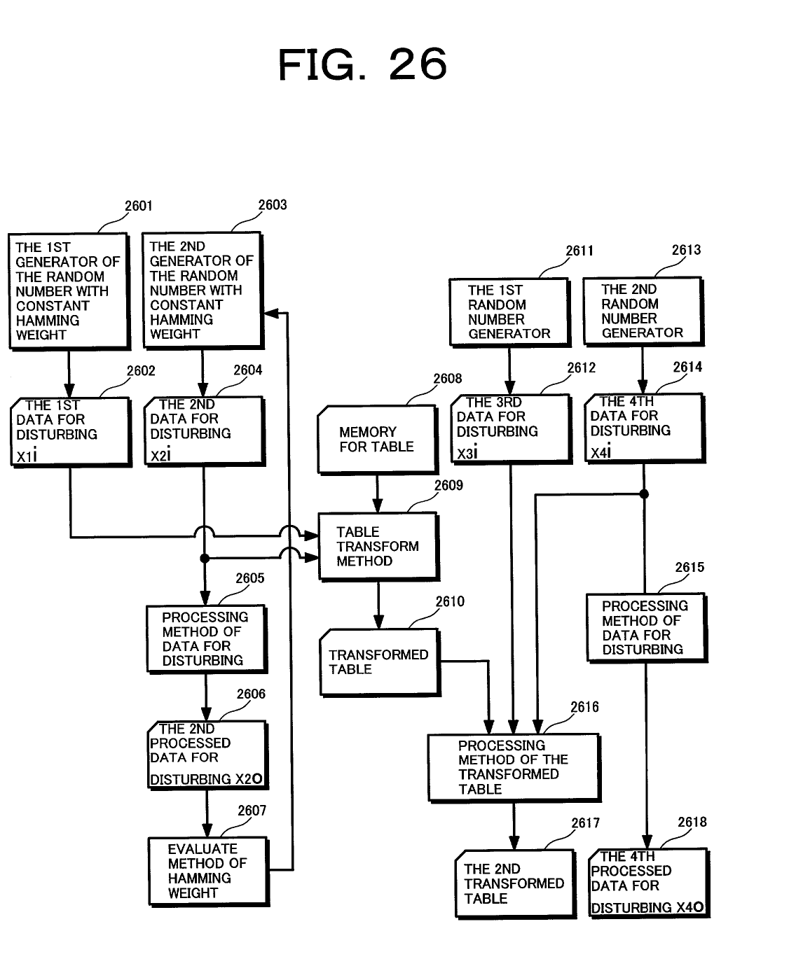

FIG. 26 is a diagram showing a data flow in an embodiment implementing a technique to generate X1i first disturbance data 2602, X3i third disturbance data 2612, X2o processed second disturbance data 2606, X4o processed fourth disturbance data 2618 and a second transformed table 2617, which are used in the embodiment shown in FIG. 24. In the procedure shown in FIG. 26, first of all, by adoption of the technique implemented by the embodiment shown in FIG. 19, X1i first disturbance data 2602, X2o processed second disturbance data 2606 and a transformed table 2610 are generated. Then, a transformed-table-processing method 2616 is adopted for processing the transformed table 2610 by using X3i third disturbance data 2612 produced by adoption of a third-disturbance-data-generating method 2611 and using X4i fourth disturbance data 2614 produced by adoption of a fourth-disturbance-data-generating method 2613 to generate a second transformed table 2617. In addition, a disturbance-data-processing method 2615 is used for computing X4o processed disturbance data 2618, which is required for inverse transformation of data, from the X4i fourth disturbance data 2614.

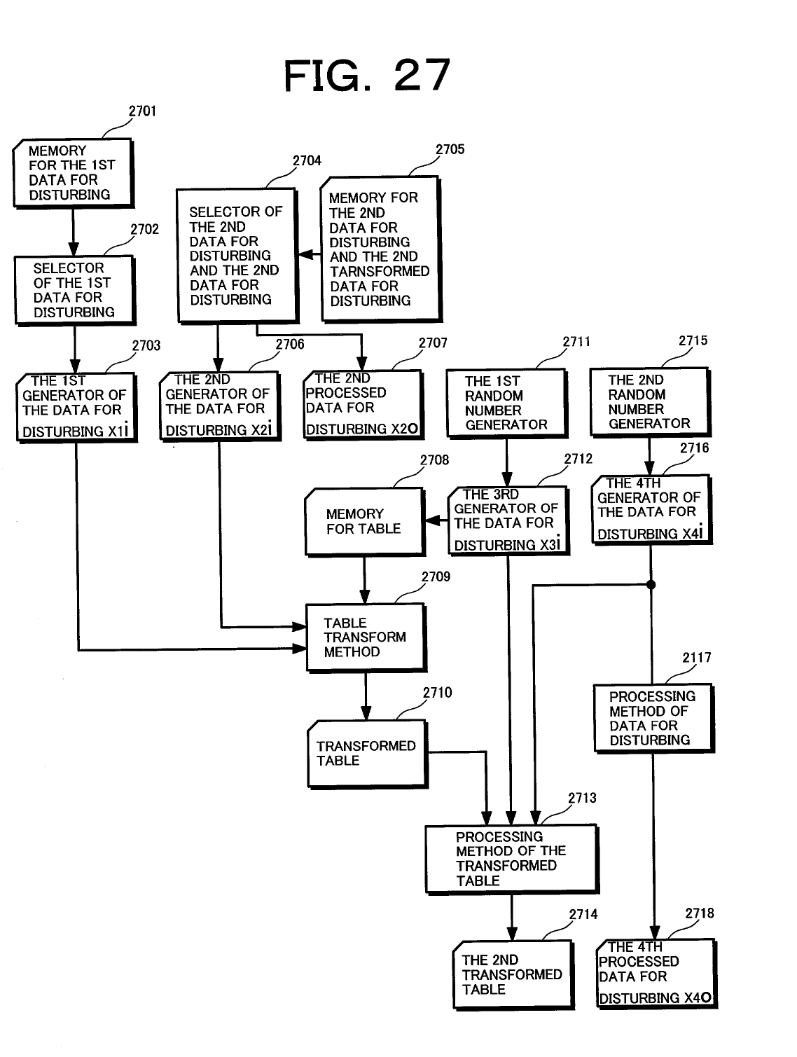

FIG. 27 is a diagram showing a data flow in another embodiment implementing a technique to generate X1i first disturbance data 2703, X3i third disturbance data 2712, X2o processed second disturbance data 2707, X4o processed fourth disturbance data 2718 and a second transformed table 2714, which are used in the embodiment shown in FIG. 24. In the procedure shown in FIG. 27, first of all, by adoption of the technique implemented by the embodiment shown in FIG. 20, X1i first disturbance data 2703, X2o processed second disturbance data 2706 and a transformed table 2710 are generated. Then, a transformed-table-processing method 2713 is adopted for processing the transformed table 2710 by using X3i third disturbance data 2712 produced by adoption of a third-disturbance-data-generating method 2711 and using X4i fourth disturbance data 2716 produced by adoption of a fourth-disturbance-data-generating method 2715 to generate a second transformed table 2714. In addition, a disturbance-data-processing method 2717 is used for computing X4o processed disturbance data 2718, which is required for inverse transformation of data, from the X4i fourth disturbance data 2716.

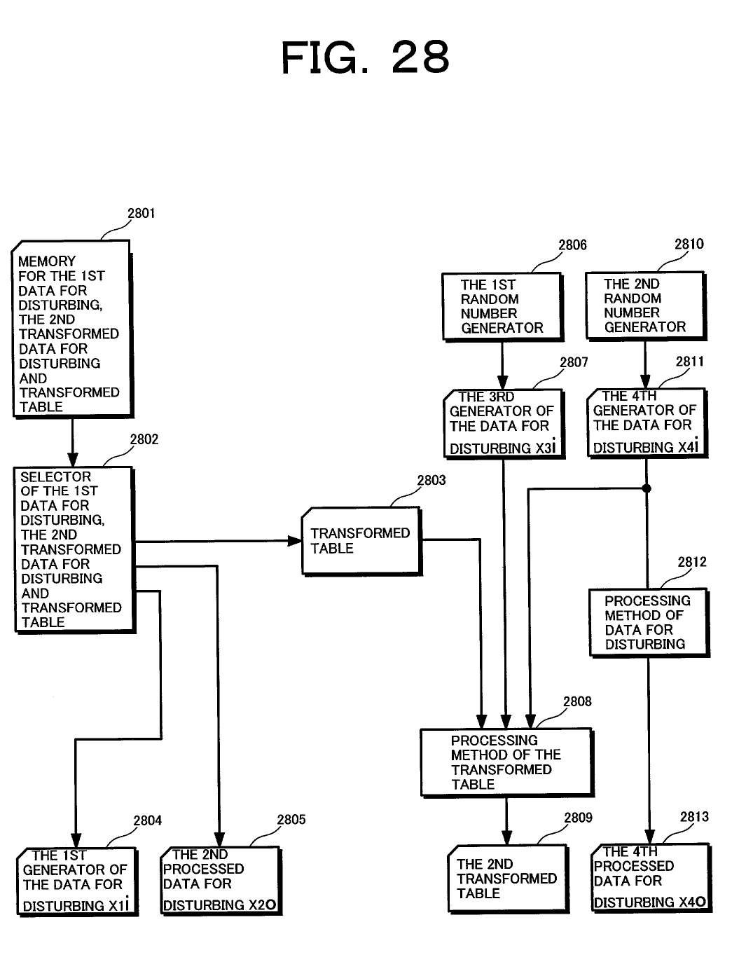

FIG. 28 is a diagram showing a data flow in a further embodiment implementing a technique to generate X1i first disturbance data 2804, X3i third disturbance data 2807, X2o processed second disturbance data 2805, X4o processed fourth disturbance data 2813 and a second transformed table 2809, which are used in the embodiment shown in FIG. 24.

In the procedure shown in FIG. 28, first of all, by adoption of the technique implemented by the embodiment shown in FIG. 21, X1i first disturbance data 2804, X2o processed second disturbance data 2805 and a transformed table 2803 are generated. Then, a transformed-table-processing method 2808 is adopted for processing the transformed table 2803 by using X3i third disturbance data 2807 produced by adoption of a third-disturbance-data-generating method 2806 and using X4i fourth disturbance data 2811 produced by adoption of a fourth-disturbance-data-generating method 2810 to generate a second transformed table 2809. In addition, a disturbance-data-processing method 2812 is used for computing X4o processed disturbance data 2813, which is required for inverse transformation of data, from the X4i fourth disturbance data 2811.

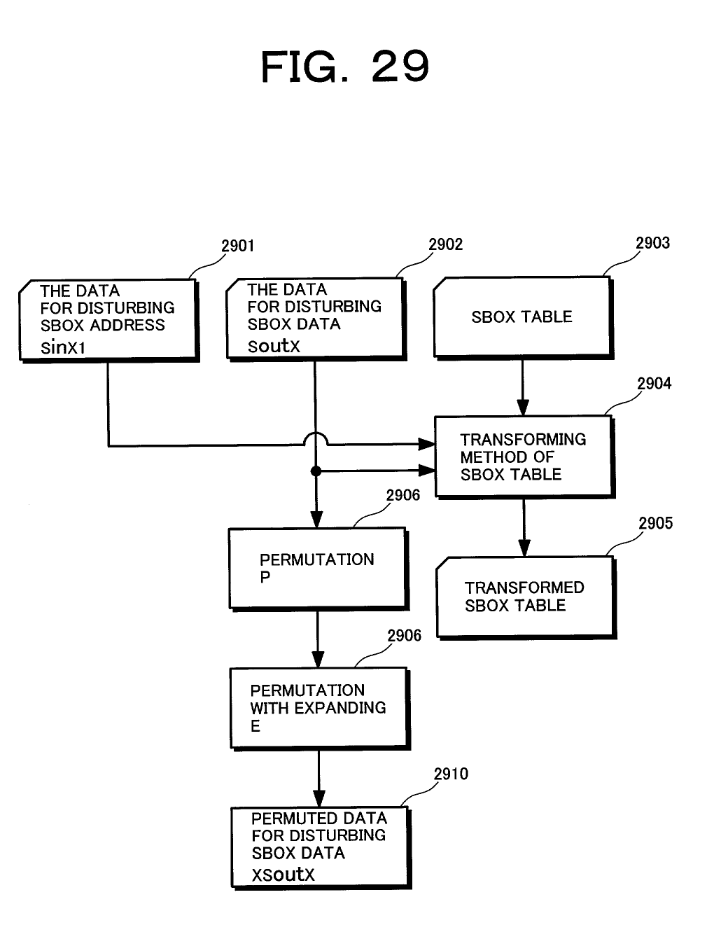

Next, other embodiments are explained by referring to FIGS. 29, 30, 31, 32, 33, 34, 35, 36, 37, 38, 39, 45, 46 and 47.

First of all, processing to transform an SBOX table and data for disturbance are explained by referring to FIG. 29. An SBOX transform method 2904 is adopted for transforming an SBOX table 2903 by using SinX1 SBOX-address disturbance data 2901 and SoutX SBOX-content disturbance data 2902 to generate a transformed table 2905. Addresses and data of the SBOX table 2903 are transformed by carrying out XOR processing. In addition, the SoutX SBOX-content disturbance data 2902 is subjected to P (permutation) processing 2906 and E (permutation with expansion) processing 2907 to generate SBOX-data-permuted disturbance data 2909. To sum up, the processing described above can be expressed by Eqs. 38 and 39 as follows:

XSBOX [i XOR SinXi]=SBOX[i] XOR SoutX (Eq. 38)

XSoutX=E(P(SoutX)) (Eq. 39)

where notation SBOX [0 - - - 63] denotes the SBOX table, notation XSBOX [0 - - - 63] denotes the transformed SBOX table, notation P ( ) denotes the P permutation and notation E ( ) denotes the E (permutation with expansion) processing. As methods for generating the SinX1 SBOX-address disturbance data 2901 and the SoutX1 SBOX-content disturbance data 2902, the techniques shown in FIGS. 19 to 22 can be adopted.

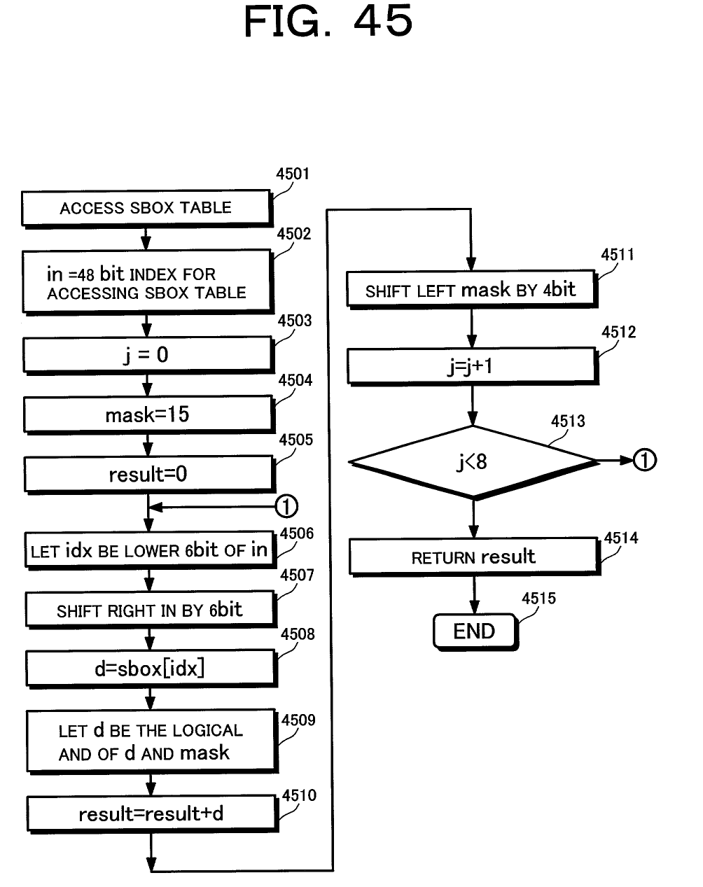

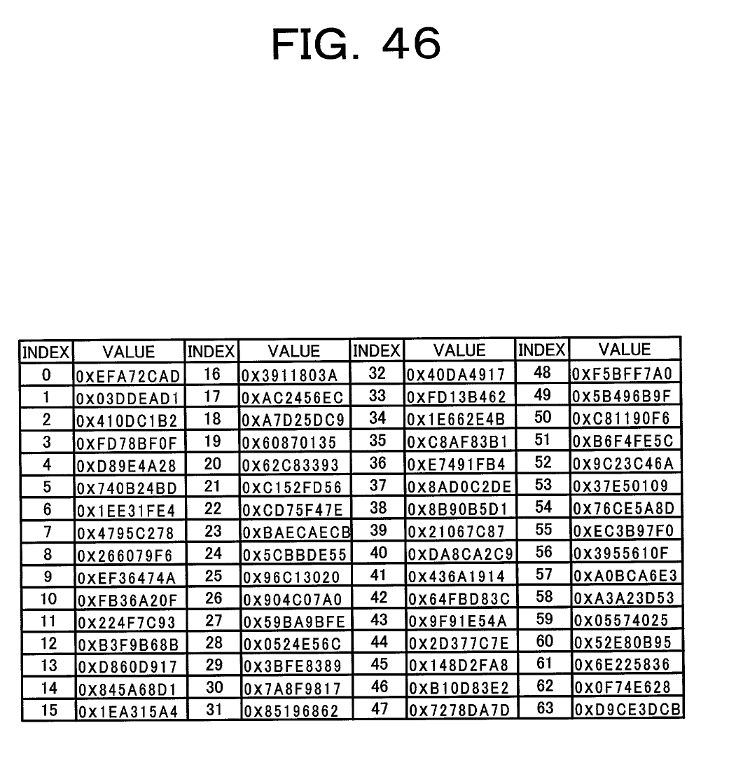

FIG. 46 is a diagram showing an embodiment implementing an SBOX storage format. As shown in the figure, the SBOX table is stored as a one-dimensional array of 64 integers each having a length of 32 bits. FIG. 45 is a flowchart of an embodiment representing a typical technique for looking up the SBOX table having a format like the one shown in FIG. 46. In the embodiment shown in FIG. 45, an index pointing to an entry in the SBOX table has a length of 48 bits. The 48-bit index is disassembled into eight 6-bit portions which are each used to look up the SBOX table for a 32-bit integer entry pointed to by the 6-bit portion. The 32-bit integer entry found in the lookup operation is masked by using a mask according to the position of the 6-bit portion to extract necessary data from the 32-bit integer entry. By sequentially repeating the lookup operation for all the eight 6-bit portions and sequentially adding a new piece of extracted necessary data to a sum of such pieces obtained so far, a final result of the lookup operations is obtained. The repetition of the lookup operation to make an access to the SBOX table is explained by referring to the flowchart shown in FIG. 45. As shown in the figure, the lookup repetition begins with a step 4502 at which a 48-bit numerical value input as an index to be used in the lookup operation is stored in a variable IN. As described above, the index is divided into eight 6-bit portions which are each to be used in one lookup operation. A variable j serves as a counter for counting the number of times the lookup operation has been carried out. At the next step 4503, the counter j is initialized at 0. Then, at the next step 4504, a variable mask for masking a lookup result is initialized at 15 which is represented by all ones set in the 4 least significant bits of the variable mask. Subsequently, at the next step 4505, a variable result used for storing a lookup-operation result is initialized at 0. Then, at the next step 4506, the 6 least significant bits of the variable IN are extracted and stored in a variable idx. Subsequently, at the next step 4507, the variable IN is shifted to the right by 6 bits to prepare new 6 least significant bits to be extracted next. Then, at the next step 4508, a lookup-operation result pointed to by an index stored in the variable idx is retrieved from the SBOX table and stored in a variable d. Subsequently, at the next step 4509, an AND operation is carried out on the variable d and the variable mask to generate a logical product which is stored in the variable d. Then, at the next step 4510, the variable d is added to the variable result. Subsequently, at the next step 4511, the variable mask is shifted to the left by 4 bits to prepare a new mask to be used in the next lookup operation. Then, at the next step 4512, the contents of the counter j are incremented by 1. The flow of the lookup repetition then goes on to a step 4513 to form a judgment at to whether of not the contents of the counter j are still smaller than 8. If the contents of the counter j are still smaller than 8, a next lookup operation is carried out, starting with the step 4506. If the contents of the counter j are equal to 8, on the other hand, the flow of the lookup repetition goes on to a step 4514 at which the variable result is passed to a calling routine as a returns value representing the result of the repeated lookup operation.

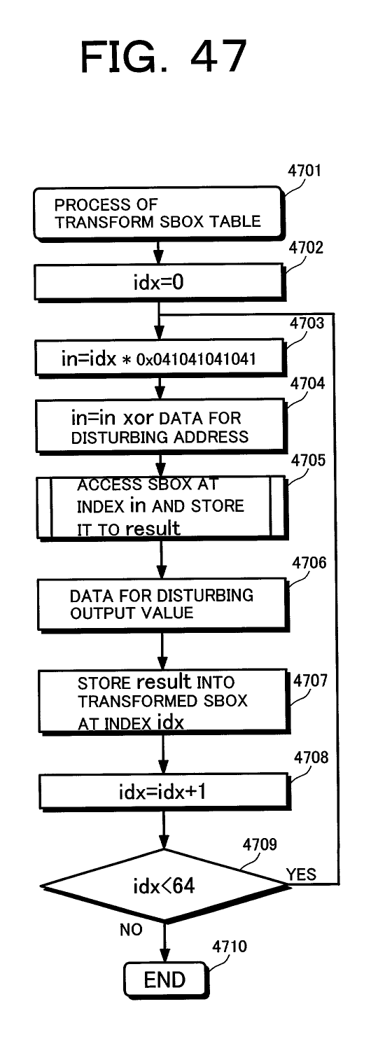

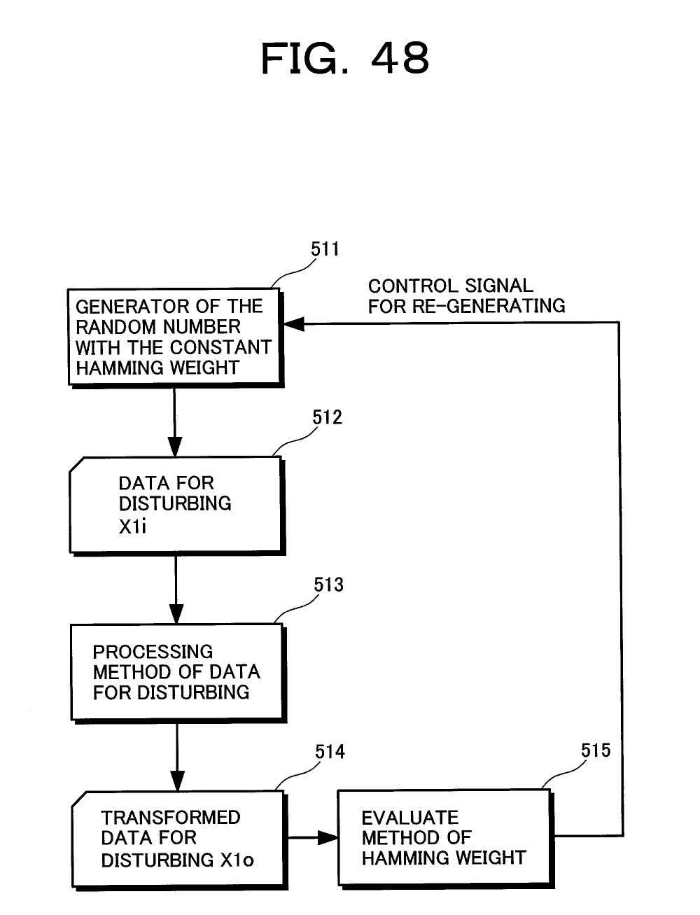

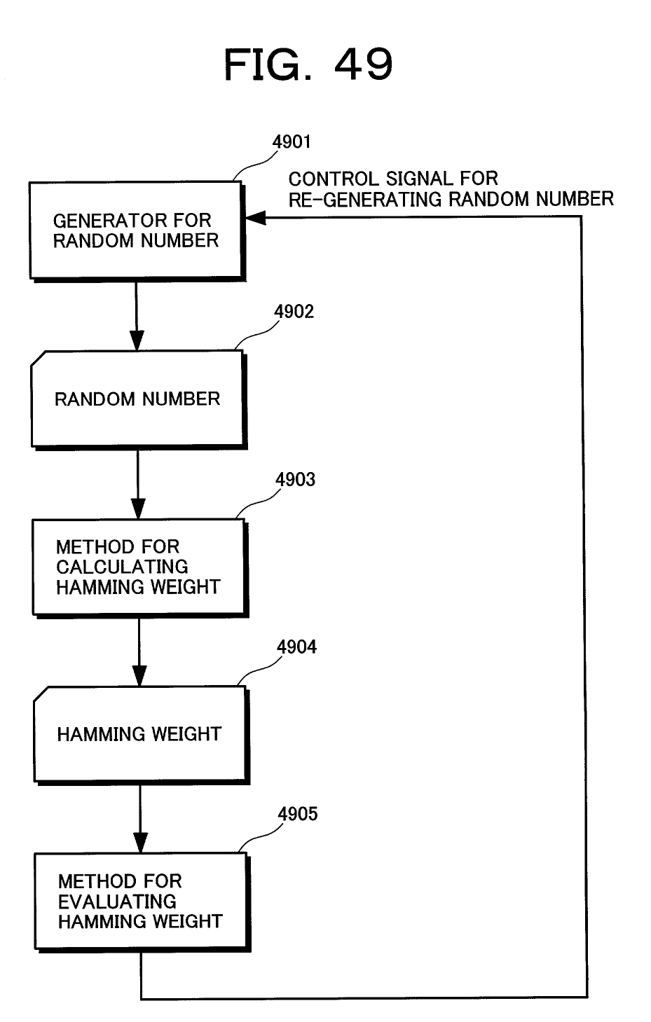

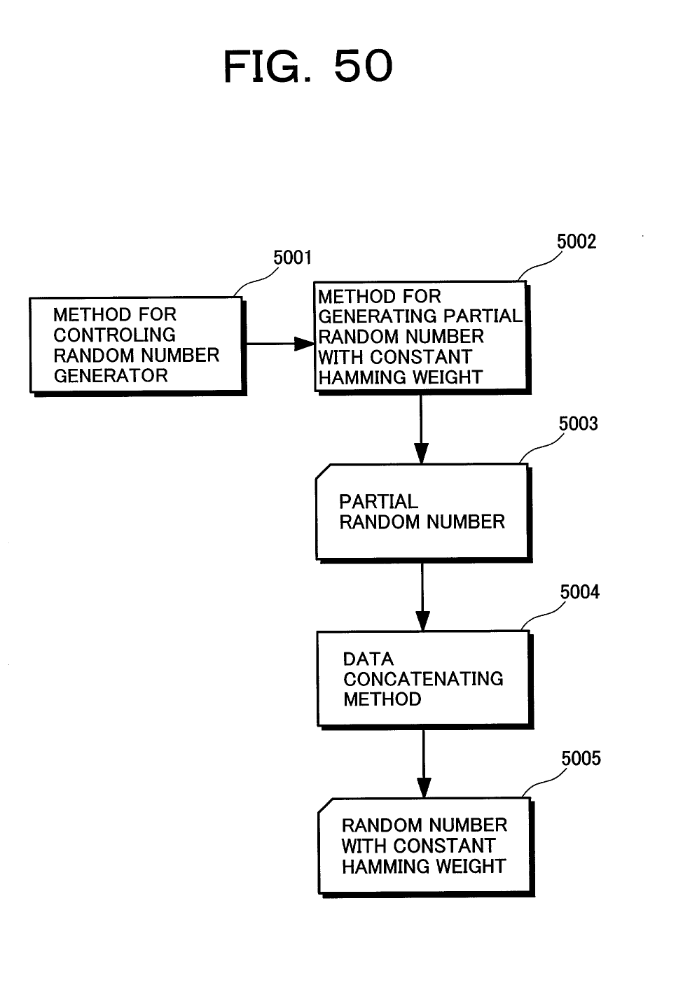

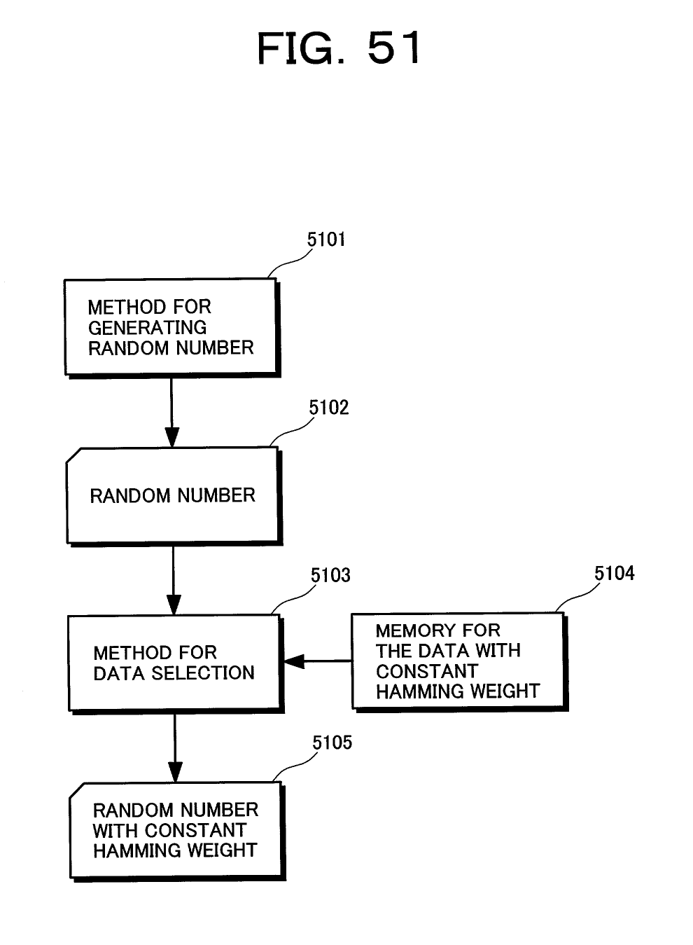

FIG. 47 is a flowchart representing details of the SBOX-table transform method 2904 shown in FIG. 29. The method is adopted as a procedure for transforming the SBOX table having the format shown in FIG. 46. A transformed SBOX table obtained as a result of execution of this procedure can be looked up by carrying out the lookup processing represented by the flowchart shown in FIG. 45. In addition, a transformed SBOX table obtained as a result of execution of the procedure represented by the flowchart shown in FIG. 47 can be treated as an ordinary SBOX table to be transformed again by execution of the procedure using new data for disturbance. That is to say, by execution of the procedure represented by the flowchart shown in FIG. 47 a number of times by using different pieces of data for disturbance, an SBOX table can be transformed the same number of times by using the different pieces of data for disturbance.

The procedure for transforming an SBOX table is explained by referring to the flowchart shown in FIG. 47. As shown in the figure, the flowchart begins with a step 4702 at which a 6-bit index idx for looking up the SBOX table is initialized at 0. Then, at the next step 4703, a 48-bit array is created by concatenating eight 6-bit indexes idx. The created 48-bit array is stored in a variable IN. Subsequently, at the next step 4704, an XOR operation is carried out on the variable IN and 48-bit data for disturbance of an address to produce a result which is stored back in the variable IN. Then, at the next step 4705, the SBOX-table lookup procedure represented by the flowchart shown in FIG. 45 is called with the variable IN passed to the procedure as a 48-bit index for looking up the SBOX table. A result returned by the SBOX-table lookup procedure represented by the flowchart shown in FIG. 45 is stored in a variable result. Subsequently, at the next step 4706, an XOR operation is carried out on the variable result and 32-bit data for disturbance of data to produce a transformed result which is stored back in the variable result. Then, at the next step 4707, the contents of the variable result are transferred to a transformed SBOX table's entries pointed to by the index idx. Subsequently, at the next step 4708, the index idx is incremented by 1. The flow of the procedure then goes on to a step 4709 to form a judgment as to whether or not the index idx is still smaller than 64. If the index idx is still smaller than 64, the processing is repeated, starting with the step 4703. If the index idx has already become equal to 64, on the other hand, the execution of the procedure is terminated.

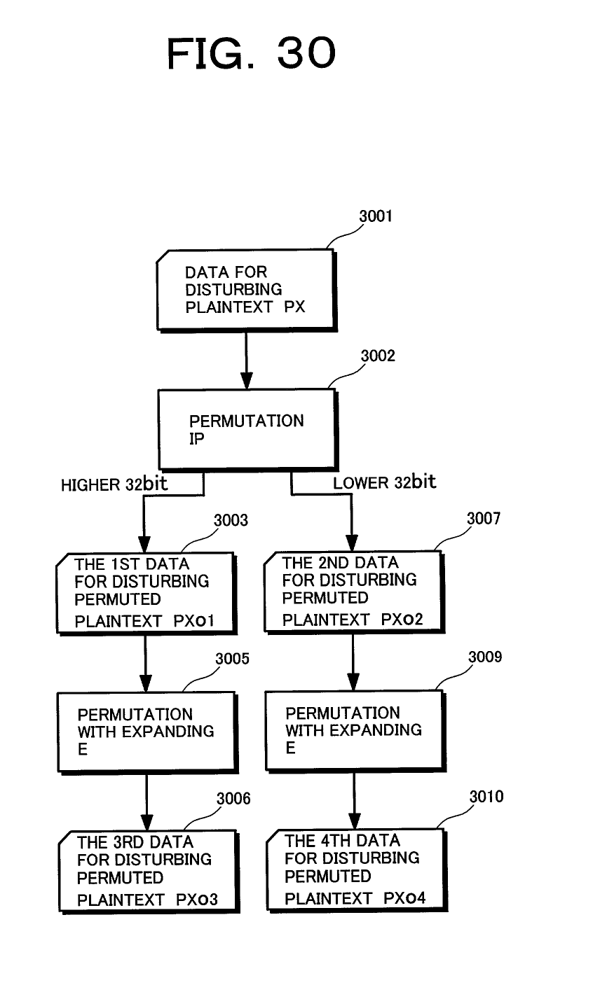

The following description explains generation of PXo1 first permuted-plain-text disturbance data 3003, PXo2 second permuted-plain-text disturbance data 3007, PXo3 third permuted-plain-text disturbance data 3006 and PXo4 fourth permuted-plain-text disturbance data 3010, which are each used for inverse transformation of data transformed by PX plain-text disturbance data, by referring to a data flow shown in FIG. 30. As shown in the figure, IP permutation 3002 is carried out on the PX plain-text disturbance data 3001 to generate 32 high-order bits and 32 low-order bits as the PXo1 first permuted-plain-text disturbance data 3003 and the PXo2 second permuted-plain-text disturbance data 3007 respectively. The PXo1 first permuted-plain-text disturbance data 3003 and the PXo2 second permuted-plain-text disturbance data 3007 are used inverse transformation of transformed data to produce a final result immediately before IP inverse permutation after completion of final-round processing. Then, the PXo1 first permuted-plain-text disturbance data 3003 is subjected to E permutation with expansion 3005 to produce the PXo3 third permuted-plain-text disturbance data 3006. By the same token, the PXo2 second permuted-plain-text disturbance data 3003 is subjected to E permutation with expansion 3009 to produce the PXo4 fourth permuted-plain-text disturbance data 3010. The PXo3 third permuted-plain-text disturbance data 3006 and the PXo4 fourth permuted-plain-text disturbance data 3010 are each used for inverse transformation prior to a lookup operation of an SBOX table in each round.

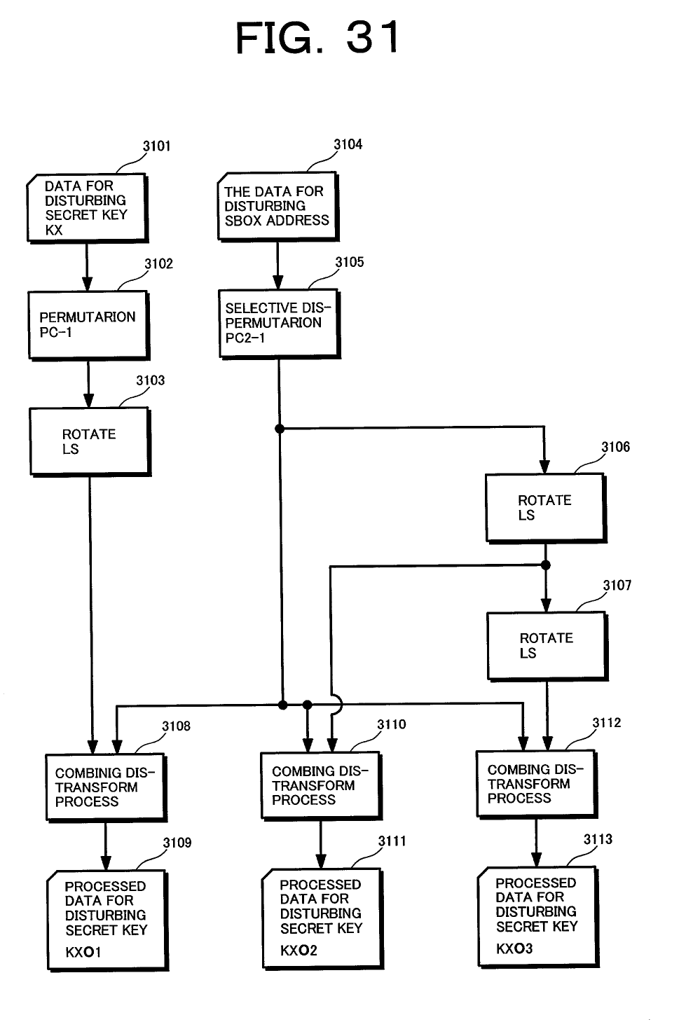

The following description explains data for disturbance of a secret key as well as generation of KXo1 first processed-secret-key disturbance data 3109, KXo2 second processed-secret-key disturbance data 3111 and KXo3 third processed-secret-key disturbance data 3113, which are each used for inverse transformation immediately following LS processing among pieces of key processing for rounds, by referring to a data flow shown in FIG. 31. In this embodiment, it is desired to output the following value:

X XOR XSoutX (Exp. 40)

where notation X denotes an ordinary output of selective permutation PC2.

Let notation PC1 ( ) denote selective permutation PC1, notation LS ( ) denote LS processing and notation K denote a key. In this embodiment, the key K is transformed in an XOR operation with secret-key disturbance data KX. Thus, in the first round, the following equations hold true:

K0=LS (PC1 (KX XOR K)) (Eq. 41)

KXo1=LS (PC1 (KX)) XOR INV_PC2 (SinX1) (Eq. 42)

K1=K0 XOR KXo1 (Eq. 43)

K1_OUT=PC2 (K1) (Eq. 44)

By using an output from PC2 as K1_OUT, it is possible to obtain a value expressed by Exp. 40. Next, values for the second round are given as follows:

KXo2=LS (INV_PC2 (SinX1)) XOR INV_PC2 (SinX1) (Eq. 45)

K2=LS (K1) XOR KXo2 (Eq. 46)

K2_OUT PC2 (K2)

In a round wherein a 2-bit rotation is carried out in LS processing as is the case with the third round for example, the values are given as follows:

KXo3=LS (LS(INV_PC2 (SinX1))) XOR INV_PC2 (SinX1) (Eq. 47)

K3=LS(LS (K2)) XOR KXo3

K3_OUT=PC2 (K3) (Eq. 48)

By using an output from PC2 as K3_OUT, it is possible to obtain a value expressed by Exp. 40. Since there are only 2 types of bits shifted in LS processing, there are required 3 types of value, namely, KXo1 for the first round, KXo2 with a 1-bit shift in LS processing and KXo3 with a 2-bit shift in LS processing. With these 3 values, all kinds of inverse transformation can be carried out in the sixteenth round. Computations of KXo1, KXo2 and KXo3 which are expressed by Eqs. 41, 45 and 47 respectively are carried out in accordance with a data flow shown in FIG. 31. In this embodiment, transformation is implemented as an XOR operation. Thus, combining inverse transform processes 3108, 3110 and 3112 shown in FIG. 31 are also each carried out as an XOR operation in this embodiment.

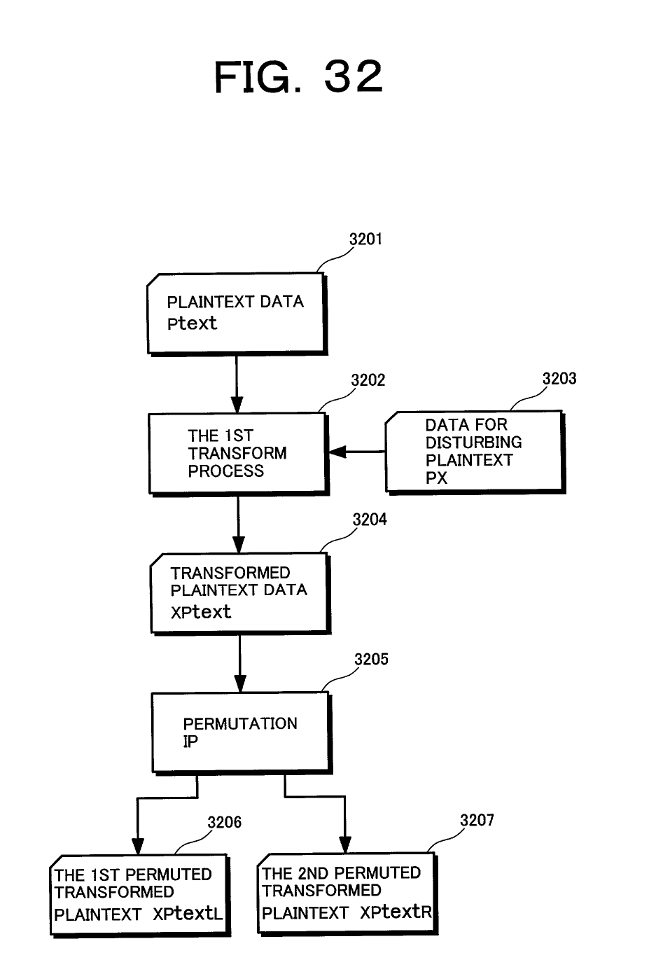

FIG. 32 is a diagram showing a data flow in an embodiment implementing a technique for transforming a Ptext plain text 3201.

The Ptext plain text 3201 is transformed by using PX plain-text disturbance data 3203 in a first transform process 3202 to produce XPtext transformed plain text 3204. The first transform process 3202 carried out in this embodiment is an XOR operation and can thus be expressed by Eq. 49 as follows:

XPtext=Ptext XOR PX (Eq. 49)

The XPtext transformed plain text 3204 is subjected to IP permutation 3205 for generating 32 high-order bits and 32 low-order bits, which are used as a XPtextL first permuted transformed plain text 3206 and a XPtextR second permuted transformed plain text 3207 respectively. If the first transformation process 3202 is eliminated from the data flow, a data flow of the ordinary DES encryption is obtained.

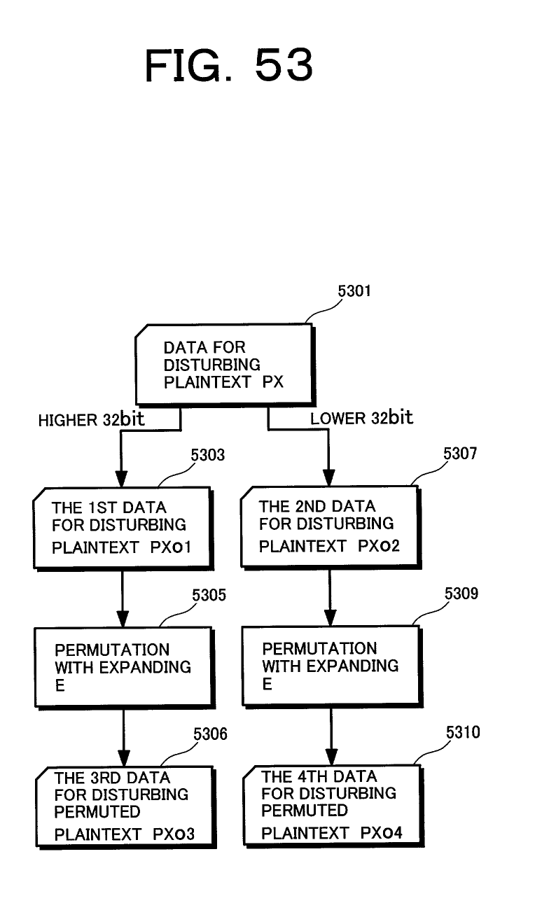

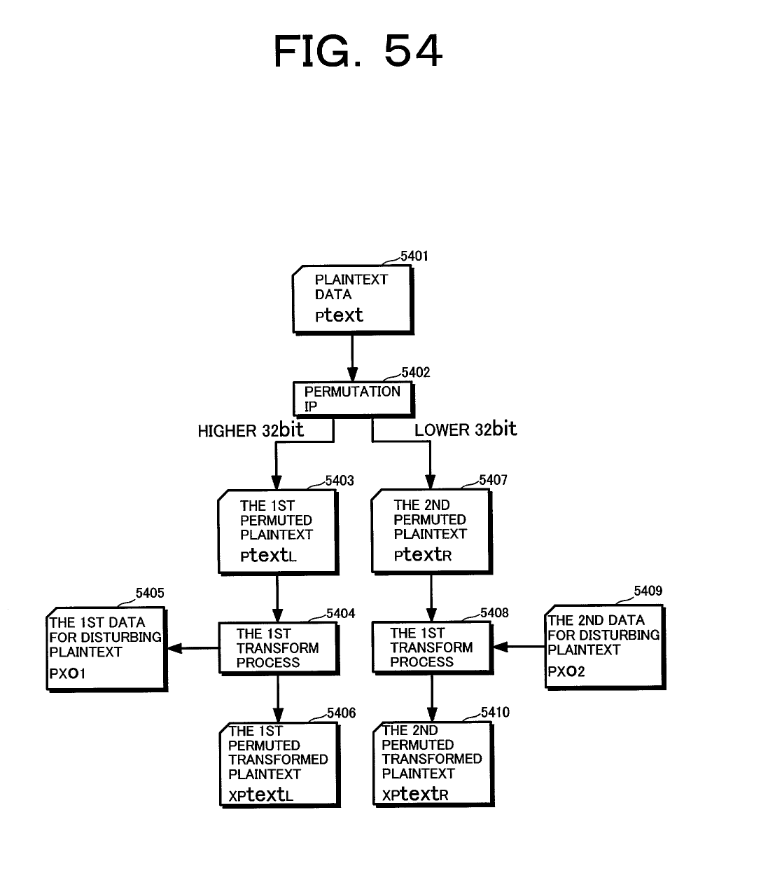

FIG. 54 is a diagram showing a data flow of another embodiment for generating a XPtextL first permuted transformed plain text and a XPtextR second permuted transformed plain text. As shown in the figure, in this other embodiment, a Ptext plain text 5401 is first subjected to IP permutation 5402 to generate the PtextL first permuted plain text 5403 and the XPtextR second permuted plain text respectively 5407 respectively. Then, a first transform method 5404 and a second transform method 5408 are used for transformations to generate the XPtextL first permuted transformed plain text 5406 and the XPtextR second permuted transformed plain text 5410 respectively. In this other embodiment, PXo1 plain-text disturbance data 5405 and PXo2 plain-text disturbance data 5409 are not involved in the IP permutation 5402, making the processing more efficient accordingly. FIG. 53 is a data flow in a first embodiment implementing a technique to process data for disturbance of a plain text.

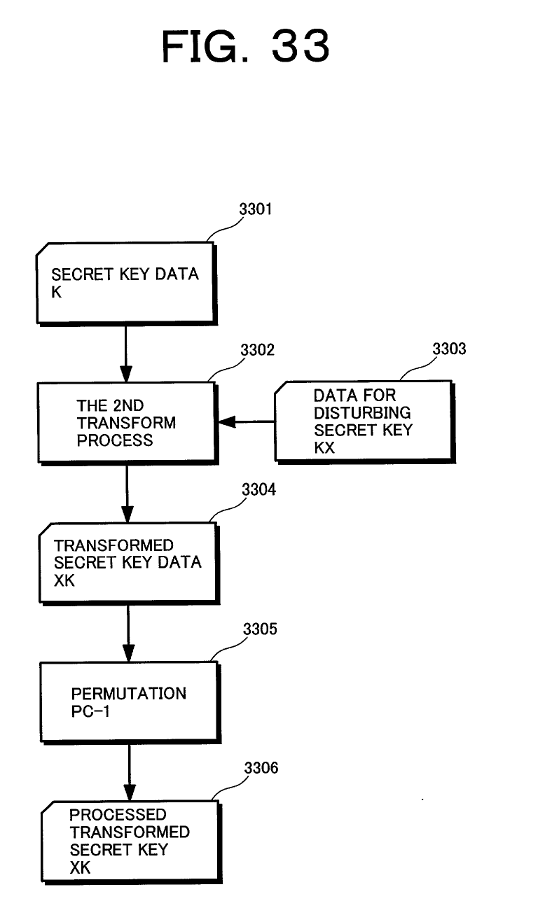

FIG. 33 is a diagram showing a data flow in an embodiment implementing a technique to process a K secret key 3301. As shown in the figure, the K secret key 3301 is subjected to a second transformation process 3302 using KX secret-key disturbance data 3303 to generate an XK transformed secret key 3304. The second transformation process 3302 carried out in this embodiment is an XOR operation and can thus be expressed by Eq. 50 as follows:

XK=K XOR KX (Eq. 50)

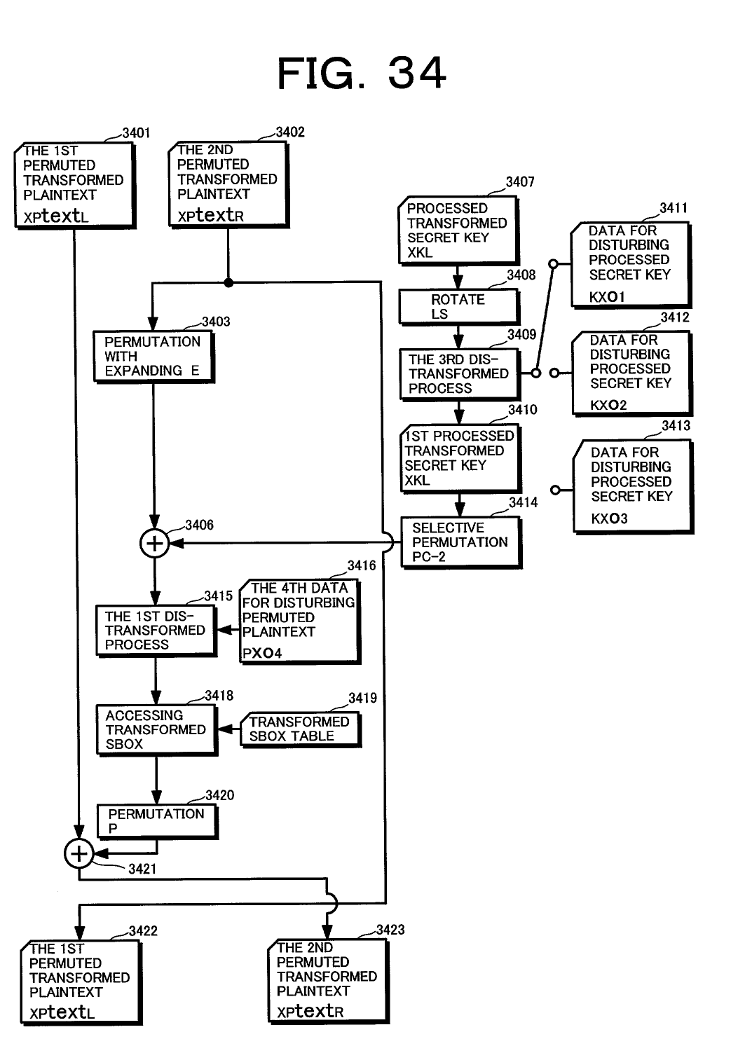

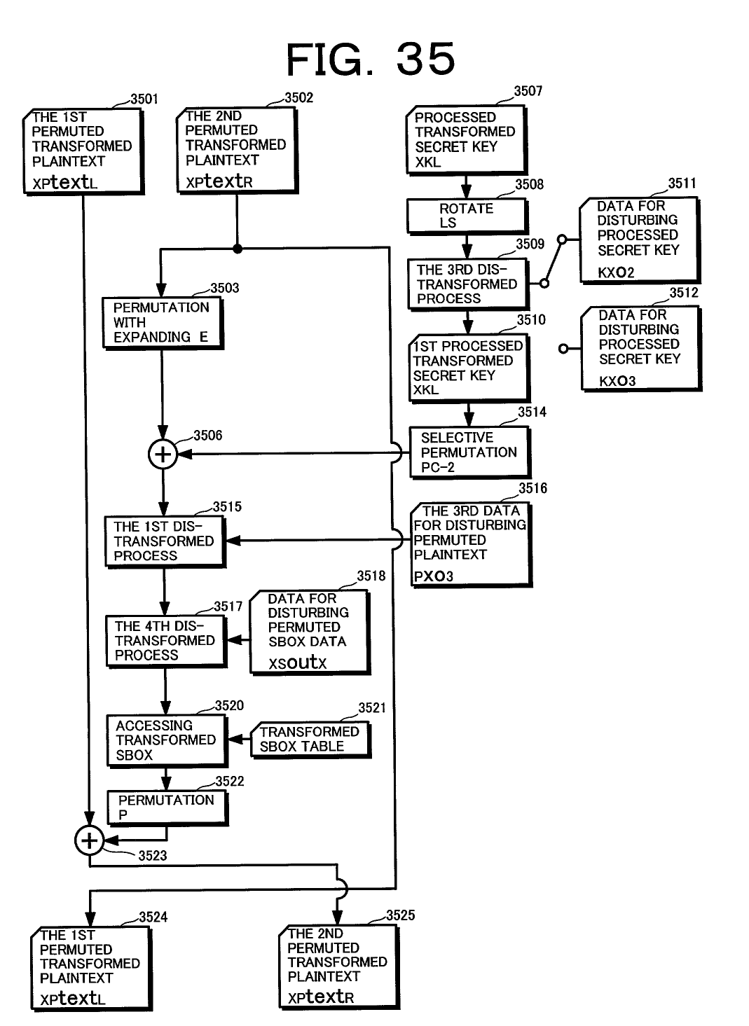

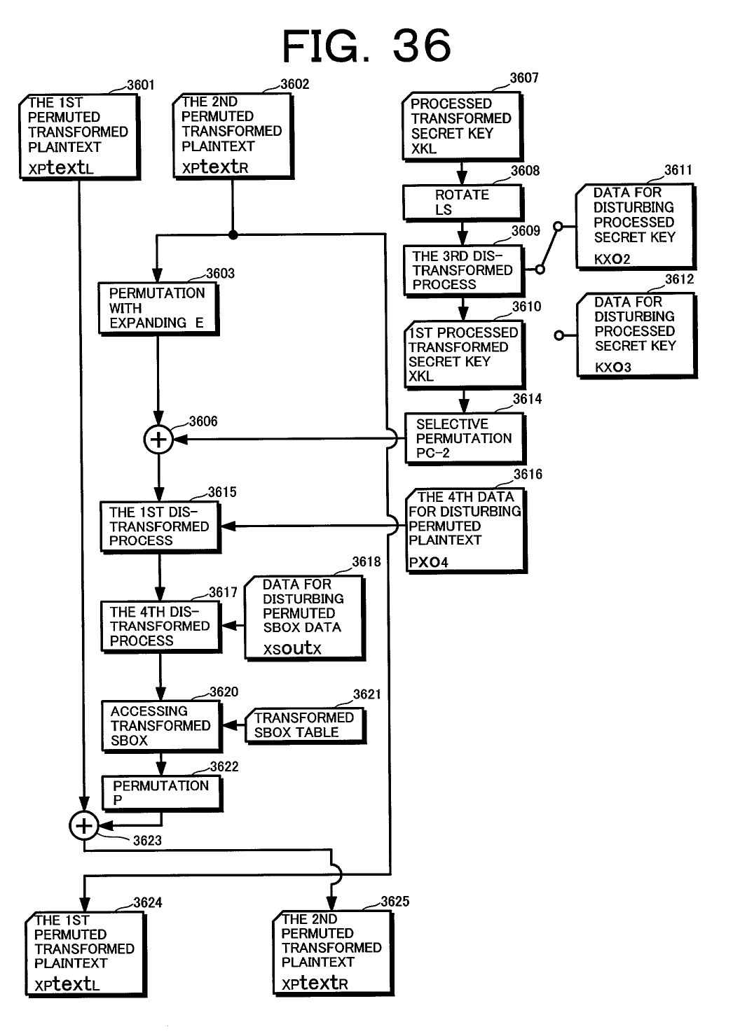

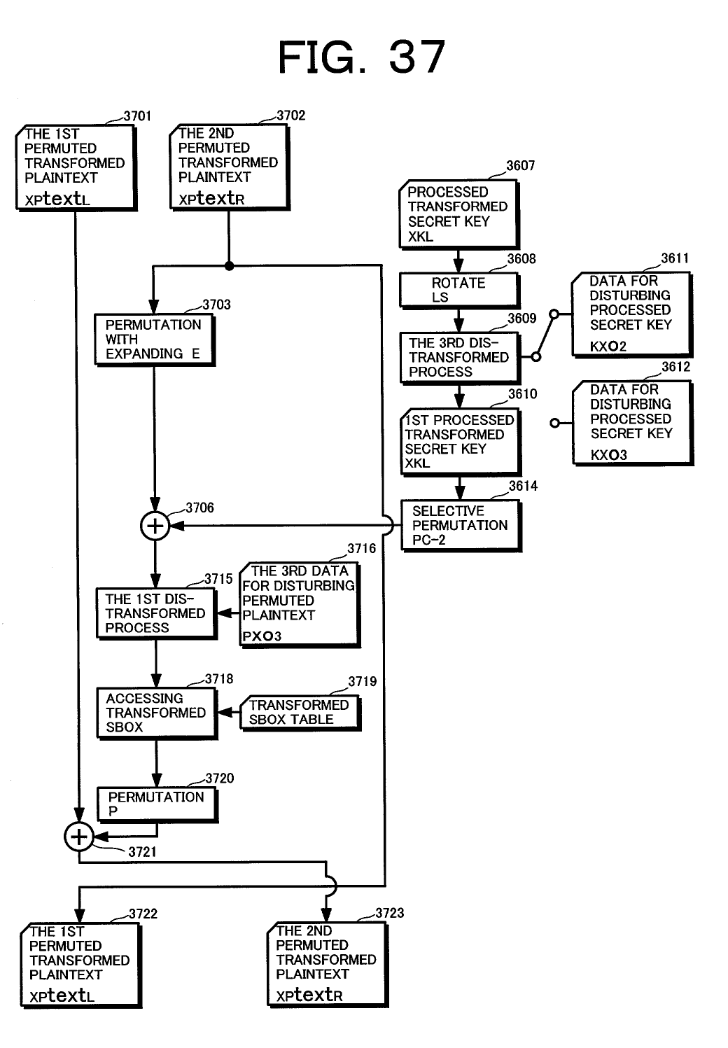

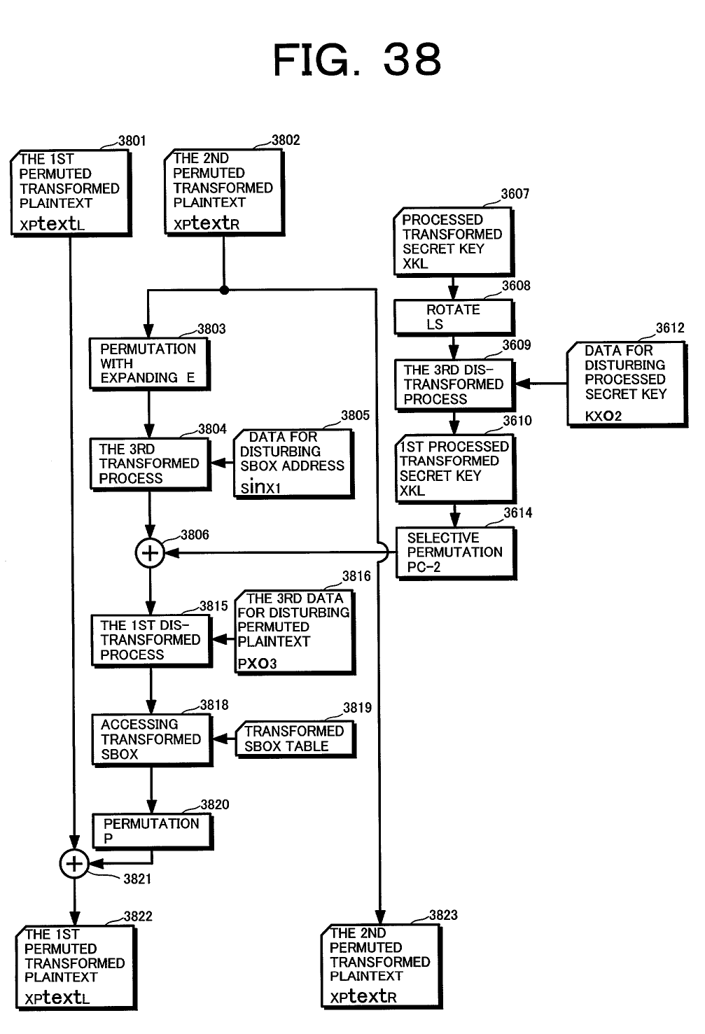

Next, pieces of processing in rounds are explained by referring to data flows shown in FIGS. 34, 35, 36, 37 and 38. Due to differences between rounds, these 5 figures are different from each other in that, FIG. 34 shows a data flow for pieces of processing in the first, fifth, ninth and thirteenth rounds, FIG. 35 shows a data flow for pieces of processing in the second, sixth, tenth and fourteenth rounds, FIG. 36 shows a data flow for pieces of processing in the third, seventh, eleventh and fifteenth rounds, FIG. 37 shows a data flow for pieces of processing in the fourth, eighth and twelfth rounds whereas FIG. 38 shows a data flow for processing in the sixteenth rounds.

The data flow shown in FIG. 34 is explained as follows. In this data flow, notation PtextL denotes a pre-processing value of an XPtextL first permuted transformed plain text 3401 which requires no further transformation. On the other hand, notation PtextR denotes a pre-processing value of an XPtextR second permuted transformed plain text 3402 which was not subjected to transformation. Thus, the XPtextL first permuted transformed plain text 3401 and the XPtextR second permuted transformed plain text 3402 can be expressed by Eqs. 51 and 52 respectively as follows:

XPtextL=PtextL XOR PXo1 (Eq. 51)

XPtextR=PtextR XOR PXo2 (Eq. 52)

By the same token, notation KL denotes a pre-processing value of a XKL processed transformed secret key 3407 which requires no further transformation. The value XKL0 of the XKL processed transformed secret key 3407 is expressed by Eq. 53 as follows:

XKL0=KL XOR PC1 (KX) (Eq. 53)

where notation PC1 ( ) denotes selective permutation PC1.

Let notation XKL1 denote the value of XKL first processed transformed secret key 3410 output by a third transformation process 3409 and notation INV_PC2 ( ) denote the inverse function of the selective permutation PC. The value of a bit not referenced by PC2 ( ) is set at 0 by INV_PC2 ( ). Processed-secret-key-disturbance data used in the third transformation process 3409 is determined by the number of bits shifted in rotate processing LS 3408 carried out in the round. If the number of shifted bits is 1, KXo2 is used. If the number of shifted bits is 2, KXo3 is used. In the case of a first round, KXo1 is used.

XKL1=LS (XKL0) XOR KXo1 (Eq. 54)

Substituting the right-side expression of Eq. 53 for XKL0 in Eq. 54 yields Eq. 55 as follows:

XKL1=LS (KL XOR PC1 (KX)) XOR KXo1 (Eq. 55)

By the way, Eqs. 56 and 57 below hold true:

LS(a XOR b)=LS(a) XOR LS(b) (Eq. 56)

(a XOR b) XOR c=a XOR (b XOR c) (Eq. 57)

Applying the relations of Eqs. 56 and 57 and substituting the right-side expression of Eq. 42 for KXo1 in Eq. 55 yield Eq. 58 as follows:

XKL1=LS (KL XOR PC1 (KX)) XOR (LS (PC1 (KX)) XOR INV_PC2 (SinX1))

=LS (KL XOR PC1 (KX) XOR PC1 (KX)) XOR INV_PC2 (SinX1)

=LS (KL) XOR INV_PC2 (SinX1) (Eq. 58)

Let notation XKL1PC2 denote a value obtained as a result of executing PC-2 selective permutation 3414 for XKL1 as follows:

XKL1PC2=PC2 (XKL1)

=PC2 (LS (KL) XOR INV_PC2 (SinX1))

=PC2 (LS (KL)) XOR SinX1 (Eq. 59)

While the first round has been explained so far, in the fifth, ninth and thirteenth rounds, the output of the PC-2 selective permutation is the value of the expression (PC2 (LS (KL)) XOR SinX1), or a value with no transformation.

By the way, Eq. 60 below holds true:

XPtextRX=E (XPtextR) XOR XKL1PC2 (Eq. 60)

where notation XPtextRX denotes a result of an XOR operation 3404 and the function E ( ) represents the E permutation with expansion denoted by reference numeral 3403. Substituting the right-side expressions of Eqs. 52 and 59 for XPtextR and XKL1PC2 in Eq. 60 yields Eq. 61 as follows:

$$\begin{matrix}XPtextRX = E ( PtextR XOR PXo2 ) XOR PC2 ( LS ( KL ) ) \\ XOR Sin X1 \\ = E ( PtextR ) XOR PC2 ( LS ( KL ) ) XOR E \\ ( PXo2 ) XOR Sin X1\end{matrix} \qquad ( Eq . 61 )$$

Let notation XPtextRX2 denote the result of a first inverse-transformation process 3415 using PXo4 fourth permuted-plain-text-disturbance data 3416. Since the first inverse-transformation process 3415 is an XOR operation, XPtextRX2 can be expressed by Eq. 62 as follows:

$$\begin{matrix}\begin{matrix}XP textRX2 = XPtextR XOR Pxo4 \\ = E ( PtextR ) XOR PC2 ( LS ( KL ) ) XOR E ( PXo2 ) \\ XOR Sin X1 XOR PXo4\end{matrix} \\ From the embodiment shown in Fig . 30 , & ( Eq . 62 ) \\ PXo4 = E ( PXo2 ) & ( Eq . 63 )\end{matrix}$$

Thus, substituting the right-side expression of Eq. 63 for PXo4 in Eq. 62 yields Eq. 64 as follows:

XPtextRX2=XPtextR XOR PXo4=E (PtextR) XOR PC2 (LS (KL)) XOR E

(PXo2) XOR SinX1 XOR E (PXo2)=(PtextR) XOR PC2 (LS (KL)) XOR SinX1 (Eq. 64)

The value PtextRX2 serving as an input to transformed-SBOX-table access processing 3418 for a case with no transformation is given by Eq. 65 as follows:

PtextRX2=E (PtextR) XOR PC2 (LS (KL)) (Eq. 65)

Thus, Eq. 64 can be rewritten into Eq. 66 as follows:

XPtextRX2=PtextRX2 XOR SinX1 (Eq. 66)

Comparison with a value for a case with no transformation indicates that XPtextRX2 is equal to a value obtained as a result of an XOR operation with the SBOX-address-disturbance data SinX1. Thus, an access can be made to a transformed SBOX table 3419. Since a result of such an access has been transformed by SoutX, an input to an XOR operation 3421 is given by Exp. 67 as follows:

P (SResult XOR Soutx) (Exp. 67)

where notation SResult denotes the SBOX output for a case with no transformation.

A result of an XOR operation 3421 carried out on Exp. 67 and an XPtextL first permuted transformed plain text 3401 is given by Exp. 68 as follows:

P (SResult XOR Soutx) XOR PtextL

=P (SResult) XOR P (Soutx) XOR XPtextL XOR PTextL XOR PXo1 (Eq. 68)

The value of the right-side expression in Eq. 68 is substituted for an XPtextR second permuted transformed plain text 3423. Let notation PtextR2 denote the value substituted for the XPtextR second permuted transformed plain text 3423 for a case with no transformation and notation XPtextR2 denote the value substituted for the XPtextR second permuted transformed plain text 3423 for a case with a transformation. PtextR2 and XPtextR2 satisfy Eq. 69 as follows:

XPtextR2=PtextR2 XOR P (SoutX) XOR PXo1 (Eq. 69)

By the same token, let notation PtextL2 denote the value substituted for the XPtextL first permuted transformed plain text 3422 for a case with no transformation and notation XPtextL2 denote the value substituted for the XPtextL first permuted transformed plain text 3422 for a case with a transformation. PtextR2 and XPtextR2 satisfy Eq. 69 as follows:

XPtextL2=PtextL2 XOR PXo2 (Eq. 70)

The values of the right-side expressions of Eqs. 69 and 70 are used in a next round represented by a data flow shown in FIG. 35. Comparison of Eq. 69 with Eq. 51 indicates that, in Eq. 69, PXo1 is used in place of PXo2 and P (SoutX) is newly added as an XOR operand. These differences cause differences between the rounds represented by the data flows shown in FIGS. 34 and 35 as follows. The PXo4 fourth permuted-plain-text disturbance data 3416 used in the first inverse-transformation process 3415 of the data flow shown in FIG. 34 is replaced by PXo3 third permuted-plain-text disturbance data 3516 used in a first inverse-transformation process 3515 of the data flow shown in FIG. 35. In order to restore a result of transformation using P (SoutX), a fourth inverse-transformation process 3517 is added. Before the fourth inverse-transformation process 3517 is carried out, P (SoutX) is subjected to expansion permutation E ( ), being converted into E (P(SoutX)) which is equal to the permuted-SBOX-table-disturbance data XSoutX.

Let notation PtextR3 denote the value substituted for the XPtextR second permuted transformed plain text 3525 for a case with no transformation shown in FIG. 35, notation XPtextR3 denote the value substituted for the XPtextR second permuted transformed plain text 3525 for a case with the transformation, notation PtextL3 denote the value substituted for the XPtextL first permuted transformed plain text 3524 for a case with no transformation and notation XPtextL3 denote the value substituted for the XPtextL first permuted transformed plain text 3524 for a case with the transformation. PtextR3 and XPtextR3 satisfy Eq. 71 while PtextL3 and XPtextL3 satisfy Eq. 72 as follows:

XPtextR3=PtextR3 XOR P (Soutx) XOR PXo2 (Eq. 71)

XPtextL3=PtextL3 XOR P (SoutX) XOR PXo1 (Eq. 72)

The values of the right-side expressions of Eqs. 71 and 72 are used in a next round represented by a data flow shown in FIG. 36. Comparison of Eq. 71 with Eq. 69 indicates that, in Eq. 71, PXo2 is used in place of PXo1. This difference causes a difference between the rounds represented by the data flows shown in FIGS. 35 and 36 as follows. The PXo3 third permuted-plain-text disturbance data 3516 used in the first inverse-transformation process 3515 of the data flow shown in FIG. 35 is replaced by PXo4 fourth permuted-plain-text disturbance data 3616 used in a first inverse-transformation process 3615 of the data flow shown in FIG. 36. In addition, in both inputs to an XOR operation 3623, P (SoutX) has completed an XOR operation. Thus, the effect of P (SoutX) is nullified to result in the following.

Let notation PtextR4 denote the value substituted for the XPtextR second permuted transformed plain text 3625 for a case with no transformation shown in FIG. 36, notation XPtextR4 denote the value substituted for the XPtextR second permuted transformed plain text 3625 for a case with the transformation, notation PtextL4 denote the value substituted for the XPtextL first permuted transformed plain text 3624 for a case with no transformation and notation XPtextL4 denote the value substituted for the XPtextL first permuted transformed plain text 3624 for a case with the transformation. PtextR4 and XPtextR4 satisfy Eq. 73 while PtextL4 and XPtextL4 satisfy Eq. 74 as follows:

XPtextR4=PtextR4 XOR PXo1 (Eq. 73)

XPtextL4=PtextL4 XOR P (SoutX) XOR PXo2 (Eq. 74)

The values of the right-side expressions of Eqs. 73 and 74 are used in a next round represented by a data flow shown in FIG. 37. Comparison of Eq. 73 with Eq. 71 indicates that, in Eq. 73, PXo1 is used in place of PXo2. In addition, Eq. 73 does not include P (SoutX) as an XOR operand. This difference causes a difference between the rounds represented by the data flows shown in FIGS. 36 and 37 as follows. The PXo4 fourth permuted-plain-text disturbance data 3616 used in the first inverse-transformation process 3615 of the data flow shown in FIG. 36 is replaced by PXo3 third permuted-plain-text disturbance data 3716 used in a first inverse-transformation process 3715 of the data flow shown in FIG. 37. Since it is not necessary to nullify the effect of the transformation using P (SoutX), the fourth inverse-transformation process is no longer required. In addition, in both inputs to an XOR operation 3721, P (SoutX) has completed an XOR operation. Thus, the effect of P (SoutX) is nullified to result in the following.

Let notation PtextR5 denote the value substituted for the XPtextR second permuted transformed plain text 3723 for a case with no transformation shown in FIG. 37, notation XPtextR5 denote the value substituted for the XPtextR second permuted transformed plain text 3723 for a case with the transformation, notation PtextL5 denote the value substituted for the XPtextL first permuted transformed plain text 3722 for a case with no transformation and notation XPtextL5 denote the value substituted for the XPtextL first permuted transformed plain text 3722 for a case with the transformation. PtextR5 and XPtextR5 satisfy Eq. 75 while PtextL5 and XPtextL5 satisfy Eq. 75 as follows:

XPtextR5=PtextR5 XOR PXo2 (Eq. 75)

XPtextL5=PtextL5 XOR PXo1 (Eq. 76)

Since the transformations expressed by Eqs. 75 and 76 are identical with those expressed by Eqs. 51 and 52 respectively, the next round can be implemented by the embodiment shown in FIG. 34.

A data flow shown in FIG. 38 is all but identical with that shown in FIG. 37 except that, in the data flow shown in FIG. 38, data is not swapped finally between XPtextL and XptextR. Let notation PtextR6 denote the value substituted for the XPtextR second permuted transformed plain text 3823 for a case with no transformation shown in FIG. 37, notation XPtextR6 denote the value substituted for the XPtextR second permuted transformed plain text 3823 for a case with the transformation, notation PtextL6 denote the value substituted for the XPtextL first permuted transformed plain text 3822 for a case with no transformation and notation XptextL6 denote the value substituted for the XPtextL first permuted transformed plain text 3822 for a case with the transformation. In this case, PtextR6 and XPtextR6 thus satisfy Eq. 77 while PtextL6 and XPtextL6 satisfy Eq. 78 as follows:

XPtextR6=PtextR6 XOR PXo1 (Eq. 77)

XPtextL6=PtextL6 XOR PXo2 (Eq. 78)

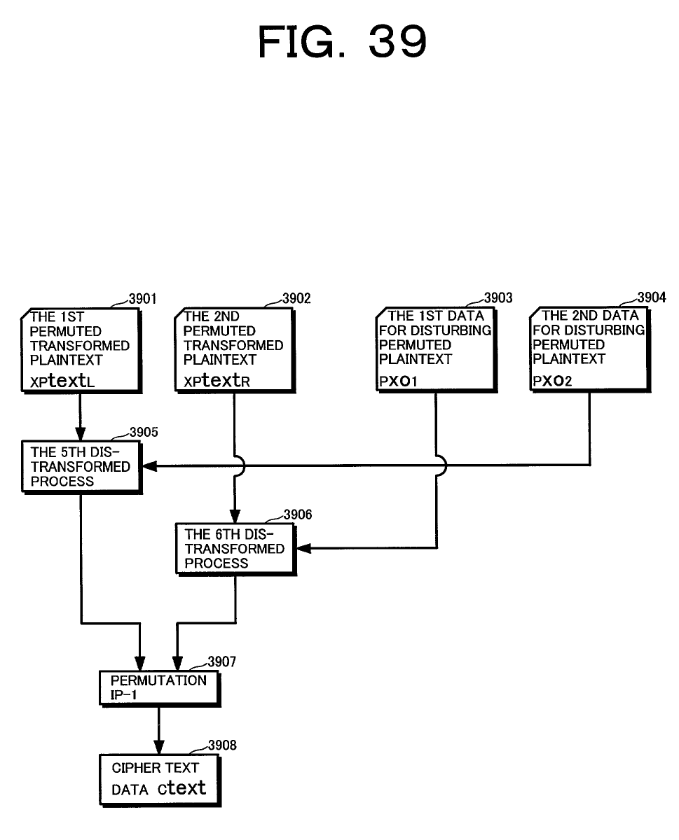

FIG. 39 is a data flow for finding a final result. A fifth inverse-transformation process 3905 is carried out by using PXo2 second permuted-plain-text-disturbance data 3904 for carrying out inverse transformation on a XPtextL first permuted plain text 3901 as expressed by Eq. 79 below. By the same token, a sixth inverse-transformation process 3906 is carried out by using PXo1 first permuted-plain-text-disturbance data 3903 for carrying out inverse transformation on a XPtextR second permuted plain text 3902 as expressed by Eq. 80 below. As a result, effects of all transformations are eliminated.

PtextR6=XPtextR6 XOR PXo1 (Eq. 79)

PtextL6=XPtextL6 XOR PXo2 (Eq. 80)

Finally, an IP-1 permutation process 3907 is carried out to permute the results of the fifth inverse-transformation process 3905 and the sixth inverse-transformation process 3906 in order to generate a Ctext final encrypted text 3908. At any point of time in the course of the processing up to the generation of the Ctext final encrypted text 3908, data is in a state of being transformed. It is thus difficult to infer the original data by observation of the waveform of current consumption.

The SBOX-address-disturbance data SinX, the SBOX-content-disturbance data SoutX and the transformed SBOX table are created by adoption of the technique with the data flow implemented by an embodiment like the one shown in FIG. 19, 20, 21 or 22. The following description explains other embodiments wherein the hamming weight is constant all the time and it is even more difficult to infer the original data by observation of the waveform of current consumption.

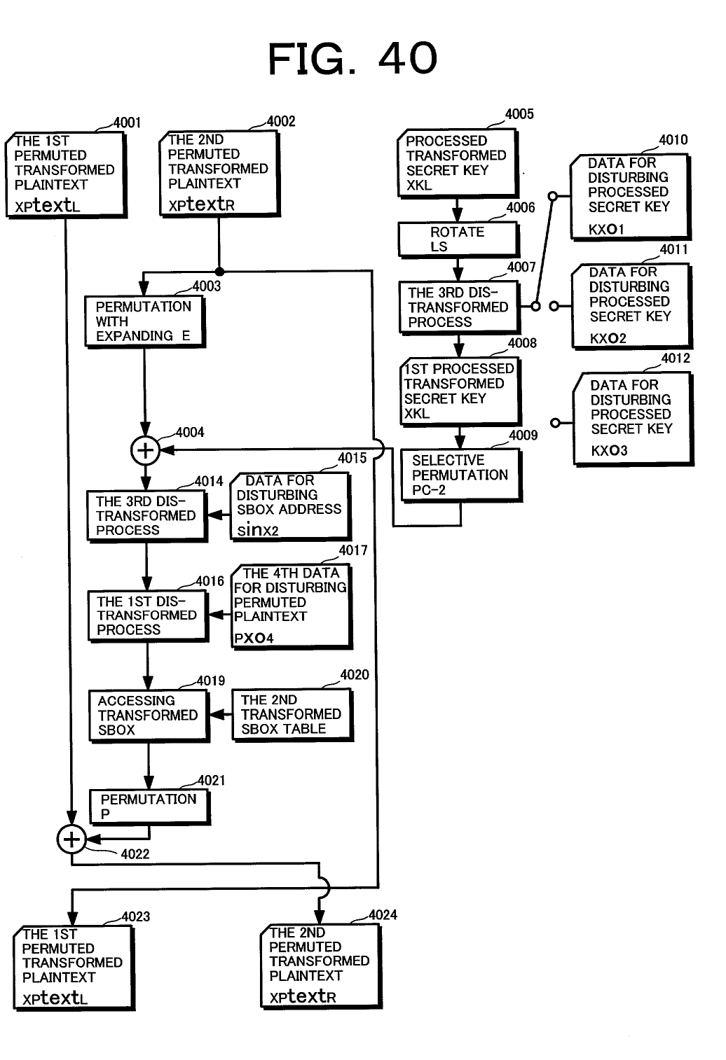

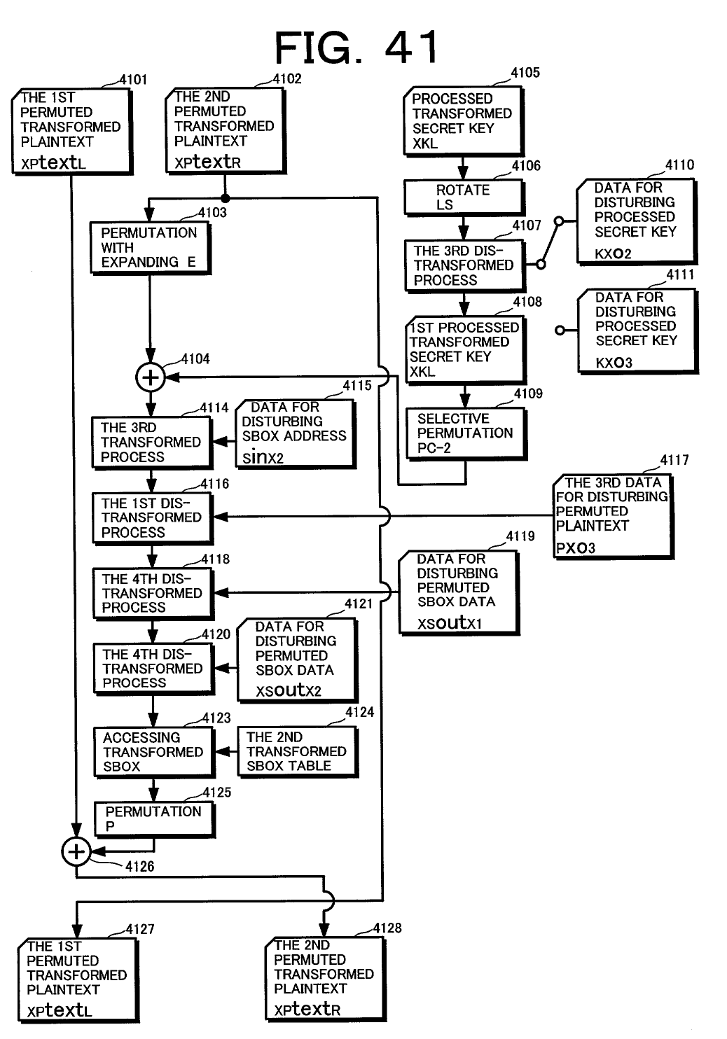

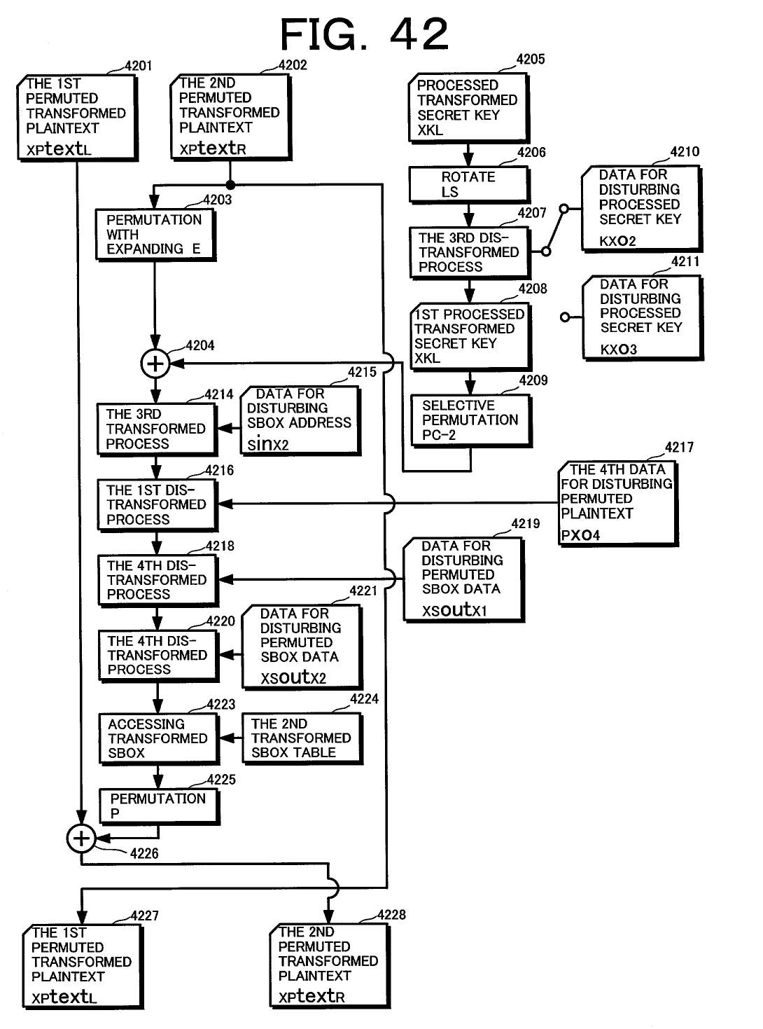

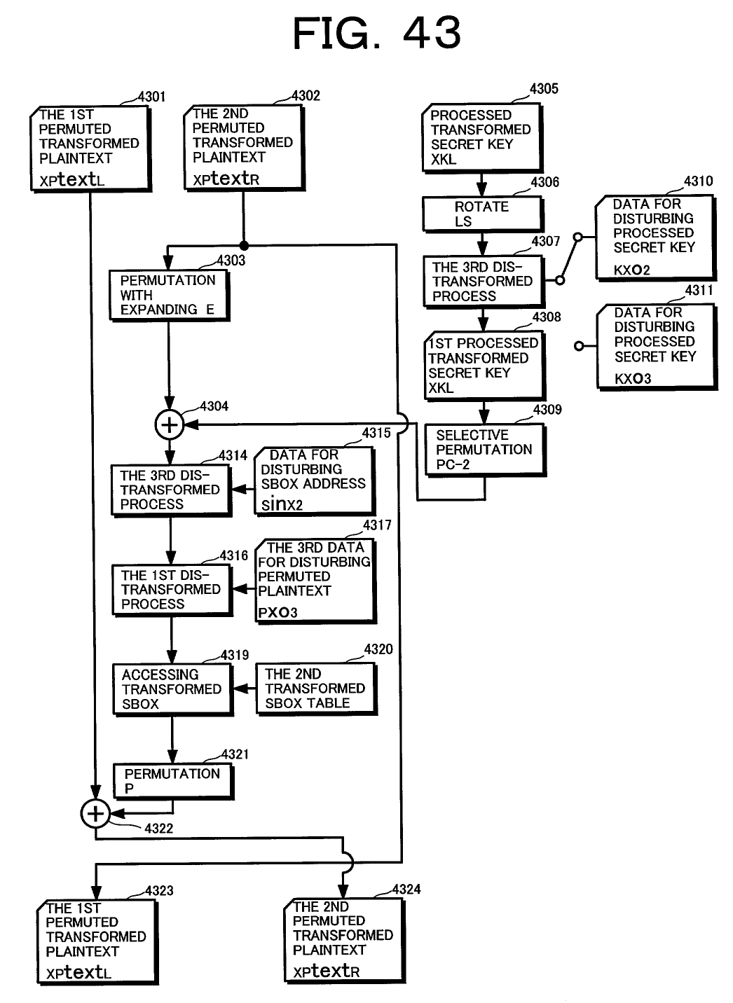

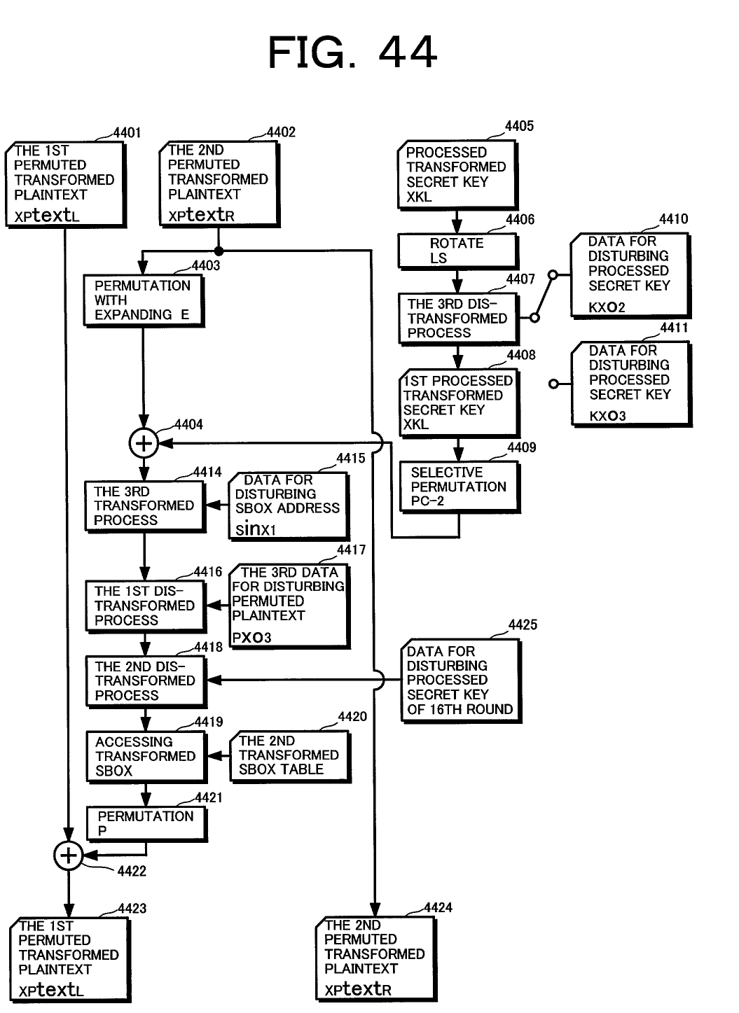

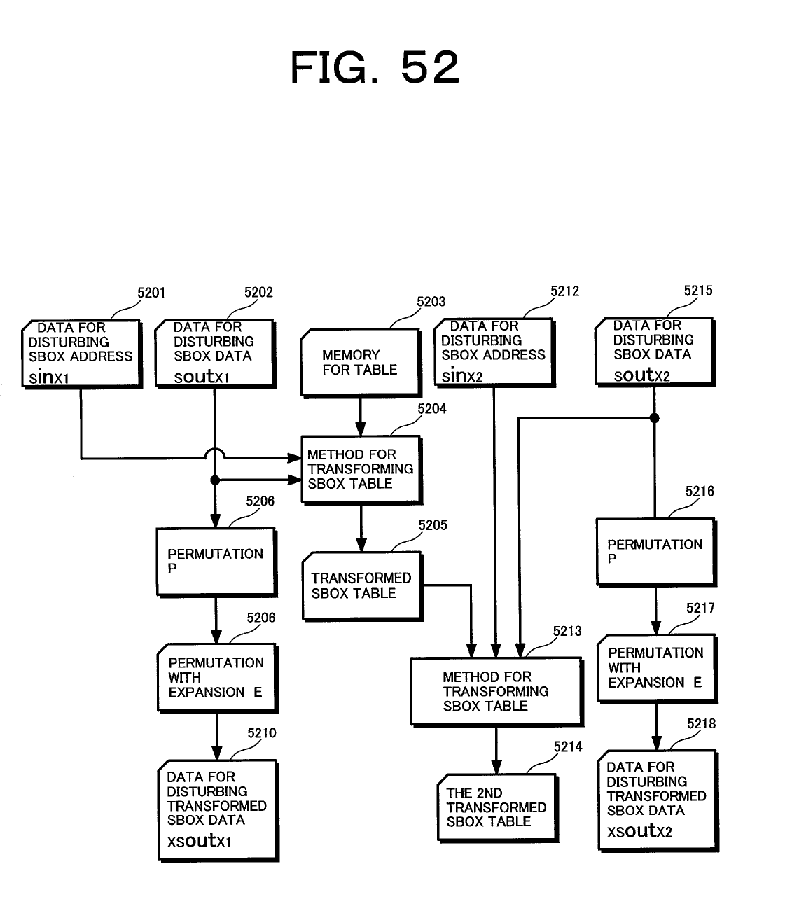

The other embodiments are shown in FIGS. 39, 40, 41, 42, 43, 44, 45, 46, 47 and 52. While the basic procedures of these other embodiments are the same as the embodiments explained earlier by referring to FIGS. 29, 30, 31, 32, 33, 34, 35, 36, 37, 38, 39, 45, 46 and 47, the former is different from the latter in that, in the case of these other embodiments, the transformation is carried out twice. An embodiment implementing a technique to transform a SBOX table is shown in FIG. 52. As shown in the figure, data for disturbance includes SinX1 first SBOX-address-disturbance data 5201, XSoutX1 first SBOX-content-disturbance data 5210, SinX2 second SBOX-address-disturbance data 5212 and XSoutX2 second SBOX-content-disturbance data 5218 to generate a second transformed SBOX table 5214. Since more pieces of SBOX-table-disturbance data are used, the embodiment implementing processing for the first, fifth, ninth and thirteenth rounds includes an additional third transforming process 4014 using SinX2 second permuted-SBOX-address-disturbance data 4015 as shown in FIG. 40. In addition, the embodiment implementing processing for the second, sixth, tenth and fourteenth rounds includes an additional third transforming process 4114 using SinX2 second SBOX-address-disturbance data 4115 and an additional fourth transforming process 4120 using XSoutX2 second permuted-SBOX-content-disturbance data 4121 as shown in FIG. 41. Furthermore, the embodiment implementing processing for the third, seventh, eleventh and fifteenth rounds includes an additional third transforming process 4214 using SinX2 second SBOX-address-disturbance data 4215 and an additional fourth transforming process 4220 using XSoutX2 second permuted-SBOX-content-disturbance data 4221 as shown in FIG. 42. Moreover, the embodiment implementing processing for the fourth, eighth and twelfth rounds includes an additional third transforming process 4314 using SinX2 second permuted-SBOX-address-disturbance data 4315 as shown in FIG. 43. Finally, the embodiment implementing processing for the sixteenth round includes an additional third transforming process 4414 using SinX2 second SBOX-address-disturbance data 4415 as shown in FIG. 44.

The first SBOX-address-disturbance data SinX1, the second SBOX-address-disturbance data SinX2, the first SBOX-content-disturbance data SoutX1, the second SBOX-content-disturbance data SoutX2 and the second transformed SBOX table are created by adoption of the technique with the data flow implemented by an embodiment like the one shown in FIG. 26, 27 or 28.

In another embodiment, the first SBOX-address-disturbance data SinX1, the second SBOX-address-disturbance data SinX2, the first SBOX-content-disturbance data SoutX1, the second SBOX-content-disturbance data SoutX2 and the second transformed SBOX table are created by adoption of the technique with the data flow like the one shown in FIG. 26, 27 or 28, and the hamming weight is examined not throughout the entire bits, but only for a limited number of bits that can be processed at one time by the central processing unit, in implementation of hamming-weight examination to keep the hamming weight constant.

In accordance with the embodiments of the present invention, by imposing additional restrictions on generation of data for disturbance in transformation of information processed in a chip of an IC card, it becomes difficult to infer processing and a secret key by observation of the waveform of current consumption.

The embodiments implement information-processing apparatuses in accordance with a variety of aspects of the present invention which are described as follows:

1. In accordance with a first aspect of the present invention, there is provided an information-processing apparatus including:

a storage unit comprising a program storage sub-unit for storing a program and a data storage sub-unit for storing data; and

a central processing unit for carrying out data processing by execution of a predetermined process according to the program,

wherein:

the program comprises one or more data-processing methods each having processing instructions each used for giving a command to the central processing unit;

a particular one of the data-processing methods includes an input-data-processing sub-method for carrying out a lookup operation on a table, processing data obtained as a result of the table-lookup operation and outputting a result of the processing as processed data;

the data-processing methods are executed sequentially one method after another to generate a processing result;

the data-processing methods use:

first disturbance data X1i with an all-time constant hamming weight;

second disturbance data X2i with an all-time constant hamming weight remaining constant even upon completion of data processing carried out on the second disturbance data X2i after a table-lookup operation;

processed second disturbance data X2o obtained as a result of the data processing carried out on the second disturbance data X2i; and

a transformed table generated by transformation of indexes of a table by using the first disturbance data X1i and transformation of the table's entries pointed to by the indexes by using the second disturbance data X2i, and

the data-processing methods comprise:

a first data-transform method for transforming input data D1 into transformed data H1 by using the first disturbance data X1i;

a first transform-table-access method for looking up the transformed table for transformed data H2 pointed to by the transformed data H1 serving as an index of the transformed table;

a first transformed-data-processing method for processing the transformed data H2 to generate processed transformed data H3;

a second data-transform method for transforming the processed transformed data H3 into processed transformed data H4 by using the first disturbance data X1i;

a third data-transform method for transforming the processed transformed data H4 into processed transformed data H5 by using the processed second disturbance data X2o;

a second transform-table-access method for looking up the transformed table for transformed data H6 pointed to by the processed transformed data H5 serving as an index of the transformed table;

a second transformed-data-processing method for processing the transformed data H6 to generate processed transformed data H7; and

a data-inverse-transform method for carrying out inverse transformation on the processed transformed data H7 by using the processed second disturbance data X2o into processed data D2 which can also be obtained without transformations as a final result of a table-lookup operation using the input data D1, processing of a result of the table-lookup operation, another table-lookup operation using a result of the processing and processing of a result of the other table-lookup operation.

2. In the information-processing apparatus described in Section 1, a method for generating the first disturbance data X1i, the processed second disturbance data X2o and the transformed table comprises:

a first constant-hamming-weight-random-number generation sub-method for generating the first disturbance data X1i;

a second constant-hamming-weight-random-number generation sub-method for generating the second disturbance data X2i;

a disturbance-data-processing sub-method for processing the second disturbance data X2i in order to generate the processed second disturbance data X2o;

a hamming-weight evaluation sub-method for computing the hamming weight of the processed second disturbance data X2o and requesting the second constant-hamming-weight-random-number generation sub-method for regenerating the second disturbance data X2i in the case of an improper value of the hamming weight of the processed second disturbance data X2o; and

a table transform sub-method for generating the transformed table by transformation of indexes of a table by using the first disturbance data X1i and transformation of the table's entries pointed to by the indexes by using the second disturbance data X2i.

3. The information-processing apparatus described in Section 1 further has:

a first-disturbance-data storage means for storing a plurality of numbers having uniform constant hamming weights; and

a second-disturbance-data storage means for storing a plurality of other numbers that have uniform constant hamming weights and provide the uniform constant hamming weight to a result of processing carried out on any of the other numbers by adoption of a disturbance-data-processing sub-method,

wherein a method for generating the first disturbance data X1i, the processed second disturbance data X2o and the transformed table comprises:

a first-disturbance-data select sub-method for randomly selecting one of the numbers, which are stored in the first-disturbance-data storage means, to be used as the first disturbance data X1i;

a second-disturbance-data select sub-method for randomly selecting one of the other numbers, which are stored in the second-disturbance-data storage means, to be used as the second disturbance data X2i;

the disturbance-data-processing sub-method for processing the second disturbance data X2i in order to generate the processed second disturbance data X2o; and

a table transform sub-method for generating the transformed table by transformation of indexes of a table by using the first disturbance data X1i and transformation of the table's entries pointed to by the indexes by using the second disturbance data X2i.

4. The information-processing apparatus described in Section 1 further has:

a first-disturbance-data storage means for storing a plurality of numbers having uniform constant hamming weights; and

a second-disturbance-data and processed-second-disturbance-data storage means for storing a plurality of pairs each consisting of second disturbance data having a constant hamming weight and processed second disturbance data obtained as a result of processing carried out on the second disturbance data by adoption of a disturbance-data-processing sub-method sustaining the constant hamming weight,

wherein a method for generating the first disturbance data X1i, the processed second disturbance data X2o and the transformed table comprises:

a first-disturbance-data select sub-method for randomly selecting one of the numbers, which are stored in the first-disturbance-data storage means, to be used as the first disturbance data X1i;

a second-disturbance-data and processed-second-disturbance-data select sub-method for randomly selecting one of the pairs each consisting of second disturbance data and processed second disturbance data, which are stored in the second-disturbance-data and processed-second-disturbance-data storage means, to be used as the second disturbance data X2i and the processed second disturbance data X2o respectively; and

a table transform sub-method for generating the transformed table by transformation of indexes of a table by using the first disturbance data X1i and transformation of the table's entries pointed to by the indexes by using the second disturbance data X2i.

5. The information-processing apparatus described in Section 1 further has:

a first-disturbance-data, second-disturbance-data and transformed table storage means for storing a plurality of sets each consisting of a value usable as the first disturbance data X1i, a value usable as the processed second disturbance data X2o and a candidate for the transformed table; and

a first-disturbance-data, processed second-disturbance-data and transformed table select method for randomly selecting one of the sets each consisting of a value usable as the first disturbance data X1i, a value usable as the processed second disturbance data X2o and a candidate for the transformed table from the first-disturbance-data, second-disturbance-data and transformed table storage means to be used as the first disturbance data X1i, the processed second disturbance data X2o and the transformed table respectively,

wherein a method for generating the first disturbance data X1i, the processed second disturbance data X2o and the transformed table is adopted for generation of the first disturbance data X1i from the selected set's value usable as the first disturbance data X1i, generation of the processed second disturbance data X2o from the selected set's value usable as the processed second disturbance data X2o and generation of the transformed table from the selected set's transformed-table candidate which has been formed by transformation of indexes of a table by using the value usable as the first disturbance data X1i and transformation of the table's entries pointed to by the indexes by using the value useable as the second disturbance data X2i.

6. In accordance with a second aspect of the present invention, there is provided an information-processing apparatus including:

a storage unit comprising a program storage sub-unit for storing a program and a data storage sub-unit for storing data; and

a central processing unit for carrying out data processing by execution of a predetermined process according to the program,

wherein:

the program comprises one or more data-processing methods each having processing instructions each used for giving a command to the central processing unit;

a particular one of the data-processing methods includes an input-data-processing method for looking up a table, processing data obtained as a result of a table-lookup operation and outputting a result of processing as processed data;

the data-processing methods are executed sequentially one method after another to generate a processing result;

the data-processing methods use:

first disturbance data X1i with an all-time-constant hamming weight;

second disturbance data X2i with an all-time-constant hamming weight remaining constant even upon completion of data processing carried out on the second disturbance data X2i after a table-lookup operation;

processed second disturbance data X2o as a result of data processing carried out on the second disturbance data X2i;

third disturbance data X3i with an all-time-constant hamming weight;

fourth disturbance data X4i with an all-time-constant hamming weight remaining constant even upon completion of data processing carried out on the fourth disturbance data X4i after a table-lookup operation;

processed fourth disturbance data X4o as a result of data processing carried out on the second disturbance data X4i; and

a second transformed table generated by transformation of indexes of a table by using the first disturbance data X1i, by transformation of the transformed indexes by using the third disturbance data X3i, transformation of the table's entries pointed to by the indexes by using the second disturbance data X2i and transformation of the transformed entries using the fourth disturbance data X4i, and

the data-processing methods comprise:

a first data-transform method for transforming input data D1 into transformed data H1 by using the third disturbance data X3i;

a second data-transform method for transforming the transformed data H1 into transformed data H2 by using the first disturbance data X1i;

a first transform-table-access method for looking up the second transformed table for transformed data H3 pointed to by the transformed data H2 serving as an index of the second transformed table;

a first transformed-data-processing method for processing the transformed data H3 to generate processed transformed data H4;

a third data-transform method for transforming the processed transformed data H4 into processed transformed data H5 by using the third disturbance data X3i;

a fourth data-transform method for transforming the processed transformed data H5 into processed transformed data H6 by using the first disturbance data X1i;

a fifth data-transform method for transforming the processed transformed data H6 into processed transformed data H7 by using the processed second disturbance data X2o;

a sixth data-transform method for transforming the processed transformed data H7 into processed transformed data H8 by using the processed fourth disturbance data X4o;

a second transform-table-access method for looking up the second transformed table for transformed data H9 pointed to by the processed transformed data H8 serving as an index of the second transformed table;

a second transformed-data-processing method for processing the transformed data H9 to generate processed transformed data H10;

a first data-inverse-transform method for carrying out inverse transformation on the processed transformed data H10 by using the processed second disturbance data X2o into processed transformed data H11; and

a second data-inverse-transform method for carrying out inverse transformation on the processed transformed data H11 by using the processed fourth disturbance data X4o into processed data D2 which can also be obtained without transformations as a final result of a table-lookup operation using the input data D1, processing of a result of the table-lookup operation, another table-lookup operation using a result of the processing and processing of a result of the other table-lookup operation.

7. In the information-processing apparatus described in Section 6, a method for generating the first disturbance data X1i, the processed second disturbance data X2o, the third disturbance data X3i, the processed fourth disturbance data X4o and the second transformed table comprises:

a first constant-hamming-weight-random-number generation sub-method for generating the first disturbance data X1i;

a second constant-hamming-weight-random-number generation sub-method for generating the second disturbance data X2i;

a disturbance-data-processing sub-method for processing the second disturbance data X2i in order to generate the processed second disturbance data X2o;

a hamming-weight evaluation sub-method for computing the hamming weight of the processed second disturbance data X2o and requesting the second constant-hamming-weight-random-number generation sub-method for regenerating another value of the second disturbance data X1i in the case of an improper value of the hamming weight of the processed second disturbance data X2o;

a first table transform sub-method for generating a first transformed table by transformation of indexes of a table by using the first disturbance data X1i and transformation of the table's entries pointed to by the indexes by using the second disturbance data X2i;

a third constant-hamming-weight-random-number generation sub-method for generating the third disturbance data X3i;

a fourth constant-hamming-weight-random-number generation sub-method for generating the fourth disturbance data X4i;

a disturbance-data-processing sub-method for processing the fourth disturbance data X4i in order to generate the processed second disturbance data X4o;

a hamming-weight evaluation sub-method for computing the hamming weight of the processed fourth disturbance data X4o and requesting the fourth constant-hamming-weight-random-number generation sub-method for regenerating another value of the fourth disturbance data X4i in the case of an improper value of the hamming weight of the processed fourth disturbance data X4o; and

a second table transform sub-method for generating the second transformed table by transformation of indexes of the first transformed table by using the third disturbance data X3i and transformation of the table's entries pointed to by the indexes by using the fourth disturbance data X4i.

8. The information-processing apparatus described in Section 6 further has:

a first-disturbance-data storage means for storing a plurality of numbers having uniform constant hamming weights; and

a second-disturbance-data storage means for storing a plurality of other numbers that have uniform constant hamming weights and provide the uniform constant hamming weight to a result of processing carried out on any of the other numbers by adoption of a first disturbance-data-processing sub-method,

wherein a method for generating the first disturbance data X1i, the processed second disturbance data X2o, the third disturbance data X3i, the processed fourth disturbance data X4o and the second transformed table comprises:

a first-disturbance-data select sub-method for randomly selecting one of the numbers, which are stored in the first-disturbance-data storage means, to be used as the first disturbance data X1i;

a second-disturbance-data select sub-method for randomly selecting one of the other numbers, which are stored in the second-disturbance-data storage means, to be used as the second disturbance data X2i;

the first disturbance-data-processing sub-method for processing the second disturbance data X2i in order to generate the processed second disturbance data X2o;

a first table transform sub-method for generating a first transformed table by transformation of indexes of a table by using the first disturbance data X1i and transformation of the table's entries pointed to by the indexes by using the second disturbance data X2i;

a first random-number generation method for generating the third disturbance data X3i;

a second random-number generation method for generating the third disturbance data X4i;

a second disturbance-data-processing sub-method for processing the fourth disturbance data X4i in order to generate the processed fourth disturbance data X4o; and

a second table transform sub-method for generating the second transformed table by transformation of indexes of the first transformed table by using the third disturbance data X3i and transformation of the first table's entries pointed to by the indexes by using the fourth disturbance data X4i.

9. The information-processing apparatus described in Section 6 further has:

a first-disturbance-data storage means for storing a plurality of numbers having uniform constant hamming weights; and

a second-disturbance-data and processed-second-disturbance-data storage means for storing a plurality of pairs each consisting of second disturbance data having a constant hamming weight and processed second disturbance data obtained as a result of processing carried out on the second disturbance data by adoption of a first disturbance-data-processing sub-method sustaining the constant hamming weight,

wherein a method for generating the first disturbance data X1i, the processed second disturbance data X2o, the third disturbance data X3i, the processed fourth disturbance data X4o and the second transformed table comprises:

a first-disturbance-data select sub-method for randomly selecting one of the numbers, which are stored in the first-disturbance-data storage means, to be used as the first disturbance data X1i;

a second-disturbance-data and processed-second-disturbance-data select sub-method for randomly selecting one of the pairs each consisting of second disturbance data and processed second disturbance data, which are stored in the second-disturbance-data and processed-second-disturbance-data storage means, to be used as the second disturbance data X2i and the processed second disturbance data X2o respectively;

a first table transform sub-method for generating a first transformed table by transformation of indexes of a table by using the first disturbance data X1i and transformation of the table's entries pointed to by the indexes by using the second disturbance data X2i;

a first random-number generation method for generating the third disturbance data X3i;

a second random-number generation method for generating the fourth disturbance data X4i;

a second disturbance-data-processing sub-method for processing the fourth disturbance data X4i in order to generate the processed fourth disturbance data X4o; and

a second table transform sub-method for generating the second transformed table by transformation of indexes of the first transformed table by using the third disturbance data X3i and transformation of the first table's entries pointed to by the indexes by using the fourth disturbance data X4i.

10. In accordance with a third aspect of the present invention, there is provided an information-processing apparatus including:

a storage unit comprising a program storage sub-unit for storing a program and a data storage sub-unit for storing data; and

a central processing unit for carrying out data processing by execution of a predetermined process according to the program,

wherein:

the program comprises one or more data-processing methods each having processing instructions each used for giving a command to the central processing unit;

a particular one of the data-processing methods is used for inputting a message and a secret key, carrying out DES (Data Encryption Standard) encryption on the message by using the secret key and outputting a result of the DES encryption; and

the data-processing methods comprise:

a method for transforming a message by using plain-text disturbance data PX for disturbing a plain text;

a method for transforming a secret key by using a secret-key disturbance data KX for disturbing a secret key;

an SBOX-table transform method for creating a transformed SBOX table used in DES encryption by transformation of indexes of an SBOX table by using SBOX-address disturbance data SinX1 for disturbing the indexes of the SBOX table to rearrange contents of the SBOX table and by transformation of the contents of the rearranged SBOX table by using SBOX-content disturbance data SoutX for disturbing the contents of the rearranged SBOX table; and

an inverse-transform method used for inverse transformation of plain-text disturbance data PX or a value transforming the plain-text disturbance data PX immediately before or immediately after permutation IP following completion a DES last round and provided with:

inverse-transformation processing or transformation processing for transforming one or both the inputs of an XOR operation immediately preceding a lookup operation of the SBOX table so as to adjust a result of the XOR operation to a value resulting from transformation using the SBOX-address disturbance data SinX1 and the plain-text disturbance data PX or a value transforming the plain-text disturbance data PX; and

other inverse-transformation processing immediately preceding a lookup operation of the SBOX table so as to adjust data to a value transformed by the SBOX-address disturbance data SinX1 by the lookup operation of the SBOX table.

11. In the information-processing apparatus described in Section 10, such values of the SBOX-address disturbance data SinX1 are used that the hamming weight of the SBOX-address disturbance data SinX1 is constant and such values of the SBOX-content disturbance data SoutX are used that the hamming weights of the SBOX-content disturbance data SoutX and a result of permutation of the SBOX-content disturbance data SoutX are constant.

12. In the information-processing apparatus described in Section 10, 2 or more pieces of SBOX-address disturbance data are used for transformation of indexes of the SBOX table a plurality of times, and 2 or more pieces of SBOX-content disturbance data are used for transformation of contents of the SBOX table a plurality of times.

13. In the information-processing apparatus described in Section 12, such values of the SBOX-address disturbance data SinX1 are used that one or more of the pieces of SBOX-address disturbance data have uniform hamming weights, and such values of the SBOX-content disturbance data SoutX are used that one or more of the pieces of SBOX-address disturbance data have uniform hamming weights.

14. In the information-processing apparatus described in Section 13, such values of the SBOX-address disturbance data SinX1 and such values of the SBOX-content disturbance data SoutX are used that the SBOX-address disturbance data SinX1 has a constant hamming weight, the SBOX-content disturbance data SoutX also has a constant hamming weight and the SBOX-address disturbance data SinX1 as well as the SBOX-content disturbance data SoutX can each be split into portions each having such a bit count that the portions can each be processed by a central processing unit at one time and the portions also have uniform constant hamming weights as well.

What is claimed is:

1. An information-processing apparatus serving as a data-processing means for carrying out predetermined processing OP1 on input data D1 in order to produce a result of said predetermined processing as processed data D2, said information-processing apparatus comprising:
a data transform means for transforming said input data D1 by using disturbance data XI to generate transformed data H1;
a transformed-data-processing means for carrying out said predetermined processing OP1 for said input data D1 or processing different from said predetermined processing OP1 to replace said predetermined processing OP1 on said transformed data H1 in order to generate processed transformed data H2; and
a data inverse-transform means for carrying out inverse-transformation processing OP2 on said processed transformed data H2 by using processed disturbance data XO in order to generate said processed D2 which can also be obtained without transformations as a result of said predetermined processing OP1 carried out on said input data D1,
wherein said disturbance data XI and said processed disturbance data XO each have a constant or all but constant hamming weight.

2. An information-processing apparatus according to claim 1 wherein said processed disturbance data XO is generated by carrying out said predetermined processing OP1 on said disturbance data XI.

3. An information-processing apparatus according to claim 1 wherein each bit of said processed disturbance data XO and said disturbance data XI has a logic value of 0 or 1 at a probability of 50%.

4. An information-processing apparatus according to claim 1, said information-processing apparatus further having a disturbance-data and processed-disturbance-data generation means capable of generating said disturbance data XI having a constant or all but constant hamming weight and generating said processed disturbance data XO having a constant or all but constant hamming weight by execution of input-data processing defined in advance on said disturbance data XI.

5. An information-processing apparatus according to claim 1, said information-processing apparatus further having:
a disturbance-data storage means for storing a plurality of candidates for said disturbance data XI having uniform or all but uniform hamming weights; and
a disturbance-data select means for randomly selecting one of said candidates for said disturbance data XI stored in said disturbance-data storage means,
wherein disturbance-data processing is carried out to process said selected candidate for said disturbance data XI in order to generate said processed disturbance data XO.

6. An information-processing apparatus according to claim 1, said information-processing apparatus further having a constant-hamming-weight-random-number generation means used for generating random numbers with uniform constant hamming weights and provided with:
a random-number generation means for generating random numbers each having a hamming weight equal to half the number of bits included in said generated random number;
a bit inversion means for inverting bits of data; and
a bit concatenation means for concatenating a random number generated by said random-number generation means with data output by said bit inversion means as a result of inversion of said random number generated by said random-number generation means.

7. An information-processing apparatus according to claim 1, said information-processing apparatus further having:
a random-number generation means for generating a random number to be used as said disturbance data XI;
a hamming-weight computation means for computing a hamming weight of a random number generated by said random-number generation means;
a hamming-weight examination means for examining said hamming weight computed by said hamming-weight computation means; and
a constant-hamming-weight assurance means for requesting said random-number generation means to generate another random number for said hamming-weight examination means' result of examination indicating an inspected hamming weight not equal to a target hamming weight.

8. An information-processing apparatus according to claim 1, said information-processing apparatus further having a constant-hamming-weight-random-number generation means used for generating random numbers with uniform constant hamming weights and provided with:
a constant-hamming-weight and constant-fractional-bit-count random-number generation means used for generating partial random numbers with uniform constant hamming weights and uniform bit counts each equal to a fraction of the bit count of a final random number to be generated;
a random-number-generation control means for controlling said constant-hamming-weight and constant-fractional-bit-count random-number generation means to generate partial random numbers till a sum of bit counts of said partial numbers equal to said bit count of said final random number; and
a data concatenation means for concatenating said partial random numbers generated by said constant-hamming-weight and constant-fractional-bit-count random-number generation means to result in said final random number.

9. An information-processing apparatus comprising:
a storage unit having a program storage sub-unit for storing a program and a data storage sub-unit for storing data;
a central processing unit for carrying out predetermined processing by execution of said program;
an input-data-processing means for looking up a table for an entry pointed to by input data D1 used as an index of said table and outputting said entry as processed data;
a transformed table generated by transformation of indexes of said table by using first disturbance data X1i with an all-time constant or all-time all but constant hamming weight and transformation of said table's entries pointed to by said indexes by using second disturbance data X2i with an all-time constant or all-time all but constant hamming weight;
a data transform means for transforming said input data D1 by using said disturbance data X1i to generate transformed data H1;
a transformed-table access means for looking up said transformed table for processed transformed data H2 pointed to by said transformed data H1 used as an index of said transformed table; and
a data inverse-transform means for carrying out inverse transformation on said processed transformed data H2 by using said second disturbance data X2i in order to generate said processed D2 which can also be obtained without transformations as a result of input-data processing carried out on said input data D1.

10. An information-processing apparatus according to claim 9, said information-processing apparatus further having a table transform means for creating said transformed table by using:
a first constant-hamming-weight-random-number generation means for generating said first disturbance data X1i;
a second constant-hamming-weight-random-number generation means for generating said second disturbance data X2i;
said first disturbance data X1i;
said second disturbance data X2i; and
said table,
wherein indexes of said table are transformed by using said first disturbance data X1i and contents of said table are transformed by using said second disturbance data X2i to generate said transformed table.

11. An information-processing apparatus according to claim 9, said information-processing apparatus further having:
a first-disturbance-data storage means for storing in advance a plurality of numbers having uniform and constant or all but uniform and all but constant hamming weights;
a first-disturbance-data select means for randomly selecting one of said numbers stored in said first-disturbance-data storage means to be used as said first disturbance data X1i;
a second-disturbance-data storage means for storing in advance a plurality of numbers having uniform and constant or all but uniform and all but constant hamming weights;
a second-disturbance-data select means for randomly selecting one of said numbers stored in said second-disturbance-data storage means to be used as said second disturbance data X2i; and
a table transform means for creating said transformed table by transformation of indexes of said table by using said first disturbance data X1i and transformation of contents of said table by using said second disturbance data X2i.

12. An information-processing apparatus according to claim 9 wherein:
first disturbance data with a constant hamming weight is prepared in advance as a candidate for said first disturbance data X1i;
second disturbance data with a constant hamming weight is prepared in advance as a candidate for said second disturbance data X2i;
a pair consisting of said first disturbance data and said second disturbance data is used in transformation to create said transformed table;
a plurality of such pairs is created;
the same plurality of such transformed tables is created by using said pairs and stored in a transformed-table storage means along with said pairs by associating said transformed tables with said pairs; and
a means is provided for selecting a set consisting of first disturbance data, second disturbance data and a transformed table from said transformed-table storage means to be used as said first disturbance data X1i, said first disturbance data X2i and said transformed table.

13. An information-processing apparatus serving as a data-processing means for carrying out a lookup operation on a table, carrying out data processing on a lookup-operation result and outputting a result of said data processing as processed data, said information-processing apparatus comprising:
a data transform means for transforming input data D1 by using first disturbance data X1I to generate transformed data H1,
a transformed-table access means for looking up a transformed table for transformed data H2 pointed to by said transformed data H1 used as an index of said transformed table;
a transformed-data-processing means for processing said transformed data H2 to produce processed transformed data H3; and
a data inverse-transform means for carrying out inverse transformation on said processed transformed data H3 by using processed second disturbance data X2o in order to generate processed D2 which can also be obtained without transformations as a result of said lookup operation carried out on said table by using said input data D1 and said data processing carried out on said result of said lookup operation,
wherein:
said first disturbance data X1i has an all-time constant or all-time all but constant hamming weight;
second disturbance data X2i has an all-time constant or all-time all but constant hamming weight and provides a constant or all but constant hamming weight to a result of data processing carried out on said second disturbance data X2i after said lookup operation, that is, processed second disturbance data X2o obtained as a result of said data processing carried out on said second disturbance data X2i also has an all-time constant or all-time all but constant hamming weight as well; and
indexes of said table are transformed by using said first disturbance data X1i whereas said table's contents pointed to by said indexes are transformed by using said second disturbance data X2i to create said transformed table.

14. An information-processing apparatus according to claim 13, said information-processing apparatus further having:
a first constant-hamming-weight-random-number generation means for generating said first disturbance data X1i;
a second constant-hamming-weight-random-number generation means for generating said second disturbance data X2i;
a disturbance-data-processing means for processing said second disturbance data X2i to produce said transformed second disturbance data X2o;
a hamming-weight examination means for computing a hamming weight of said processed second disturbance data X2o and requesting said second constant-hamming-weight-random-number generation means to generate another value of said second disturbance data X2i in the case of an improper hamming weight of said processed second disturbance data X2o; and
a table transform means for creating said transformed table by transformation of indexes of said table by using said first disturbance data X1i and transformation of contents of said table by using said second disturbance data X2i.

15. An information-processing apparatus according to claim 13, said information-processing apparatus further having:
a first-disturbance-data storage means for storing a plurality of numbers having uniform and constant or all but uniform and all but constant hamming weights;
a first-disturbance-data select means for randomly selecting one of said numbers stored in said first-disturbance-data storage means to be used as said first disturbance data X1i;
a second-disturbance-data storage means for storing a plurality of numbers having uniform and constant or all but uniform and all but constant hamming weights as well as providing uniform and constant or all but uniform and all but constant hamming weights to results of disturbance-data processing carried out on said numbers;
a second-disturbance-data select means for randomly selecting one of said numbers stored in said second-disturbance-data storage means to be used as said second disturbance data X2i;
a second-disturbance-data processing means for carrying out said disturbance-data processing on said second disturbance data X2i to generate said processed second disturbance data X2o; and
a table transform means for creating said transformed table by transformation of indexes of said table by using said first disturbance data X1i and transformation of contents of said table by using said second disturbance data X2i.

16. An information-processing apparatus according to claim 13, said information-processing apparatus further having:
a first-disturbance-data storage means for storing a plurality of numbers having uniform and constant or all but uniform and all but constant hamming weights;
a first-disturbance-data select means for randomly selecting one of said numbers stored in said first-disturbance-data storage means to be used as said first disturbance data X1i;
a second-disturbance-data and processed-second-disturbance-data storage means for storing a plurality of pairs each consisting of second disturbance data and processed second disturbance data, wherein said second disturbance data has a constant or all but constant hamming weight and provides a constant or all but constant hamming weight to said processed second disturbance data obtained as a result of disturbance-data processing carried out on said second disturbance data;
a second-disturbance-data and processed-second-disturbance-data select means for randomly selecting one of said pairs each consisting of second disturbance data and processed second disturbance data from said second-disturbance-data and processed-second-disturbance-data storage means to be used as a pair of said processed second disturbance data X2o and second disturbance data X2i; and
a table transform means for creating said transformed table by transformation of indexes of said table by using said first disturbance data X1i and transformation of contents of said table by using said second disturbance data X2i.

17. An information-processing apparatus according to claim 13, said information-processing apparatus further having:
a second-disturbance-data, processed-second-disturbance-data and transformed-table storage means for storing a plurality of sets each consisting of a candidate for said first disturbance data X1i, a candidate for said processed second disturbance data X2o and a candidate for said transformed table; and
a second-disturbance-data, processed-second-disturbance-data and transformed-table select means for randomly selecting one of said sets each consisting of a candidate for said first disturbance data X1i, a candidate for said processed second disturbance data X2o and a candidate for said transformed table from said second-disturbance-data, processed-second-disturbance-data and transformed-table storage means to be used as a set of said first disturbance data X1i, said processed second disturbance data X2o and said transformed table,
wherein:
said candidate for said transformed table is created by transformation of indexes of said table by using said candidate for said first disturbance data X1i and transformation of contents of said table by using said candidate for said second disturbance data X2i;
said candidate for said processed second disturbance data X2o is obtained as a result of processing carried out by disturbance-data processing means on said candidate for said second disturbance data X2i;
said candidate for said first disturbance data X1i has a constant hamming weight;
said candidate for said second disturbance data X2i has a constant hamming weight as well; and
said candidate for said processed second disturbance data X2o also has a constant hamming weight even after said processing carried out by said disturbance-data processing means.
